(19) United States
(12) Patent Application Publication
(10) Pub. No.: US 2018/0000108 A1
(43) Pub. Date: Jan. 4, 2018

(54) SYSTEMS AND METHODS FOR COFFEE PREPARATION

(71) Applicant: SEVA COFFEE CORPORATION, San Carlos, CA (US)

(72) Inventor: Deepak Boggavarapu, San Carlos, CA (US)

(21) Appl. No.: 15/483,809

(22) Filed: Apr. 10, 2017

Related U.S. Application Data
(63) Continuation-in-part of application No. 15/058,934, filed on Mar. 2, 2016.
Application No. 15/058,934 is a continuation of application No. 14/028,459, filed on Sep. 16, 2013, now abandoned.
(60) Provisional application No. 61/766,066, filed on Feb. 18, 2013.
(60) Provisional application No. 61/743,946, filed on Sep. 15, 2012.
(60) Provisional application No. 62/320,500, filed on Apr. 9, 2016.

(51) Int. Cl. A23F 5/26; A47J 31/36; A47J 31/42; A47J 31/44

(52) U.S. Cl. CPC A23F 5/26; A47J 31/4492; A47J 31/3633; A47J 31/42

(57) ABSTRACT

Example embodiments of systems and methods for brewing coffee can include providing an integrated beverage system that can include a grinding system, a roasting system, and a brewing system. The integrated beverage system can be used with a container that can contain unroasted coffee beans or coffee grounds, where the integrated beverage system can be configured to accept the container and can roast, grind, and brew coffee.

### REFERENCE TO RELATED APPLICATIONS

The present application is a continuation-in-part (CIP) of U.S. non-provisional patent application Ser. No. 15/058,934, filed Mar. 2, 2016, which is a continuation of U.S. non-provisional patent application Ser. No. 14/028,459, filed Sep. 16, 2013, which claims the priority benefit of U.S. provisional patent application Ser. No. 61/766,066, filed Feb. 18, 2013, and U.S. provisional patent application Ser. No. 61/743,946 filed Sep. 15, 2012, and hereby incorporates the same applications herein by reference in their entirety; the present application claims priority to U.S. provisional patent application 62/320,500, filed Apr. 9, 2016, which is incorporated by reference in its entirety.

### TECHNICAL FIELD

Embodiments of the technology relate, in general, to coffee roasting, grinding, or brewing technology, and in particular to integrated roasting, grinding, or brewing coffee systems operable by a consumer.

### BACKGROUND

Coffee has traditionally been made using a three step process that generally includes the roasting of coffee beans, grinding of roasted beans, and brewing of the ground beans in hot water to extract the flavor into a beverage. These three steps are traditionally done at different times and locations. Roasting is typically done in large industrial machines in large batches of tens of pounds to thousands of pounds at a time. Roasted beans or ground roasted beans are generally shipped to local retailers, which can take weeks to months before the package arrives for the consumer to brew. The consumer can be the retail home consumer or businesses, such as coffee shops, that brew and sell coffee. Roasted beans decay in freshness and taste from the moment the roast is completed as chemical compounds formed in the bean during the roasting process deteriorate. The decay of roasted beans may lead to the coffee having a less desirable taste. Coffee produced by such methods may be stale due to the time delay from roasting to brewing. The preparation of coffee generally involves the steps of roasting, grinding, and brewing. In current systems, roasting is generally performed at a separate location and performed days, weeks, or months prior to grinding and brewing.

The taste of coffee is generally determined by the type of coffee beans used and by numerous process parameters in each step of making the coffee beverage. A key set of chemical reactions that influence coffee taste occur during the roasting process. The roasting process is typically done in an industrial batch scale, and the end consumer has no control over the roast process or the taste of the coffee beverage as determined by the bean roast. Additionally, the degree of roasting for each bean type can transform the taste of the final coffee beverage to an individual consumer's liking, yet this degree of control by the consumer does not exist in the coffee industry today.

### SUMMARY

An example embodiment of a method for brewing coffee can include providing an integrated beverage system that can include a roasting system and a brewing system and providing a container that can contain a plurality of coffee grounds, where the plurality of coffee grounds can be unroasted. The method can include inserting the container into the integrated beverage system, engaging the plurality of coffee grounds with the roasting system of the integrated beverage system, roasting the plurality of coffee grounds, engaging the plurality of coffee grounds with the brewing system of the integrated beverage system, and brewing the plurality of coffee grounds with the integrated beverage system.

An example embodiment of a method for brewing coffee can include providing an integrated beverage system that can include a roasting system, a grinding system, and a brewing system and providing a container that can contain a plurality of coffee beans, where the plurality of coffee beans can be unroasted. The method can include inserting the container into the integrated beverage system, engaging the plurality of coffee beans with the roasting system of the integrated beverage system, roasting the plurality of coffee beans, engaging the plurality of coffee beans with the grinding system of the integrated beverage system, grinding the plurality of coffee beans such that a plurality of coffee grounds can be formed, engaging the plurality of coffee grounds with the brewing system, and brewing the plurality of coffee grounds with the integrated beverage system.

An example embodiment of a method for brewing coffee can include providing an integrated beverage system that can include a grinding system, a roasting system, and a brewing system and providing a container that can contain a plurality of coffee beans, where the plurality of coffee beans can be unroasted. The method can include inserting the container into the integrated beverage system, engaging the plurality of coffee beans with the grinding system of the integrated beverage system, grinding the plurality of coffee beans such that a plurality of coffee grounds can be formed, engaging the plurality of coffee grounds with the roasting system of the integrated beverage system, roasting the plurality of coffee grounds, engaging the plurality of coffee grounds with the brewing system, and brewing the plurality of coffee grounds with the integrated beverage system.

In an example embodiment, an integrated coffee system can include a roasting chamber that can be configured to receive a user selectable quantity of coffee beans or grounds in an unroasted state. A control interface can be operatively coupled to the roasting chamber and can include one or a plurality of user selectable roasting parameters. The integrated coffee system can include a grinding chamber into which the coffee beans in a roasted state can be received. The control interface can be operatively coupled to the grinding chamber and can include one or a plurality of user selectable grinding parameters. The integrated coffee system can include a brewing chamber into which the user selectable quantity of coffee beans, in a ground state, can be received. The control interface can be operatively coupled to the brewing chamber and can include one or a plurality of user selectable brewing parameters.

An integrated coffee brewing method can comprise the steps of entering at a control interface each of at least one of a plurality of user selected roasting parameters, at least one of a plurality of user selected grinding parameters and at least one of a plurality of user selected brewing parameters. The integrated coffee brewing method can include the steps of roasting a user selectable quantity of coffee beans in accordance with the entered one of the roasting parameters, grinding the roasted coffee beans in accordance with the entered one of the grinding parameters, and brewing the ground coffee beans in accordance with the entered one of the brewing parameters.

### BRIEF DESCRIPTION OF THE DRAWINGS

The present disclosure will be more readily understood from a detailed description of some example embodiments taken in conjunction with the following figures:

FIG. 1 depicts an example integrated beverage system according to one embodiment.

FIG. 2 depicts an example method of coffee bean marking, verification, preparation, and brewing according to one embodiment.

FIG. 3 depicts an example method of coffee bean marking, verification, preparation, and brewing according to an alternate embodiment.

FIG. 4 depicts an example method of coffee marking, verification, preparation, and brewing according to one embodiment.

FIG. 5 depicts a front cross-section view of an integrated coffee system that includes a roasting system and a brewing system according to one embodiment.

FIG. 6 depicts a front cross-section view of an integrated coffee system that includes a roasting system, a grinding system, and a brewing system according to one embodiment.

FIG. 7 depicts a front cross-section view of an integrated coffee system that includes a grinding system, a roasting system, and a brewing system according to one embodiment.

FIG. 8 depicts a side view of an integrated coffee system depicting a stationary coffee container and a roasting system, a grinding system, and brewing system configured to move relative to the stationary coffee container according to one embodiment.

FIG. 9 depicts a top view of an integrated coffee system depicting a movable coffee container that can be positioned initially with an installation system, moved to a scanner, moved to a roasting system, moved to a grinding system, and moved to a brewing system according to one embodiment.

FIG. 10 depicts a perspective view of a coffee bean that has been marked for verification according to one embodiment.

FIG. 11 depicts a perspective view of a coffee container configured to retain a plurality of coffee beans according to one embodiment.

FIG. 12A depicts a partial exploded view of a coffee container configured to retain a plurality of coffee beans in a single-bean arrangement according to one embodiment, where the container is shown populated with a plurality of coffee beans.

FIG. 12B depicts an exploded view of the coffee container shown in FIG. 12A.

FIG. 13A depicts a container for a plurality of coffee beans that can be configured such that coffee bean roasting, grinding, and brewing can occur within the container according to one embodiment.

FIG. 13B depicts an exploded view of the container of FIG. 13A.

FIG. 14 depicts a container for a plurality of coffee beans that can be configured such that coffee bean roasting, grinding, and brewing can occur within the container according to an alternate embodiment.

FIG. 15 depicts a container for a plurality of coffee beans that can be configured such that coffee bean roasting, grinding, and brewing can occur within the container according to an alternate embodiment.

FIG. 16 depicts the container of FIG. 13, where the container is shown prior to being engaged with a roasting system according to one embodiment.

FIG. 17 depicts the container of FIG. 13, where the container is shown after engagement with the roasting system of FIG. 16 according to one embodiment.

FIG. 18 depicts the container of FIG. 13, where the container is shown engaged with a grinding system according to one embodiment.

FIG. 19 depicts the container of FIG. 14, where the container is shown engaged with a brewing system according to one embodiment.

FIG. 20 depicts a partial cutaway view of a roasting system and the movement of a plurality of coffee beans within the roasting system according to one embodiment.

FIG. 21 depicts a perspective view of a pod having a lid, where the pod and lid are configured from a compostable or recyclable material according to one embodiment.

FIG. 22 depicts the pod and lid of FIG. 21, where the lid is shown opened to display two seeds attached thereto according to one embodiment.

FIG. 23 depicts a side cutaway view of an integrated beverage system according to one embodiment.

FIG. 24 depicts a partial side cutaway view of the integrated beverage system of FIG. 23 shown with a pod holder rotated to dump beans into a roaster.

FIG. 25 depicts a side view of a vacuum system that can be incorporated into an integrated beverage system according to one embodiment.

FIG. 26 depicts a side schematic view of a stacked integrated beverage system shown with a pod that is used to both store and brew coffee according to one embodiment.

FIG. 27 depicts a side schematic view of an integrated beverage system according to one embodiment.

FIGS. 28A-28C depict a side view of a pod having a sleeve, where the pod is shown in a closed, partially open, and open position according to one embodiment.

FIG. 29 depicts a side schematic view of a pod associated with a fixed container for brewing according to one embodiment.

FIG. 30 depicts a schematic view of an integrated beverage system incorporating a single fan according to one embodiment.

FIG. 31 depicts a schematic view of an integrated beverage system incorporate a plurality of fans according to one embodiment.

FIGS. 32A-32B depict a side view of a spring-loaded brewing system according to one embodiment.

FIGS. 33A-33B depict a side view of a drawbridge-style brewing system according to one embodiment.

FIG. 34 depicts a front perspective view of a grinder that can be associated with a pod according to one embodiment.

FIG. 35 depicts a side view of a heat recovery system that can be used with an integrated beverage system according to one embodiment.

FIG. 36 depicts a side view of a chaff removal system that can be used with an integrated beverage system according to one embodiment.

FIG. 37 depicts a top view of a turbo wheel according to one embodiment.

FIG. 38 depicts a partial side view of a pipe having a heating element associated with the turbo wheel of FIG. 37 according to one embodiment.

FIG. 39 depicts a top view of a fan blade according to one embodiment.

FIG. 40 depicts a front perspective view of an integrated beverage system according to one embodiment.

FIG. 41 depicts a side view of a cylinder roaster for convective hot air roasting according to one embodiment.

FIG. 42 depicts a schematic view of a water system that can be used with an integrated beverage system according to one embodiment.

FIG. 43 depicts a schematic view of an electrical system that can be used with an integrated beverage system according to one embodiment.

FIG. 44 depicts an integrated beverage system according to one embodiment.

FIGS. 45A-45C depict an integrated beverage system according to one embodiment.

FIG. 46 depicts a top view of a pod having multiple cavities according to one embodiment.

FIG. 47 depicts a side view of an integrated beverage system according to one embodiment.

FIG. 48 depicts a side view an integrated beverage system showing a roasting stage and a grinding stage according to one embodiment.

FIG. 49 depicts a side view an integrated beverage system showing a brewing stage according to one embodiment.

FIGS. 50-58 depict a plurality of displays that can be associated with a software user interface for an integrated beverage system according to one embodiment.

FIG. 59 depicts a schematic view of the hardware and software architecture for an integrated beverage system according to one embodiment.

FIG. 60 depicts a schematic view of the hardware and software architecture for an integrated beverage system according to an alternate embodiment.

FIGS. 61A-61D depict a side view of a pod insertable into an integrated beverage system, where the integrated beverage system is shown opening the pod according to one embodiment.

FIGS. 62A-67 illustrate integrated beverages systems according to various embodiments.

FIG. 68A depicts a top view of an beverage system according to one embodiment.

FIG. 68B depicts a side view of the integrated beverage system shown in FIG. 68A.

FIG. 69 depicts a side view of a pod according to one embodiment.

FIGS. 70A-70B depict a pod according to an alternate embodiment.

FIGS. 71A-71C depict a side view of a pod having a sleeve according to one embodiment.

FIGS. 72A-72B depict a pod and an associated tool according to one embodiment.

FIG. 73 depicts a cutaway side view of a pod and an associated tool according to one embodiment.

FIG. 74 depicts a cutaway side view of a pod and an associated tool according to one embodiment.

FIG. 75 depicts a cutaway side view of a pod and an associated tool according to one embodiment.

FIGS. 76A-76B depict a cutaway side view of a pod and an associated tool according to one embodiment.

FIGS. 77A-77C depict a cutaway side view of a pod and an associated integrated beverage system according to one embodiment.

FIG. 78 depicts a cutaway side view of a pod and an associated integrated beverage system according to one embodiment.

FIGS. 79A-79B depict a cutaway side view of a pod and an associated integrated beverage system according to one embodiment.

FIGS. 80A-80C depict a cutaway side view of a pod and an associated integrated beverage system according to one embodiment.

### DETAILED DESCRIPTION

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics may be combined in any suitable manner in one or more embodiments.

Systems and methods described herein can integrate roasting, grinding and brewing of coffee into a single machine, where customers can precisely adjust the coffee at each stage of the process to suit their preferences. Example embodiments can include providing unroasted green coffee beans in single serve pods, which can eliminate the need for high cost bulk roasting and the accompanying higher consumer cost. Such a system may create a new market for green unroasted coffee beans. Example embodiments described herein can use an integrated coffee system to produce a cup of coffee from unroasted whole beans in less than 2 minutes, in less than five minutes, or at any suitable speed or time duration.

Various non-limiting embodiments of the present disclosure will now be described to provide an overall understanding of the principles of the structure, function, and use of the apparatuses, systems, methods, and processes disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Described herein are example embodiments of apparatuses, systems, and methods for an integrated beverage grinding, brewing, and/or roasting system. In an example embodiment, packaging for coffee is disclosed that can maintain the freshness of the bean while allowing easy distribution and verification of bean authenticity. In an example embodiment, an integrated coffee system can grind, roast, and brew coffee within a single system. In some embodiments, the integrated coffee system can be configured to accept unroasted coffee beans in single-serving packages. In some embodiments, the integrated coffee system can be configured to accept ground, unroasted coffee beans for roasting and brewing within an integrated coffee system.

The examples discussed herein are examples only and are provided to assist in the explanation of the apparatuses, devices, systems and methods described herein. None of the features or components shown in the drawings or discussed below should be taken as mandatory for any specific implementation of any of these apparatuses, devices, systems or methods unless specifically designated as mandatory. For ease of reading and clarity, certain components, modules, or methods may be described solely in connection with a specific figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Example embodiments described herein may maximize coffee freshness and flavor by grinding or roasting coffee beans just prior to brewing. Unground green coffee beans, when stored properly, may be more flavorful than beans that are roasted and ground long before they are sent to and brewed by a consumer. For example, unroasted green coffee beans can be shipped to a consumer and can be roasted, ground, and then brewed within a single machine. Unground green coffee beans can be shipped as discrete single-use packages where, for example, unground green coffee beans can be roasted by a consumer just prior to brewing and drinking. Unground green coffee beans may retain sufficient freshness such that these “green” coffee beans can be marketed based upon a flavor profile and date of harvest. Additionally, or alternatively, unground beans and/or related packaging can be marked or otherwise carry indicia of origin, harvest date, or the like.

An integrated coffee grinding, roasting, and/or brewing computer system in accordance with the present disclosure can be accessed via any suitable technique, such as a web-browser such as SAFARI, OPERA, GOOGLE CHROME, INTERNET EXPLORER, or the like executing on a client device. In some embodiments, the systems and methods described herein can be a web-based application or a stand-alone executable. Additionally, in some embodiments, the systems and methods described herein can integrate with various types of integrated coffee grinding, roasting, and/or brewing systems, such as systems and methods that grind, roast, and brew within a single unit, and the like. Any suitable client device can be used to access, or execute, the integrated coffee grinding, roasting, and/or brewing computing system, such as laptop computers, desktop computers, smart phones, tablet computers, gaming systems, and the like.

Systems and methods described herein may generally provide an interactive environment for users (e.g., an optimized coffee grinding, roasting, or brewing experience) to provide granular control over coffee preparation. Interaction with the integrated coffee grinding, roasting, and/or brewing computer system may include, without limitation, keyboard entry, touchpad entry, voice recognition, physical buttons, writing from pen, stylus, finger, or the like, with a computer mouse, or other forms of input (voice recognition, etc.). The integrated coffee computer system may be presented on a tablet, desktop, phone, board, or paper. In one embodiment, the user may interact with the integrated coffee computer system by writing with a smart pen on normal paper, modified paper, or a hard flat surface of their preference. In this embodiment, the user may receive real-time feedback, or at least near real-time feedback, or may synchronize with the integrated coffee grinding, roasting, and/or brewing computer system at a later date. The integrated coffee grinding, roasting, and/or brewing computer system can be a personal computer, or one or multiple computers in server-type system.

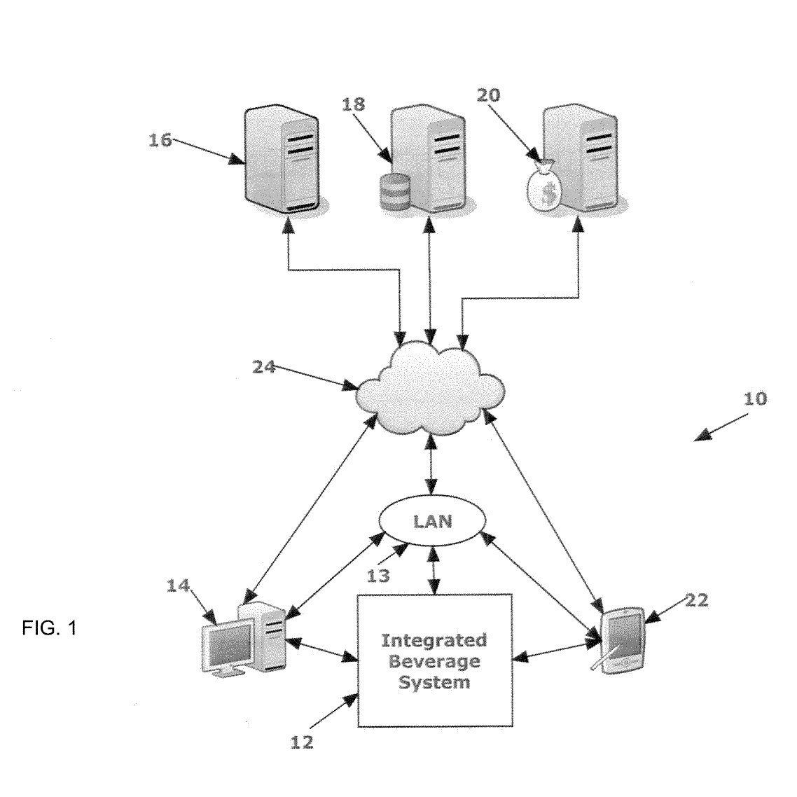

Referring now to FIG. 1, disclosed is one embodiment of an interactive beverage system 10 that can include an integrated beverage system 12. The integrated beverage system 12 can be configured to grind, roast, or brew any suitable beverage, such as coffee. The interactive beverage system 10 can include the integrated beverage system 12 and any suitable network of peripheral data or component connections. For example, the integrated beverage system 12 can be coupled with a personal computer 14 or smartphone 22, such that a user can communicate with or control the integrated beverage system 12. Communication can be wired or wireless and can include short-range wireless interconnection of cellular phones, computers, and other electronic devices, wired USB, or any other suitable connection. It will appreciated that communication with the integrated beverage system 12 can be two-way, where the integrated beverage system 12 can push or otherwise transmit any suitable data, notifications, or the like to any suitable component or peripheral device. Such data or commands can include turning the machine on or off, choosing a recipe, adjusting recipe parameters, determining when a beverage will be ready, indicating whether the integrated beverage system is busy, or the like. The integrated beverage system 12 can include a transmitter and/or receiver that can be configured to send and/or receive information in communication with any suitable device or source. Data can also be transmitted or received from a local area network (LAN) 13, a cloud 24, or from any other suitable source. It will be appreciated that the personal computer 14, smartphone 22, or any other suitable peripheral device or data can be associated with the manufacturer of the integrated beverage system, where data can be sent through the cloud 24 to a user's integrated beverage system 12. Such communications can include software updates, new product offerings, new recipes, personalized messages, requests for information, or the like.

The integrated beverage system 12 can be coupled with or communicate via the cloud 24 with a server 16, a database server 18, or an ecommerce server 20. It will be appreciated that server 16 can communicate, store, or process any suitable data or information related to the integrated beverage system 12. The database server 18 can maintain any suitable information or data related to the integrated beverage system including, for example, coffee package verification data, user verification data, coffee bean verification data, usage data, software upgrade information, user preferences, stored roasting programs, stored grinding programs, stored brewing programs, stored dispensing programs, or the like. The integrated beverage system 12 can be coupled with the ecommerce server 20, or any other suitable ecommerce platform, where purchases can be made automatically or manually. For example, the ecommerce server 20 can maintain user financial information, such as credit card information, and can automatically determine when a user's supply of coffee is below a threshold and automatically order additional coffee based upon the user's preferences stored in the database server 18. It will be appreciated that any suitable storage device retaining any suitable information, such as recipes or personal preferences, can be coupled or can be integral with the integrated beverage system 12. It will be appreciated that data can be transmitted to, received from, and stored within the cloud 24.

The integrated beverage system 12 can include an internet connection and can upload and download information to/from computer servers, such as servers 16, 18, 20, that can be attached to the internet. These servers can be owned and maintained by a company selling the integrated beverage system 12, which can provide consumers with a variety of functions. A website can also be associated with the integrated beverage system 12 that can have information to educate the consumer about the coffee beans and the provenance/terroir of the coffee beans in pods. This information can include professional tasting ratings, user generated feedback forums on taste, and information about the source of each pod. The website can allow for the auctioning or trading of coffee pods, can verify the pods for authenticity, or can include any other suitable information.

Containers, pods, packages, or any other suitable coffee bean retainer can be sold with optimized preparation recipes encoded as described herein. However, the consumer may choose to experiment with process parameters to suit individual taste. The user can decide to upload their personal recipe for a specific pod to the website for free access by all, or may choose to upload the recipe and charge others for access. The website can handle the transaction and can take a percentage of the sale price for facilitating the transaction. Chefs or celebrities can create branded recipes specific to each type of pod or package.

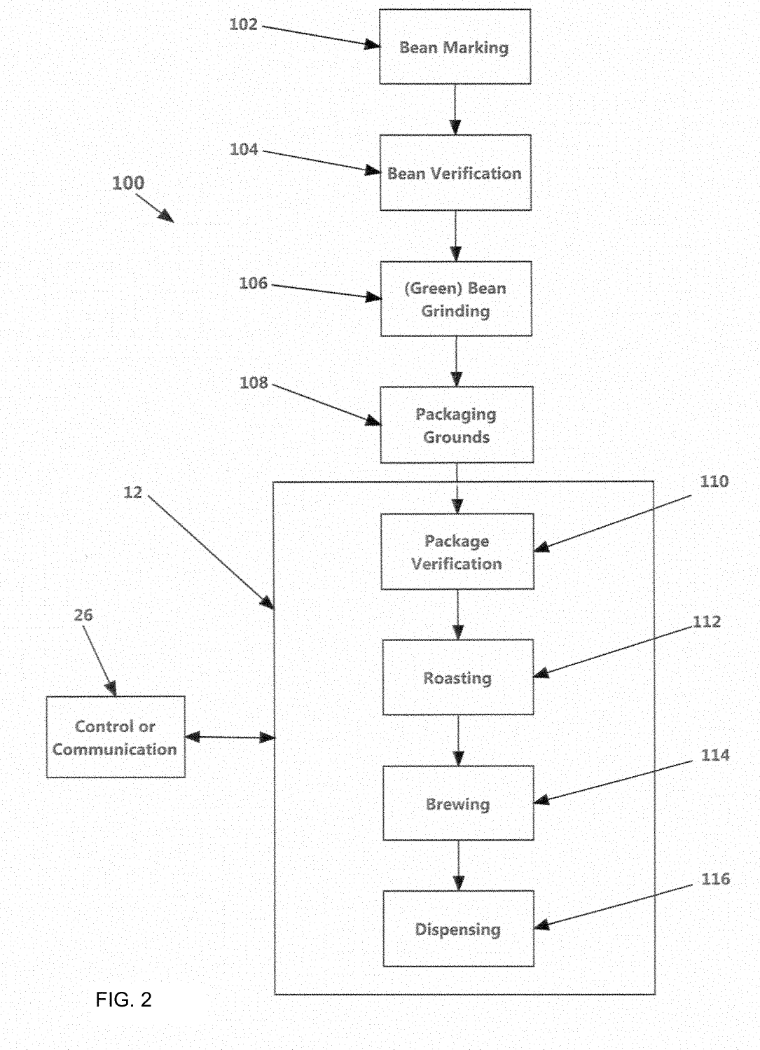

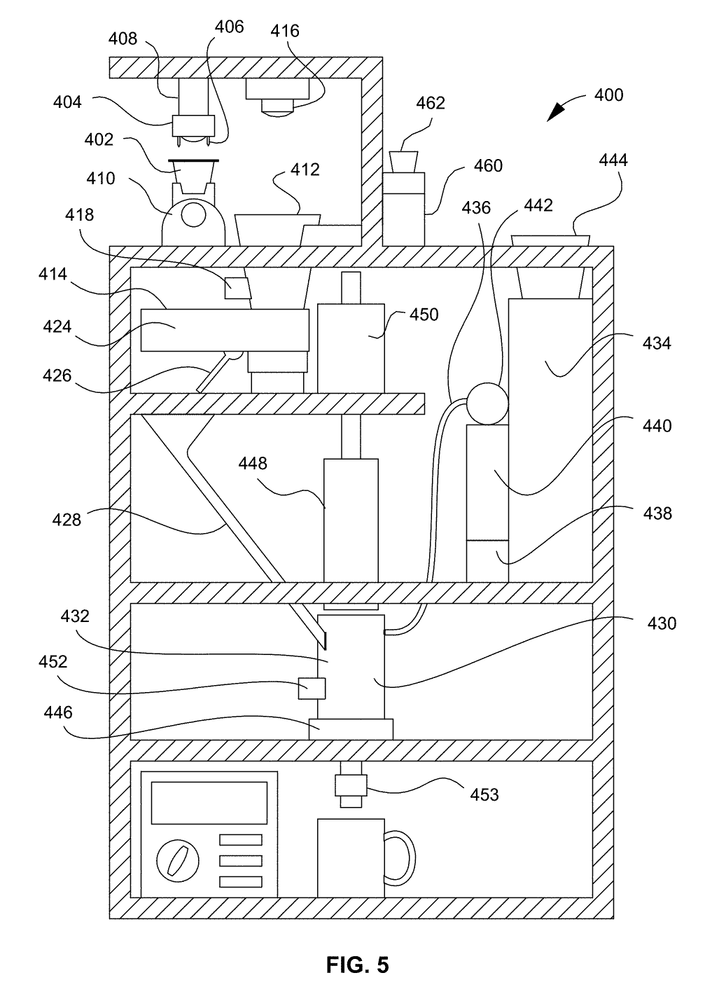

FIG. 2 depicts an example embodiment of a method 100 for providing coffee to a consumer. Method 100 can be performed at least partially by the interactive beverage system 10 or the integrated beverage system 12. It will be appreciated that any suitable steps of the method 100 can be performed by the integrated beverage system 12 or can be performed independently from the integrated beverage system 12. In an example embodiment, the method 100 can be performed with an integrated beverage system 400 depicted in FIG. 5. Long preparation times may delay customer consumption of coffee and customers may seek other options if preparation time is too long. Traditional coffee roasting can be a time consuming process that can take 10 to 20 minutes for the roasting to occur and the full batch process time can exceed 30 minutes. This length of time may be too long for the consumer to wait for coffee preparation. Methods, apparatuses, and systems described herein can rapidly roast, grind, and/or brew coffee such that the entire preparation process can be performed automatically in less than one minute, in about 1 to about 2 minutes, in about 2 to about 3 minutes, in about 3 to about 5 minutes, in about 5 to about 7 minutes. These time ranges for coffee preparation are within the ranges acceptable for a consumer to wait while providing an entirely new coffee drinking experience to the consumer. It will be appreciated that systems, devices, or tools associated with the integrated coffee system 12, including grinding, roasting, or brewing tools or systems, can be engaged with, associated with, coupled with, can interact with, can be operable to work with, or can otherwise be used with coffee beans or coffee grounds.

The method 100 can include the step of Bean Marking 102. Coffee has evolved in recent years from a widespread commodity product with ‘generic’ tasting coffee products to specialty coffee where specific beans, origin location, microclimates, growing conditions, year of production, and processing conditions are tracked and marketed. These variations in the source beans can affect the taste of the coffee beverage and thus can be tracked and marketed to a final consumer. Coffee has many aromatic compounds that affect aroma and taste and coffee contains more aromatic compounds than wine. Coffee can be marketed by region, year of packaging, vineyard, year of harvest, time of year harvested, plantation or farm, type of bean, elevation, time of day sun hits the coffee plant, microclimate, bean processing, picking method, de-pulping, drying, dry process, wet process, shipping and storage method, exact weather conditions at the source during the growing season, satellite weather data, or by any other suitable parameter or characteristic. In an example embodiment, providing an unroasted product to a consumer may help retain the characteristics of the bean, where such a model may be attractive to consumers. The step of Bean Marking 102 can provide assurance to the end consumer that the product, such as unroasted green coffee beans, being purchased is genuine and not counterfeit. This can allow the consumer to verify the authenticity of the purchase and to possibly sell that product in the future for value that may increase or decrease.

Coffee plants are grown in approximately 50 countries worldwide typically in the tropical regions of the world at high elevations. The coffee cherry is generally picked from the plant and after several process steps, dried green coffee beans are produced. These beans can vary widely in quality and taste leading to a large difference in price. Commodity green coffee beans may be priced significantly lower than specialty green coffee beans, which may have a specific taste and origin. However it may be difficult for a person to determine the origin of a green coffee bean by physical observation and thus expensive beans may be easily counterfeited.

The step of Bean Marking 102 can include laser marking, mechanical marking, or any other suitable system or mechanism for determining, indicating, or validating the type, origin, age, or the like, for a coffee bean. Referring to FIG. 10, one example of a coffee bean 900 is illustrated having a marking 902. It will be appreciated that the marking 902 can be placed on any suitable region of the coffee bean 900 and can have any suitable size, shape, or configuration. Laser marking can be applied to individual coffee beans with a custom code, regional code, or the like, that may be difficult or impossible to copy. The marking instrument can include a diode laser, fiber laser, CO2 laser, or any other suitable type of laser. Laser marking can include short pulse, high peak power lasers that can minimize heat damage to surrounding areas of the green bean outside where the beam hits. Penetration depth of the laser can be varied and can depend on wavelength and peak power, where it may be advantageous to minimize penetration depth such that the inside of the bean remains substantially unharmed. The curved side or the flat side of a bean can be marked. In an example embodiment, the surface of bean can be marked without damage or with minimal damage to the inside of the bean. Mechanical marking of the surface of a coffee bean with a specific code, for example, can also be performed without damaging the inside of the bean using, for example, a blade or a stamp. Bean Marking 102 can include the application of visual marking material to a coffee bean in, for example, a custom pattern. Example markings can include fluorescent materials that can emit only when stimulated with the proper external optical stimulus. These materials can be organic (e.g., green fluorescent protein or other materials) or inorganic. Biologically safe materials and materials that can burn off during coffee roasting can be used to leave no trace in appearance or taste. It will be appreciated that the step of Bean Marking 102 can be performed at any suitable location or time including, for example, at a coffee farm or processing plant prior to the coffee beans being packaged or shipped to consumers.

Still referring to FIG. 2, the method 100 can include the step of Bean Verification 104. Consumers may wish to validate characteristics of coffee beans, such as origin, age, type, or the like. In an example embodiment, Bean Verification 104 can include mechanically, electronically, optically, or manually reviewing the imprint, code, or the like associated with the Bean Marking step 102. For example, a warehouse receiving beans from around the world can be equipped to electronically read and/or record the imprint, code, or indicia on the beans to confirm the authenticity of each bean. Additionally, or alternatively, the integrated coffee system 12 can be equipped to read the imprint, code, or the like associated with coffee beans to confirm authenticity. In one embodiment, the scanned or otherwise recorded information can be compared by an integrated coffee system 12 against data in the database server 18 (FIG. 1) to determine coffee bean authenticity.

Bean Verification 104 can include DNA verification, where DNA sequencing of beans can be performed on reference bean samples from desired locations. Bean Verification 104 can be performed at any stage during the method 100 and can be performed at a farm, warehouse, distribution site, or by the integrated beverage system 12. DNA sequence data can be stored, such as in the database server 18, and compared to DNA sequence data of coffee beans at a later date to verify origin of the bean. In an example embodiment, bean roasting can occur just prior to consumption, where Bean Marking 102 and Bean Verification 104 can be combined with any other suitable anti-counterfeiting method or system to maintain the integrity and reliability of coffee beans through the distribution chain until the final preparation. Delaying roasting until just prior to preparation may help maintain the integrity of markings and DNA associated with Bean Marking 102 and Bean Verification 104.

Bean Verification 104 can include any suitable evaluation of parameters to validate the origin or terroir of coffee beans, including characteristics of the geography, geology and climate of certain places, which may affect coffee taste. Food provenancing, which is the chronology of the ownership or location of a historical object, can be applied to coffee beans just as it is frequently applied to other foods and beverages such as wine. Bean Verification 104 can include using spectroscopic methods to verify provenance of coffee beans by measuring spectroscopic data (e.g., molecular compounds, ratios of different elements, etc.) from regions, locations, climates, etc., and creating a library of this bean spectroscopic data. This library of data, which can be stored in the database server 18, can be used to compare against spectroscopic measurements by the integrated beverage system 12 or for verification if the provenance of any bean is called into question. Spectroscopic techniques can include mass spectrometry, laser spectroscopy, LIBS (laser induced breakdown spectroscopy), ICP-MS (inductively coupled plasma mass spectrometry), or any other suitable methods. A spectroscopic signature can help verify provenance of coffee bean growth and the subsequent ability to verify beans after packaging into coffee pods or packages as described herein.

Method 100 can include the step of Bean Grinding 106. In an example embodiment, coffee beans can be ground prior to roasting, where the coffee beans can be ground in a “green” condition to any suitable size. Size of grounds can range for example from about 10 um to about 100 um, from about 100 um to about 500 um, from about 500 um to about 1000 um, or from about 1000 to about 3000 um. Grinding coffee beans prior to packaging and roasting may make the roasting process, particularly if performed by the integrated beverage system 12, more efficient, while at the same time may preserve the freshness of the coffee beans as compared to traditional coffee beans that are roasted and then ground. The unroasted coffee bean grinding process can take place in a factory or other suitable setting as is commonly known in the art. It will be appreciated that any suitable size or shape of grounds can be created as will be apparent to one of ordinary skill in the art. In an alternate embodiment, the step of Bean Grinding 106 can include partially roasting the coffee beans prior to grinding the coffee beans, where partially roasting the beans may help maintain freshness but make a subsequent roasting process more efficient. In an alternate embodiment, the step of Bean Grinding 106 can include grinding green coffee beans to a first particle size, such as a coarse grind, where the coffee grounds can then be packaged. The integrated beverage system 12 can then be configured to further grind the coffee grounds from the first particle size to a smaller particle size, such as into a fine ground. It will be appreciated that any suitable step of roasting, grinding, or brewing can be performed in any suitable order and each step can be performed multiple times if desirable.

Method 100 can include the step of Packaging Grounds 108. Packaging Grounds 108 can include the use of single serve coffee containers, such as container 402 shown in FIG. 5, or packages for consumer preparation of coffee in single cup portions. Advantages of coffee pods can include convenience, single serve preparation so that coffee does not sit aging in pots, and the ability for a consumer to choose amongst pod types. Discrete coffee pods or packages can include small plastic or metal containers with ground unroasted coffee and filter material, such as filter paper or metal mesh, inside. Unroasted green coffee beans can be ground and packaged into small enclosed containers, such as pods, where each pod can contain enough green coffee grounds to ultimately produce one serving of coffee. The pod can be hermetically sealed or otherwise configured to preserve freshness. Pods can be used with the integrated beverage system 12 or the interactive beverage system 10, for example. Ground green coffee beans may have a long shelf life and may not degrade rapidly as compared to ground and roasted coffee beans, or unground roasted coffee beans. Packaging Grounds 108 can include filling the ground coffee container with a gas, or any other suitable substance, to help preserve the enclosed grounds. This fill gas can be atmospheric air, nitrogen, inert gas, noble gas, or the pod can be vacuum packed. In an example embodiment, the pod can be filled with positive pressure gas (e.g., nitrogen, noble gas, or others). Each pod can contain approximately from about 0.1 to about 2 grams, from about 2 grams to about 10 grams, from about 10 grams to about 70 grams of ground green coffee beans. In certain cases, certain beans are known to improve with age and exposure to air, where pods containing such grounds may be packaged with a breathable membrane that can allow for the exchange of atmospheric air. The package or pod can be marked with an information code or bar code that can contain information about the grounds in the pod. Packages can be deliberately designed to be hard to reproduce to act as an anti-counterfeit measure.

The pod can be made of recyclable materials or biodegradable materials. The compostable or recyclable pod may contain green unroasted beans, may mate or may be inserted into the systems as described herein, such as a system for roasting, grinding, and brewing, where the pod may contain the leftover grinds after brewing. In such an example the pod can be removed from the system and disposed of or can be reused for planting or other purposes. The convenience of a pod or capsule approach to coffee may be useful to the end consumer and using compostable material for the pod can prevent extra waste from being created, where conventional packaging uses non-recyclable plastics or materials that cannot be easily recycled. The pod can be made of any suitable compostable material such as wood pulp, bamboo, bagasse, sugarcane waste, wheat straw, corn plastic, miscanthus, or combinations thereof.

In an alternate embodiment, the quantity of green coffee beans within a package can be adjusted depending on the type of roast contemplated, as beans lose weight during roast due to the loss of water from the bean during the roast process. For example, a dark roasted bean generally loses more water weight than a lightly roasted bean, where the quantity of beans within a pod can be adjusted to the appropriate amount at the time of packaging to account for this roast loss.

Method 100 can include Package Verification 110. Pod or Package Verification 110 can include imprinting the pod with a code, bar code, or other data that can be read by a scanner 404 of the integrated beverage system 400 (FIG. 5). Package Verification 110 can also include near field communication (NFC) methods, RFID, or other electronic components integrated into the pod that may be queried by wireless or wired means. Package Verification 110 can allow the integrated beverage system 400 to verify the authenticity of a coffee pod, such as container 402, and can prevent fake containers from working in the integrated beverage system 400. Encoded bean information and optimum preparation recipe instructions can be provided on the packaging that can be read and used by the integrated beverage system 400. Package Verification 110 can also include anti-tampering features or data. The information, code, data, or the like can be printed on the package in any suitable form, such as a form invisible to the naked eye, to preserve the aesthetic appeal of the pod. One such example of an invisible code to the naked eye can include printing the code using phosphors that emit light when excited by higher energy light. A light emitting diode can be used to excite the phosphors and a camera can be used to read out the resulting information. The flash and camera contained in a smartphone can be used, for example. The container 402 can include features that can prevent tampering or can indicate if tampering has occurred. One embodiment can hermetically seal the container 402, where a leak detector can be used to identify tampering. The container can be designed such that noninvasive measurement of the spectral features of the beans can be performed to verify provenance of the bean. In an example embodiment, a transparent window can be formed in a portion of the container that can allow for non-invasive laser spectroscopic measurements. Invasive tools can also be used that can take a sample from the bean, where the tool could be designed to puncture the container and self-seal the puncture when the tool is retracted. It will be appreciated that the scanner 404 can communicate with the interactive beverage system 10 to transmit data relative to the verification.

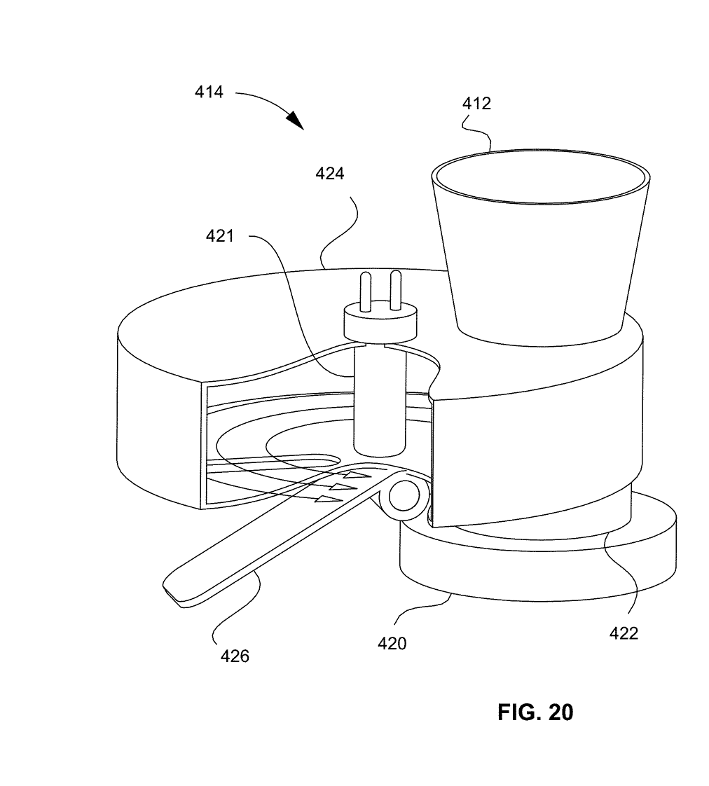

Referring to FIG. 5, containers 402 can be designed in conjunction with the integrated beverage system 400 such that the integrated beverage system 400 can automatically open the pod upon insertion. For example, the integrated beverage system 400 can include a cutter 406 that can be associated with a motor 408 that can include an actuator or linear actuator to engage and rotationally cut the seal away from the container 402. The integrated beverage system 400 can include a stepper motor 410 that can be configured to rotate and expel the contents of the container 402 into a funnel 412 leading to a roasting system 414. An example roasting system 414 is illustrated in more detail with reference to FIG. 20. The integrity of the roasting process can be monitored by a camera 416 or the camera output can be used to adjust roasting parameters in a real time control loop. Any suitable package, pod, container, or packaging methods can be used to create a container 402 that can be designed for long life with reduced bean or ground degradation. Packages can be configured for storing, collecting, trading, and consuming specialty green coffee grounds in an analogous manner as to how fine wine is collected, stored, traded, and ultimately consumed. Fine wine may go up or down in value as the provenance or taste of the specific wine gains or loses reputation amongst collectors of wine; and due to supply and demand constraints. Similarly, fine green coffee grounds may have analogous taste and aroma characteristics that cannot be artificially duplicated, which can create a tradable value amongst connoisseurs.

Referring to Figure. 2, Method 100 can include the step of Roasting 112. Method 100 illustrates one version of a method of grinding green coffee beans, roasting the ground green coffee beans, and brewing coffee. Method 100 can introduce green coffee beans to the Roasting 112 step that may be ground to a small size, which can result in more surface area exposed to heat during roasting which can enable faster, more uniform, heat transfer throughout the green coffee bean particles. It will be appreciated that any sized grounds are contemplated. Providing small grounds can allow for more uniform roasting and faster roasting, which may be desirable. It will be appreciated that the steps of roasting, grinding, and brewing can be performed as three separate discrete steps. However, as described herein, partial or complete overlapping of these steps in time or space is contemplated and may reduce the total time required to make coffee. For example, the roasting and grinding may occur in the same vessel and the grinding may begin as some beans are roasted. Another example is that grinding and brewing may occur in the same vessel and the grinding may occur in a wet grind process which can initiate the brewing process. Other variations of combining process steps can occur.

Referring to FIG. 5, the integrated beverage system 400 can have an array of sensors 418 built in to measure process parameters along with feedback control systems to optimize the performance of each step described herein. For Roasting 112, such sensors can include a camera/color sensor to determine color change of beans during roasting, a humidity/water sensor to measure the water content in the roasting chamber, humidity sensor for ambient local air, a carbon monoxide sensor, a carbon dioxide sensor to measure CO2 emission during roasting, an optical spectroscopy system to measure chemical emissions during roasting, a temperature and time measurement along with roast profile control, a microphone sensor to listen for noise emissions during roasting, a gas chromatography or mass spectrometer to measure molecular species during roasting, or any other suitable sensor.

Roasting 112 can include roasting of coffee grounds in single serve portions with the green coffee grounds provided in small pods. The roasting can occur within a few minutes and can roast, for example, from about 0.1 to about 2 grams, from about 2 to about 10 grams, or from about 10 to about 50 grams of grounds. The composition of the gas in the roasting chamber can be controlled as desired to be air, or some other mix of gases to aid in roasting. The integrated beverage system 400 can rapidly rise in temperature from ambient temperature of approximately 20 degrees Celsius to several hundred degrees Celsius in a precisely controlled manner. An ultrafast heater temperature increase ramp rate can be utilized that can be in the range of from about 1 to about 10 C/second, from about 10 to about 50 C/sec, from about 50 to about 100 C/sec, from about 100 to about 200 C/sec, from about 200 C/sec and higher, or combinations thereof. At the end of Roasting 112, the temperature can be rapidly cooled and the temperature decrease ramp rate can be in the range of from about 0.1 to about 10 C/second, from about 10 to about 50 C/sec, from about 50 to about 100 C/sec, from about 100 to about 200 C/sec, or combinations thereof. The overall time for roasting can be in the range of from about 1 to about 30 seconds, from about 30 to about 60 seconds, from about 60 to about 90 seconds, from about 90 to about 120 seconds, from about 120 to about 300 seconds, or any other suitable time. Roasting 112 can include a rapid heating method to roast the grounds and this heat can be applied by convection, conduction, radiation, or by any other suitable system or mechanism. Roasting can occur at temperature ranges of from about 200 to about 250 Celsius, from about 250 to about 300 C, from about 300 to about 350 C, from about 350 to about 400 C, from about 400 to about 500 C, or other such high temperature as desired. After Roasting 112, it may be desirable to rapidly quench the grounds (i.e., rapidly cool down the grounds) to stop the ongoing processes in the grounds due to latent heat inside the grounds. This may be done in one of several ways including, for example, water immersion quenching or forced air quenching of the beans or grounds. The water used to brew the coffee can serve to quench the heat of the beans, where the water used for brewing can be just under 100 Celsius in contrast to the several hundred degree Celsius roast temperature.

Roasting 112 can include a heating method that can enable the rapid temperature rise of the grounds. Referring to FIG. 5, a roasting system 414 can include an electrical resistor heating element 420 and a motor 422 associated with a fan (not shown) that can be used to heat and blow air into a chamber 424, where this air can heat the coffee beans through convective heating. It will be appreciated that Roasting 112 can include any suitable heating system or method such as laser heating, where a laser of specific wavelength, spot size, and power level can be directed via an optical system to the green coffee grounds, which can absorb the radiation and heat up. Laser heating of green coffee grounds can be used to rapidly roast green coffee beans. The use of a laser can allow for direct heating of the grounds without heating up the air or other space around the grounds. Laser heating may provide very precise delivery of heat to the grounds since the heat source can be removed when the laser is turned off or blocked. The laser can be operated in a continuous mode, pulsed mode or some sequential combination of these modes to provide the exact dose of thermal energy to optimize Roasting 112. The grounds can be agitated mechanically or with air to move them into the path of the laser beam. The laser beam delivery system can be mounted on a mechanical system to move the beam across the array of coffee grounds to be roasted. Optical systems can be used to distribute the laser light uniformly across the grounds, or can be used to create a desired illumination profile across the coffee grounds. The laser used for illumination can be a diode laser, a diode laser single emitter, an array of diode laser single emitters, a diode laser bar, a diode laser stack of bars, or any other suitable laser or combination of lasers. The laser diodes can operate in the visible wavelength range, the near infrared wavelength range, or other infrared wavelength ranges, for example. The laser wavelength of operation can be chosen to correspond with specific spectral absorption features of the coffee grounds. A potential benefit of operating in the near infrared wavelength range is the commercial availability of high power laser diodes that have been developed for other applications. Roasting 112 can also be performed using a combination of heating methods that can include the laser radiation method along with convective resistive heating. In another embodiment of optical heating methods, a light emitting diode (LED) can be used instead of the laser light source with an appropriate optical system to direct the light from LED to the coffee grounds. In another embodiment, microwave energy can be used to rapidly heat and roast the grounds.

Roasting 112 can also include radiation heating. Infrared or visible wavelength emission lamps can be used as the heating element. The green coffee grounds can absorb the radiated light from a bulb and heat up until roasted (the bulb can emit in the visible wavelength range, infrared wavelength range, or bands of wavelengths deemed desirable such as mid infrared, far infrared, etc.). The use of a lamp 421 (FIG. 20) can allow for fast roasting and direct heating of the green coffee grounds. The lamp can be operated in continuous, pulsed, or some combination of these modes to provide the exact dose of thermal energy to optimize roasting. Lamps emit light in multiple directions and some emitted light may not hit the grounds. Thus to efficiently use the optical energy, it may be preferable to use optical cavity designs to collect and direct the emitted light to the target coffee grounds. Such optical cavity designs can include elliptical reflective cavities, multi-ellipse cavities, circular reflective cavities, etc. These cavity designs can be applied to roasting coffee where the coffee ground are placed in a transparent tube at one focus of the ellipse and the lamp is placed at the other focus such that the elliptical cavity focuses light onto the coffee beans. The optical cavity can be designed to illuminate the beans with a desired intensity profile for specific roasting as desired. The roasting can also be done using a combination of heating methods including a lamp radiation method along with convective resistive heating (fluidized bed methods). Any suitable cavity design can be used to capture and direct light to a focal spot while also homogenizing the focal spot light intensity.

In some cases, it may be desirable to roast coffee beans with a hybrid convective and radiation based roasting system. An example of such a roasting system 414 is shown in FIG. 20, and can include an electrical resistor heating element 420 and a motor 422 that can be used to heat air in a chamber 424, such that hot air can flow around the perimeter of the chamber and optical radiation can radiate from a central lamp 421. The lamp 421 can be chosen for wavelengths in any part of the visible or infrared wavelength ranges. A potential benefit of this type of roasting can be the decoupling of the heating source, which may be optical, from the air flow that can agitate the beans. This separation can allow the independent control of roast process variables. Infrared optical roasting of green beans may result in coffee with a higher anti-oxidant concentration than green beans roasted with convective roasting. A hybrid roaster can allow for the programmable control of the heating source that is used, and the amount of that heating source, such that a roasting program can be adjusted to optimize the anti-oxidant concentration of the resultant coffee. Caffeine concentration of brewed coffee beverage can vary with the degree of roasting, where darker roasts may have a lower caffeine concentration. A hybrid optical and convective roaster can allow the customer to roast to a desired taste profile, caffeine concentration, antioxidant concentration, or to other desirable parameters. Chlorogenic acid, which may aid in weight loss or weight control, can be controlled by programming and adjusting the roasting parameters of the roaster and roasting process.

During roasting of green coffee grounds, the color of the grounds can change from green to dark brown or black depending on the length of time roasted (longer time generally gives a darker color). Traditionally, these roast types and colors are denoted as cinnamon/New England, city/full city, Vienna, espresso, Italian, and French. Using quantitative measurements and methods such as precision imaging and signal processing, Roasting 112 can include a finer gradation in roast progress and thus much finer taste control. As the grounds are roasted, some smoke may be emitted and chaff may be released from the outside skin of the bean. The integrated beverage system 400 (for example, FIG. 5) can capture the smoke and/or the chaff such as with, for example, a catalytic converter, activated charcoal, or a filter 460 that can have an exhaust 462. During the roasting process the beans or grounds can emit a defined popping sound at different times during roasting known as first crack and second crack. These sounds can be indicative of roasting progress and audio monitoring of this sound, such as with sensor 418, with feedback control can be used to optimize roasting. During roasting, the beans or grounds emit an aroma that is pleasant to many people and a desirable trait to smell. The integrated beverage system 400 can include elements or features, such as containers or fans, to capture and disperse this aroma outside of the machine into the local environment for the pleasure of the consumer. In another embodiment, the integrated beverage system 400 can capture the aroma scent into a small hollow container, or container with porous polymer resins such as TENAX, or other device that can be opened later to release the aroma as desired by the user (or the aroma containment system could be attached to a coffee cup with aroma released in a time release manner, or at some later time).

Roasting 112 generally includes heat, where extra waste heat from this process can be used to heat or pre-heat the water needed for the brewing process. As one example, water can be passed over the hot beans or grounds after roasting, which can serve to quench the roasting process in the beans and heat the water. This can improve the energy efficiency within the integrated beverage system 12. Power efficiency in all steps of roasting, grinding, and brewing can be optimized or adjusted to provide the consumer with the highest quality coffee in the fastest possible time. As one example, the electrical power limit of most standard single phase electrical circuits in the US is approximately 1500 Watts. A roaster may consume up to, for example, 1500 Watts. A grinder may consume from about 100 to about 200 Watts, and a fast water heater or boiler for the brewing system may consume in the range of about 1000 to about 1500 Watts. In order to prepare a cup of coffee quickly, multiple stages can be operated in parallel or a stage can be prepared in advance so that it is ready (e.g., preheating the water to the desired temperature). Optimizing power efficiency of the roaster, or any other component, can allow parallel operations to take place such as heating the water while the roaster is in operation. Optical roasting may be advantageous because of the direct absorption of energy by the bean, which may allow the roaster to be more efficient and may keep power consumption below the common 1500 Watt limit. In some cases it may be desirable to modulate the aroma release such that the smell sensory system of the consumer does not become saturated and de-sensitized to the aroma.

The integrated beverage system 400 can include any suitable components or elements that can automate handling of the grounds to move them from stage to stage of Method 100. For example, moving the grounds from packaging to roasting to brewing. Robotic handling methods are contemplated are described in more detail herein. Referring to FIGS. 5 and 20, upon completion of Roasting 112, the roasting system 414 can open a trap door 426 that can allow the roasted grounds to gravitationally move down a chute 428 to a brewing system 430. It will be appreciated that any suitable mechanism or system to facilitate movement of the roasted grounds, such as a conveyor belt, is contemplated.

Referring to FIG. 2, the method 100 can include Brewing 114. Brewing 114 can include brewing particles that are ground and roasted. Brewing 114 can be performed by passing heated water through the grounds, which can extract the coffee into the liquid. Referring to FIG. 5, the integrated beverage system 400 can include a brewing system 430 that can include a brew chamber 432 that can accept the roasted grounds from the chute 428. The brew chamber 432 can be coupled with a water reservoir 434 via a tube 436. The water reservoir 434 can be associated with a heating element 438 and a water heater 440 such that heated water can be pumped with a pump 442 to the brew chamber 432. The water reservoir can include a funnel 444 such that water can be poured into the water reservoir 434. The water heater 440 and heating element 438 can include a rapid water heating system that can quickly bring water to the proper temperature for brewing coffee. The water temperature can be brought to boiling (212 F), or some other temperature range such as from about 150 degrees to about 160 degrees Fahrenheit, from about 160 degrees to about 175 degrees Fahrenheit, from about 176 to about 195 degrees Fahrenheit, from about 196 degrees to about 211 degrees Fahrenheit, or any other suitable temperature. A water temperature in the range of from about 195 degrees to about 205 degrees Fahrenheit is contemplated. It may be desirable to brew at relatively lower temperatures, such as with what is known as ‘cold brew’, which can result in a different taste of coffee. Cold brewing can be done at or near room temperature and the steep time can be many hours to days. In an example embodiment, overall water temperature can be reduced, by using high speed centrifugal forces in the brew extraction process to rapidly mix and agitate the grinds within the liquid water. A suitable balance of water temperature between ambient and 212 F is contemplated, and high speed centrifugal forces can be used to quickly brew coffee to the desired taste.

Referring to FIG. 5, the coffee grounds can be retained within the brew chamber 432, where the brew chamber 432 can be associated with a filter 446 that can be positioned at the bottom of the brew chamber 432. The filter 446 can be paper or metallic mesh, for example. The coffee grounds can be tamped or compressed by the brew system 430 as desired where, for example, the brew system 430 can include a piston 448 that can be coupled with a motor 450. The pressure of compression can be varied by the integrated beverage system 400 as desired. This can be performed by controlling piston 448 movement or by use of an adjustable pressure relief valve that can control the release of coffee from the brew chamber 432. In some cases, multiple parallel pistons (not shown) can be used where the specific amount of grinds, quantity of hot water, the steep time, and other extraction parameters may be different for each piston and associated brew chamber to create varying taste profiles, where the output of all piston brewers can be mixed into one cup for consumption by the consumer. Water can be injected into the brew chamber 432 at high pressure or any other suitable pressure, including a drip method. The water pressure can range from about 0.1 bar to about 18 bar depending on the coffee type (e.g., coffee, espresso, etc.) desired and the desired taste of coffee. A refractometer or other sensors 452 can be incorporated into the integrated beverage system 400 and can provide real time measurement and feedback control of various brew parameters to optimize coffee taste. The amount of water used in making a cup of coffee can be from about 0.1 ounces to about 20 ounces, or any suitable amount. The brewing time can be less than one second, from about 1.01 second to about 30 seconds, from about 30.01 second to about 60 seconds, from about 60.01 seconds to about 120 seconds, from about 120.01 seconds to about 180 seconds, from about 180.01 seconds to about 300 seconds, from about 300.01 second or longer, or any other suitable time frame.

Referring to FIG. 2, the Method 100 can include Dispensing 116. Dispensing 116 can include dispensing the coffee or other prepared beverage from the integrated beverage system 400 (FIG. 5). Dispensing 116 can include dispensing the coffee via a nozzle or valve 453 into a cup or any other suitable receptacle. Cup sizes or other aspects of the delivery can be specified by the user or preprogrammed. Various other fluids or substances can be combined during Dispensing 116 where, for example, milk, creamer, sugar, whipped cream, sweetener, flavoring, vitamins, or other products can be added manually or automatically. Espresso-based drinks are contemplated and include espresso, cappuccino, latte, etc. In example embodiments, an integrated beverage system, as described herein, can be used with a tamping mechanism for grinds and the brewing components can be replaced or supplemented with a high pressure boiler system for the water. The pressurized hot water can be forced through the grinds and espresso extraction can occur. Additionally, the integrated beverage system can contain a milk heater, steamer, and/or frothing function. Such systems may be used in a professional cafe or restaurant setting, where it may be desirable to prepare multiple independent cups of coffee at the same time. A single machine can be configured with multiple components such that multiple cups of coffee can be made in parallel. Certain steps or components in such a system may be performed independently, such as roasting, grinding, or brewing, but some elements may be in common such as a common water heating system with valves or pumps to direct water to the appropriate location. Common electronic control systems can be used that can control multiple roasters, grinders, or brewers. Such a machine can also have a robotic handling system that can automatically choose and insert an appropriate coffee container from a variety of options, in accordance with a user's order, into the integrated beverage system for processing.

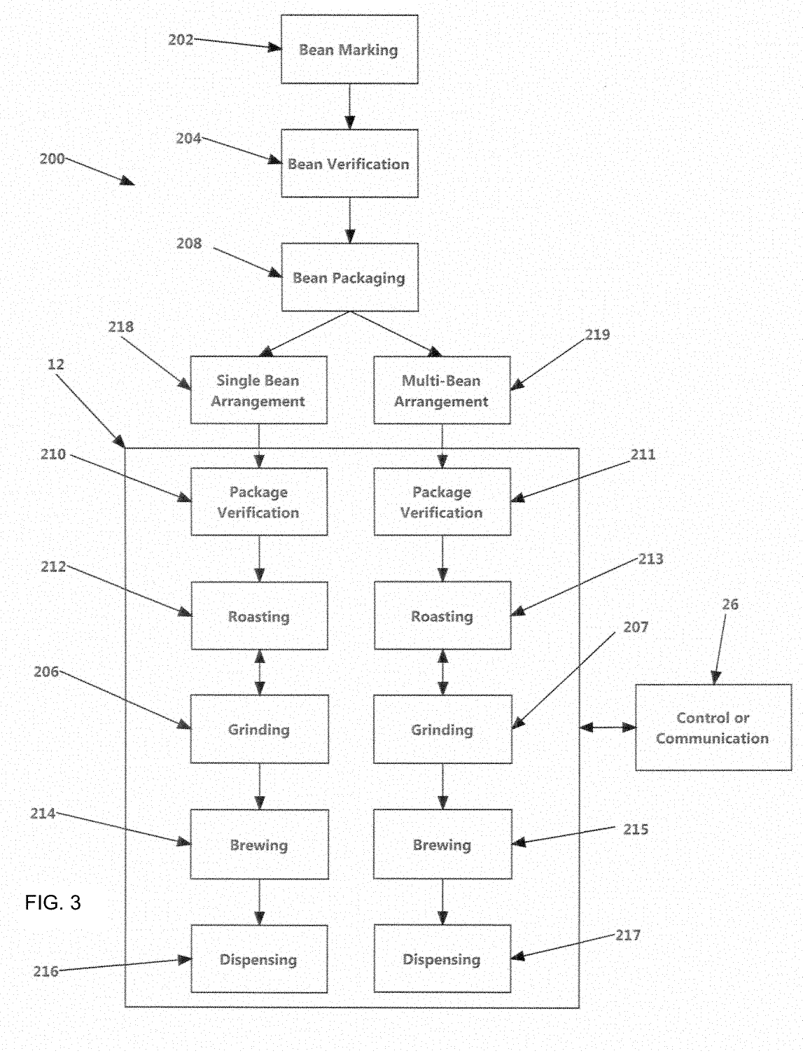

Referring to FIG. 3, an alternate Method 200 is depicted for providing coffee to a consumer. Method 200 can be performed at least partially by the interactive beverage system 10, the integrated beverage system 12, the integrated beverage system 500, or the integrated beverage system 1500. It will be appreciated that any suitable steps of the method 200 can be performed by the integrated beverage system 500 or can be performed independently from the integrated beverage system 500. In some embodiment, the entire process of Method 200 can happen quickly such as, for example, in from about 0.01 to about 30 seconds, from about 30.01 to about 60.0 seconds, from about 60.01 to about 120.0 seconds, from about 120.01 to about 300 seconds, or from about 300.01 to about 600 seconds. Traditional coffee brewing methods generally take much longer than this and even one step, such as pourover brewing, can take 4 minutes or more.

The method 200 can include the steps of Bean Marking 202 and Bean Verification 204, which can be analogous to the steps of Bean Marking 102 and Bean Verification 104, respectively, as described with reference to FIG. 2.

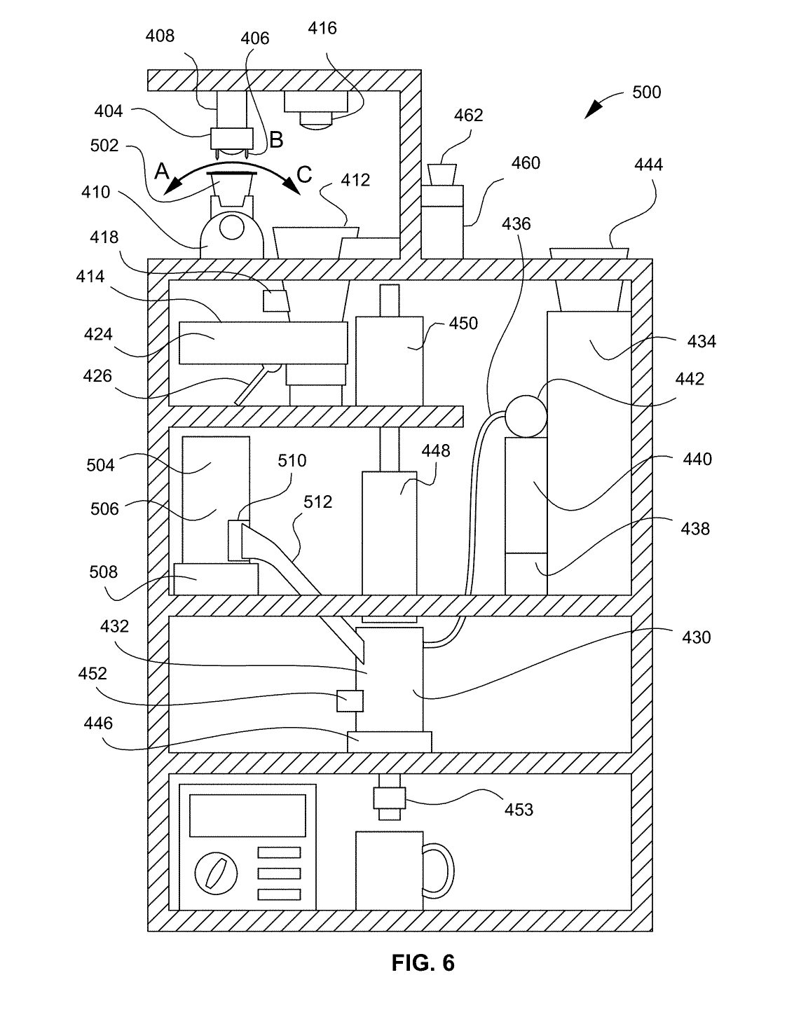

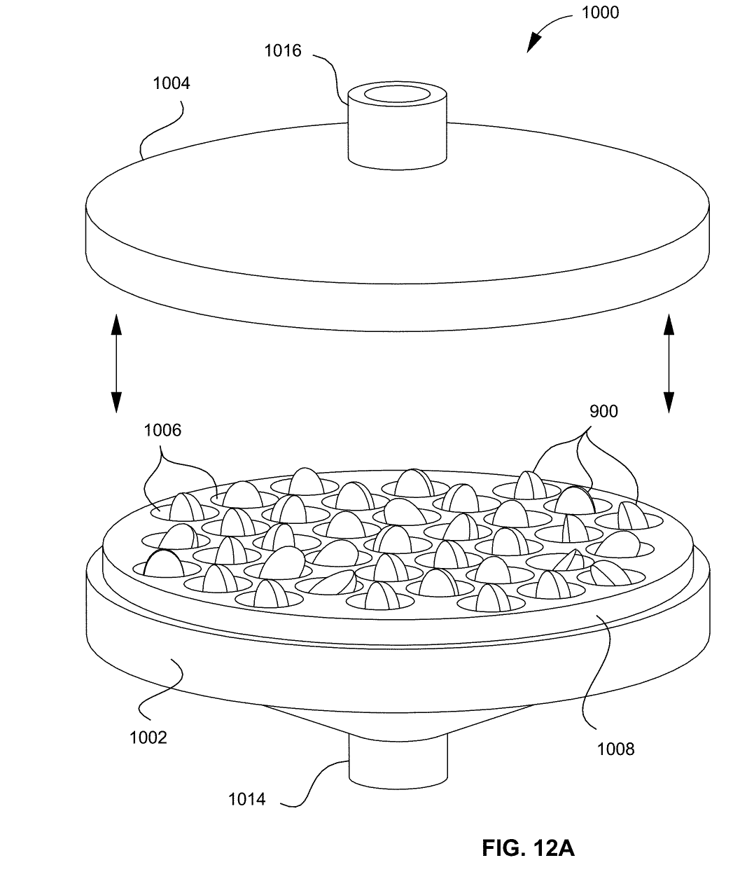

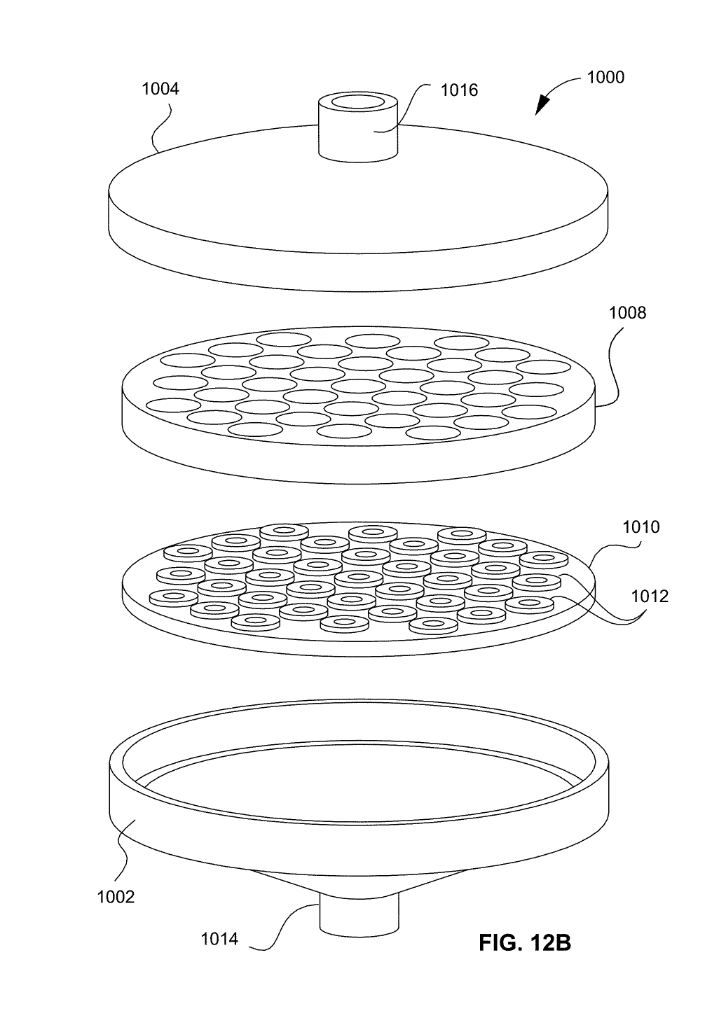

The method 200 can include the step of Bean Packaging 208. Bean Packaging 208 can be similar to, and can include the disclosure of, the step of Packaging Grounds 108 described in FIG. 2. In an example embodiment, it may be preferable to package whole unroasted or “green” coffee beans prior to roasting or grinding. A single pod or container 1000 (FIG. 12) can be packaged and organized as a series of independent coffee beans (Bean Arrangement 218) or a container 502 (FIGS. 6, 10) can simply be filled and packaged with a predetermined number of coffee beans (Multi-Bean Arrangement 219). Coffee may degrade in freshness from the moment it is ground, where it may be preferable to package and ship unroasted whole coffee beans to consumers prior to grinding or roasting. Volatile organic compounds can be created during roasting that can make up at least a portion of the flavor of coffee, where these compounds may escape from the beans from the moment of roast ending such that the longer the roasted beans sit, the more VOC's are lost to the atmosphere. It may be preferable to retain the beans in an unroasted state for as long as possible.

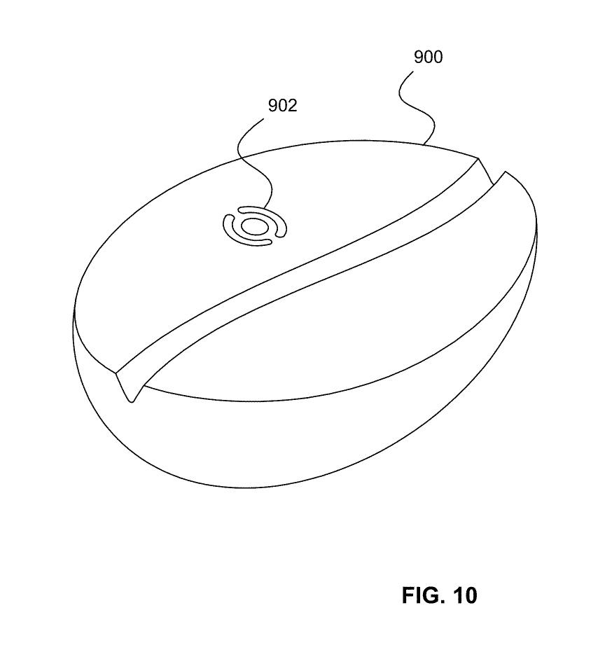

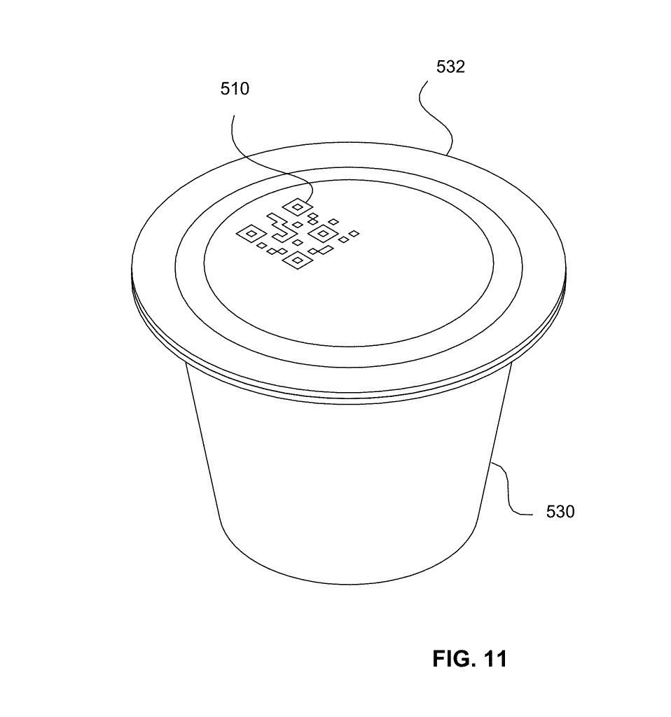

For the step of Bean Packaging 208, which can include the Single Bean Arrangement 218 (container 1000 shown in FIG. 12) and Multi-Bean Arrangement 219 (container 502 shown in FIG. 11) steps, green coffee beans can be packaged into small enclosed containers or pods where each pod can contain enough green coffee beans to produce one serving of coffee. The one or a plurality of pods or packages can be hermetically sealed with a seal 504 and can include a validation marking 510. These containers, such as container 502, can be used with the integrated beverage system 500. The container 502 can include a body 530 that can define a cavity configured to retain a plurality of coffee beans and a seal 532 that can be manually or automatically punctured, removed, or otherwise opened as described herein. Green coffee beans generally have a long shelf life relative to roasted coffee beans and do not degrade rapidly, where the shelf life of green coffee beans may be years or more if stored properly. An example container 502 can be filled with a gas to preserve the enclosed beans for long periods of time. Any suitable fluid or gas can be used including atmospheric air, nitrogen, inert gas, noble gas, or the pod may be vacuum packed. In some cases the pod may be filled with positive pressure gas (e.g., nitrogen, noble gas, or others). Each container 502 can contain approximately from about 0.1 to about 2 grams, from about 2 to about 10 grams, or from about 10 to about 70 grams of green coffee beans. In certain cases, certain beans are known to improve with age and exposure to air, where containers 502 containing such beans can be packaged with a breathable membrane that can allow for atmospheric air exchange.

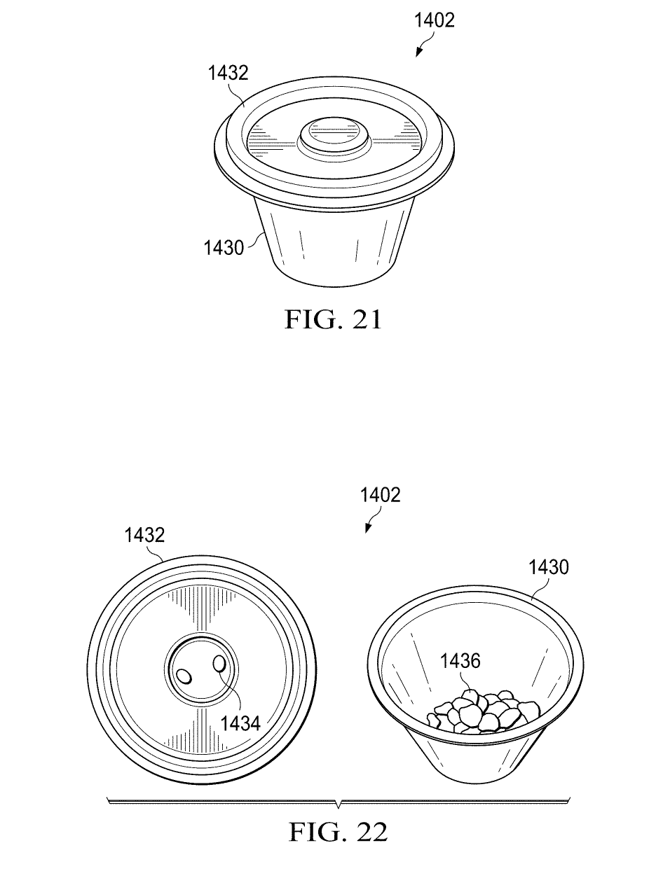

Referring to FIG. 21, an alternate version of a container 1402 is shown that can be constructed from recyclable or compostable material. The container 1402 can include a body 1430 and a lid 1432, where each element can be compostable or recyclable. Referring to FIG. 22, the underside of the lid 1432 can include one or a plurality of plant or fauna seeds 1434 and the body 1430 can retain roasted and brewed coffee grounds 1436, where such coffee grounds 1436 can be excellent fertilizer. After the container 1402 has been used with the integrated beverage system, soil can be added to the coffee grounds and the entire container 1402 can be planted in the ground. In such a manner what was once unrecyclable trash can now be transformed into a readymade planter. The integrated beverage system or process may unlock or release this seed 1434 during or after the coffee making process to make it easier to use the pod as a planter. For example, the seed 1432 may be contained in a water soluble pouch (not shown) or covering that may dissolve during a coffee process step to expose the seed. Heat can be used to expose the seed or any other mechanism to expose the seed can be incorporated. Alternatively, the end user can manually access the seed 1434 after the coffee making process is finished. In one embodiment, the packaging container (not shown) in which an array of pods is shipped may contain a package of seeds for the end user to implant into the used pods. The packaging container could hold, for example, any suitable number of pods such as 1, 2, 10, 100 or any other number. The packaging container may also contain other items to aid in growth of seeds such as soil, fertilizer, or the like. The packaging container of an array of pods may be designed so that it becomes a holder (not shown) of the pods in a planter configuration that can make it convenient for the end user to grow an array of plants simultaneously in a compact space for indoor gardening or outdoor gardening (the planter may be vertical, horizontal, or other configuration). In such an embodiment every part of the packaging, or substantially every part of the packaging, can be re-used with no waste.

In one embodiment, used pods can be shipped back to a central facility for distribution to end users that want to use the pods for planting. The pods can be inserted partially into each other to be stackable and save space during shipping. The pods can be used in a greenhouse or other farming operation to grow new plants. The pods can be designed to mate into receptacles for ease of use in growing facilities such as farms or greenhouses. The pod can also be made of edible material such as sorghum or the like. These edible materials can be made shelf stable by processing using any suitable method. Such edible material pods may be used as foodstuffs for human or animal consumption after making coffee, or may be faster to biodegrade after use.

Referring back to FIG. 11, in an example embodiment, beans can be pre-sorted and packaged with beans of a similar size and color into a single container 502. The value of this sorting may be that the roasting of the beans will progress similarly when exposed to heat and thus produce a uniform roast, which may be desirable. Such a sorting system can also detect spoiled or undesirable beans that may have phenol content or other impurities that impair taste of the final beverage. Containers 502, as described herein, can be marked to help verify the authenticity of the coffee pod, to prevent counterfeit pods from working in the integrated beverage system 12, to encode bean information and optimum preparation recipe instructions, to encode origin information, to prevent tampering, or to act as anti-counterfeit measures.

Note that the pods may be inserted into a machine or array of machines by an automatic external robotic system that may pick a pod out of an array of pods based on the user choice and initiates operation of the coffee machine. The resulting cup of coffee may be robotically moved by the system to a position to serve the customer such that the machine becomes available for the next use. The used pod may be automatically removed from the machine by the machine itself or external robotic system. The robotics system may have RFID, camera system with computer vision, or the like, to be able to pick the correct pod from the array as desired by the user.

The pod may have enough coffee beans to make 1 cup of coffee, 2 cups of coffee, or any N number of cups of coffee and the cup size may vary depending on user preference (the pod may contain beans that are a non-integer number of cups of coffee also). The liquid used to brew the coffee may be water, water with additives for nutritional benefit such as antioxidants or other healthful ingredients. The water may be pH controlled or other minerals/ingredients added for optimal taste. The water may come from multiple reservoirs in the machine (each reservoir may have different water characteristics) and can be mixed in real time to control the pH or other characteristics of the water. The brewing system may have more than one boiler such that brewing can be sequentially done with water of different temperatures to control flavors extracted at each step. The water heating may be done by boiler system, instant hot water system, or other methods including heat exchanger from hot air.

Referring to FIGS. 12A and 12B, the container 1000 can be configured such that each bean of a plurality of unroasted coffee beans 900 can be individually roasted by an integrated coffee system 12. The container 1000 can include a base 1002 that can engage with a lid 1004 such that a plurality of unroasted coffee beans 900 can be retained therebetween. The plurality of unroasted coffee beans 900 can reside within a plurality of cavities 1006 that can be defined by a tray 1008. Referring to FIG. 12B, the tray 1008 can rest upon a thick film substrate 1010 that can include a plurality of thick film heaters 1012, where each of the thick film heaters 1012 can be configured to be in close proximity with each of the plurality of beans 900 held within the tray 1008. During operation, air can be forced through an intake 1014 in the base 1002 such that the plurality of thick film heaters 1012 can heat the local air to turn roast the plurality of unroasted coffee beans 900. The lid 1004 can include an exhaust 1016 that can be used to expel smoke or the like. It will be appreciated that any configuration for a container that can roast beans individually is contemplated. In an example embodiment, the container 1000 can be purchased as a contained unit where the container 1000 can be inserted into the integrated beverage system 12. After roasting, the container 1000 can be mechanically and automatically opened or otherwise emptied such that the roasted beans can be transferred to a grinding mechanism. The roasted beans can be removed, for example, by tipping over the container 1000, using a high fan speed associated with a heating element to eject the beans, or a vacuum that could be used to suction the beans out of the container 1000. In an alternative embodiment, single-bean roasting can be accomplished by having a common fan system and a common heating system that can blow hot air towards beans that can be arranged in pockets as shown in FIG. 12A. In such an embodiment, an independent mechanical shutter can be positioned below each bean in the array that can allow air to flow to the bean when the shutter is open or can obstruct air flow when the shutter is closed such that roast control on an individual bean can be provided.

The container 1000 can be associated with an optical imaging system (not shown) with a camera that can monitor the color change of each bean during roasting. This information can be used with a feedback control system to turn on/off or adjust the heat and/or airflow to each bean independently. Other sensors described herein can also be used in conjunction with the camera for feedback control on either an individual bean basis or on an aggregate basis.

Bean Packaging 208 can include packaging coffee beans, where some processing step has already been performed on the beans prior to packaging. For example, the green coffee beans can be partially roasted and then packaged into the container 502 (FIG. 6), which may save roasting time when prepared by the consumer. The partial roasting can be performed, for example, in a manner that can preserve the freshness of the bean and can prevent or delay decaying or staleness of the bean relative to conventional roasting. For example, partial roasting could stop at or before “first crack” of the coffee bean.

The Method 200 of FIG. 3 can include the steps of Package Verification 210, 211, which can correspond with the step of Package Verification 110 described with reference to FIG. 2. Package Verification 210, 211 can be performed by the integrated beverage system 500, scanner 404, manually by the user, by inputting information into a personal computer 14, a smartphone 22, or any other suitable input device.

The Method 200 can include steps for Roasting 212, 213. As illustrated in FIG. 3, the Roasting 212, 213 steps can be performed by the integrated beverage system 500 and can include the disclosure of the Roasting 112 step described with reference to FIG. 2. Although Method 200 generally describes the steps for creating coffee in the order of roasting, grinding, and brewing as three separate discrete steps, it will be appreciated that any suitable order or combination is contemplated. For example, partial or complete overlapping of these steps in time or space is contemplated, where such a combination may reduce the total time required to make coffee. For example, the roasting and grinding may occur in the same vessel and grinding may begin as bean roasting begins. In an alternate embodiment, grinding and brewing can occur in the same vessel and the grinding can occur in a wet grind process which initiates the brewing process. Other variations of combining process steps are contemplated. In some cases it may be desirable to rapidly quench the roasting of the beans after external heat application has stopped. Heat internal to the beans may continue the roasting process. An alternate approach to rapid quenching can include quickly grinding the beans to increase surface area exposure to air. At this point, air can be flowed through the grounds to cool the coffee grounds. An alternate embodiment can include immersing the grounds in water, where the water is of lower temperature than the roasting temperature such that roasting can be quenched. The rapid quenching process can be performed by an integrated beverage system as described herein, or can be used separately for quenching roasted beans independent of any other machine.

In one embodiment, it may be advantageous to rapidly de-gas the carbon dioxide that can be built up in the bean during roasting. With typical roasting, the beans generally remain whole for some period of time after roasting. In one embodiment, the beans can be ground quickly after roasting, which can greatly increase the surface area of the beans exposed to air and can increase the rate that CO2 escapes from the beans or grounds. A vacuum can be provided in the chamber holding the grounds such that the pressure in the chamber can be reduced below ambient air pressure. This vacuum may be to levels such as about 0.5 atmospheres, about 0.1 atmospheres, about 0.01 atmospheres, about 0.001 atmospheres, or any other pressure level to aid in the rapid release of CO2 gas. In some cases it may be advantageous to illuminate the grounds with optical energy corresponding to the absorption wavelength of CO2 molecules such as 10.6 um.

With reference to Roasting 212 in a Single Bean Arrangement 218, roasting of beans can be done on an individual basis, which may create uniform roasting and can optimize taste. The quantity of green beans needed for a single cup of coffee may range from 50 to 500 beans, where approximately 100 beans may be typical. Individual beans can be arranged in the single-serve container 502 such that each bean can be exposed to a radiative light based heating system (e.g., laser, LED, lamp, etc.), where the beans can be aligned in a pattern with a corresponding pattern of illumination sources (this can include a 1:1 mapping, or N:M mapping of sources to beans). This can include optical only roasting, convective roasting only, fluidized bed roasting, or hybrid optical/convective roasting. An optical system can be used between the sources and beans such that each bean is illuminated by one light source with the desired illumination pattern. Each light source can have individual power control or sub-arrays or the light source can have a single power control. By using a 1:1 mapping of light sources to beans, each bean can be illuminated and heated with individual control. A camera can be used to image the color of the beans and along with image processing algorithms can be used to provide feedback or individual power adjustment control to the individual light sources to optimize roasting (a wavelength selective filter can be placed in front of the camera to filter out the light used to roast the beans). In an example embodiment, the beans can be roasted to substantially the same degree of roast (e.g., color of roast) or a roast blend can intentionally be created where some beans can be roasted to a different degree purposefully to get a desired taste profile. In an alternate embodiment, instead of single bean cavities, several separate cavities can be created containing a subset of beans and corresponding lamps can be controlled separately based on feedback sensors to optimize roast within each cavity. The beans from plurality of cavities can, for example, be mixed before grinding. An array of resistive heating elements, with each element in contact with one bean, can be used as an alternative to a light-based heating system. It will be appreciated that any suitable system, method, or mechanism to individually roast a single bean, or a small number of beans, is contemplated.

The integrated beverage system 500 (FIG. 6) can have an array of sensors 418, 452 built in to measure process parameters along with feedback control systems that can optimize the performance of each step the machine performs. For roasting, such sensors 418 can include a camera or color sensor that can determine color change of beans during roasting, a humidity or water sensor that can measure the water content in the roasting chamber, a humidity sensor that can measure ambient local air, a carbon dioxide sensor that can measure CO2 emission during roasting, an optical spectroscopy system that can measure chemical emissions during roasting, a gas chromatography / mass spectrometry (GC/MS) system to measure chemical emissions, a temperature and time measurement sensor than can be combined with a roast profile control, or a microphone sensor to listen for first crack, second crack of the beans, or noise emissions during roasting.

The Method 200 can include the steps of Grinding 206, 207. The Grinding 206, 207 steps can be performed by the integrated beverage system 500 and can include the disclosure of the Grinding 106 step described with reference to FIG. 2. The integrated beverage system 500 can include any suitable grinder system 504 that can grind the roasted beans into any suitably sized particles. The grinder system 504 can accept the roasted beans from the trap door 426. The grinder system 504 can include a body 506, a motor 508, a grain-size filter 510, and a chute 512 that can convey roasted grounds to the brewing system 430. The average particle size can vary, for example, from between about 10 microns to about 2000 microns. An electrically powered grinder can be adjustable to a desired particle size. The grinder system 504 can include a blade grinder, a burr grinder, a disc burr grinder, a conical burr grinder, ultrasonic grinder, wet grinder, mortar and pestle grinder, or any other grinder. The grinder system 504 can be configured to produce a uniform particle size or particles having varying sizes. Grinding time can be from about 1 second to about 10 seconds, from about 10 second to about 30 seconds, from about 30 second to about 60 seconds, from about 60 second to about 120 seconds, or for greater than 120 seconds. The grinder system 504 can also be adaptively controlled such that the mechanical adjustment of grind size can be determined by the degree of roasting of the coffee beans performed in the integrated beverage system 500. The fracture mechanics of coffee beans in the grinder system 504 can depend on the degree of roasting such that darker roasts may fracture to finer particles than lighter roasts even when the mechanics of the grinder remain unchanged. It may be valuable to adjust grinder system 504 mechanics based on information about the degree of coffee bean roasting.

In an example embodiment, after Roasting 212, 214, the integrated beverage system 500 can automatically move the roasted beans from the roasting stage to the grinder system 504 using gravity or active transportation. After Grinding 206,207, the integrated beverage system can automatically move the grounds to the brewing system 430.

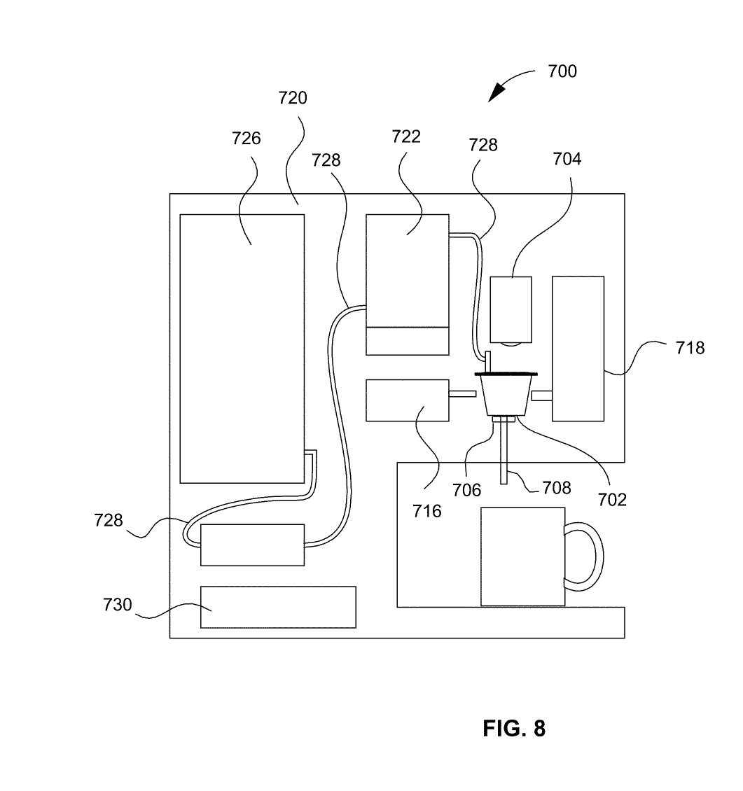

In an alternate embodiment, as will be described in more detail with reference to FIG. 8, after Roasting 212, 214, an integrated beverage system 700 can move a grinding tool 718 that can be associated with Grinding 206, 207 into proximity with roasted beans. After the beans are ground, the integrated beverage system 700 can move the equipment or components associated with Brewing 214, 215 into proximity with the roasted grounds. It will be appreciated that the beans and/or grounds can remain in substantially the same location, where the integrated beverage system 700 can move, rotate, or otherwise bring the tools associated with the Method 200 into proximity with the beans or grounds. In an alternate embodiment, the tools associated with the steps of the Method 200 can remain substantially stationary and the beans or grounds can be moved or otherwise transitioned between various stations. Grinding 206, 207 steps can include sensors such as optical sensors to visually monitor grind size, a vibration sensor (e.g., accelerometer) that can monitor progress of grinding, or a microphone that can measure noise from the grinder to determine grind size. The grind process makes audible noise, where it may be possible to use active noise canceling techniques along with an embedded audio speaker to mute or minimize the noise generated by the grinder. Similarly, other process steps such as roasting or brewing may make audible noise that can be minimized by active noise canceling methods.

The Method 200 can include Brewing 214, 215, which can include the disclosure of Brewing 114 described with reference to FIG. 2, and Dispensing 216, 217, which can include the disclosure of Dispensing 116 described with reference to FIG. 2. Brewing 214, 215 can include sensors 452 (FIG. 5) such as a sensor for water temperature, water pressure, water pH, optical absorption, optical color sensor, optical light scattering, optical polarization to measure coffee extraction from the grind, a refractometer that can measure coffee extraction, a surface plasmon resonance (spr) sensor that can measure other chemical parameters of brewing, or other chemical sensors.

In an alternate embodiment, with reference to FIG. 8, some or all of the steps of Roasting 212, 214, Grinding 206, 207, and Brewing 214, 215 can be performed within a container 702 containing a single-serving size of coffee, where the container 702 can remain substantially stationary. The container 702 that can contain unroasted beans can be engaged by the integrated beverage system 700 such that one or a plurality of grinding, roasting, brewing, scanning, or any other suitable tools or systems act upon the container 702. The container can be installed onto a holder 806 that can also include a dispensing tube 708. The holder 706 can be configured to retain the container 702 throughout the roasting, grinding, and/or brewing process. The holder 706 can retain the container 702 as various tools move into proximity with or engage the container 702. A scanner 704 can initially confirm that the container 702 is not a counterfeit. After the scanner 704, the container 702 can be engaged by a roasting tool 716 for Roasting 212, 214. The roasting tool 716 can include, for example, hot air delivery and an exhaust. After Roasting 212, 214, the integrated beverage system 700 can engage the container 702 with the grinding tool 718 that can be associated with Grinding 206, 207, where any suitable tools, such as a burr grinder or ultrasonic grinder, can enter the container 702 to grind the beans as desired. The container 702 can then be engaged by a brewing tool 720 that can be associated with Brewing 214, 214, where the brewing step can occur wholly or partially within the container 702. The brewing tool 720 can include a hot water reservoir 722, a pump 724, and a water reservoir 726 that can be connected with tubing 728. In this manner, the steps of roasting, grinding, and brewing can occur within the container 702. A computer or control system 730 can guide the tools of the integrated beverage system 700 to engage the container 702.

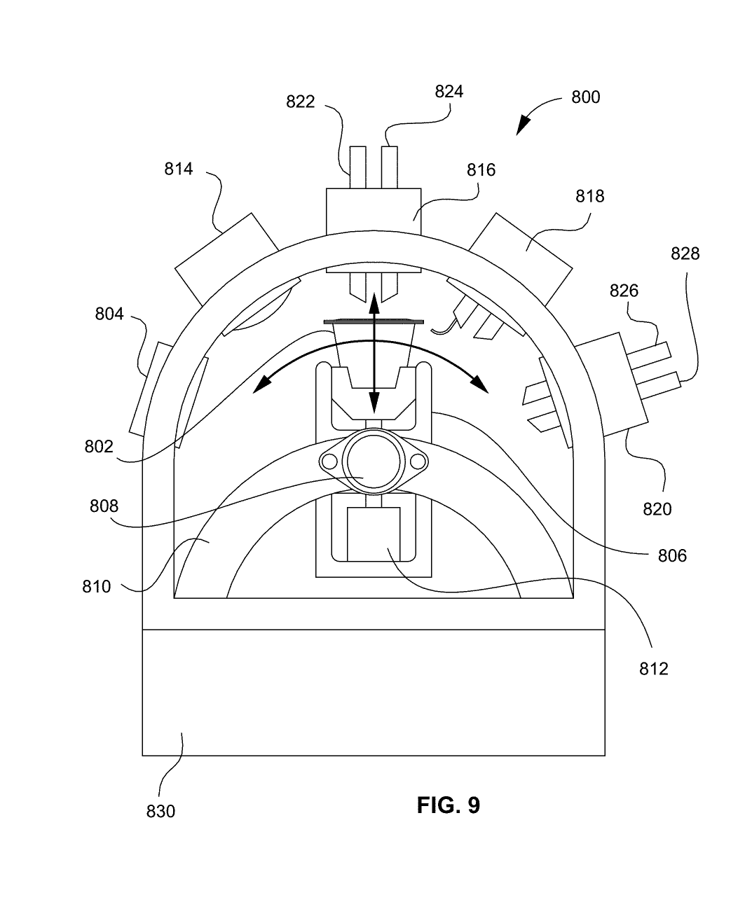

In another alternate embodiment, some or all of the steps of Roasting 212, 214, Grinding 206, 207, and Brewing 214, 215 can be performed within a package 802 containing a single-serving size of coffee, where the package 802 can be moved and the tools remain substantially stationary. For example, referring to FIG. 9, a package 802 containing unroasted beans can be transitioned by a beverage system 800 to a first station 804 that can install the package 802 into a movable holder 806 that can be associated with a stepper motor 808, a track 810, and a linear actuator 812. The holder 806 can be configured to retain the package 802 throughout the roasting, grinding, and brewing process. The holder 806 can transition the package 802 between various stations as the stepper motor 808 moves within the track 810 and where the linear actuator 812 can be configured to engage the package with each station. After the first station 804, the package 802 can be transitioned to a second station 814 that can be used to scan or validate that package 802. After completing the second station 804, the package 802 can be transitioned to a roasting station 816 for Roasting 212, 214. The roasting station 816 can include, for example, hot air delivery 822 and an exhaust 824. After Roasting 212, 214, the integrated beverage system 800 can transition the package 802 to a grinding station 818 that can be associated with Grinding 206, 207, where any suitable tools, such as a burr grinder or ultrasonic grinder, can enter the package 802 to grind the beans as desired. The package 802 can then be transitioned to a brewing station 820 that can be associated with Brewing 214, 214, where the brewing step can occur wholly or partially within the package 802. The brewing station 820 can include a hot water input 826 and a brewed coffee output 826 that can lead to a drinking receptacle. In this manner, the steps of roasting, grinding, and brewing can occur within the package 802 or pod. A computer or control system 830 can guide the stepper motor 808, transition the package 802, or otherwise move the package through the stations of the integrated beverage system 800. In an example embodiment, the package with green coffee beans can contain a resistive heating element that can mate to a current source in the integrated beverage system to roast coffee. In an alternate embodiment, the package can be transparent and can allow optical energy provided by the integrated beverage machine to impinge upon the beans and roast the beans. The integrated beverage machine can break a seal on the package or otherwise puncture the package as needed during these steps. Another approach to grinding is to apply sonic energy to the roasted beans to cause the beans to fracture into small particles; and/or high pressure water may be applied to the beans to cause them to fracture. Water may be injected into the pod in order to brew the coffee.

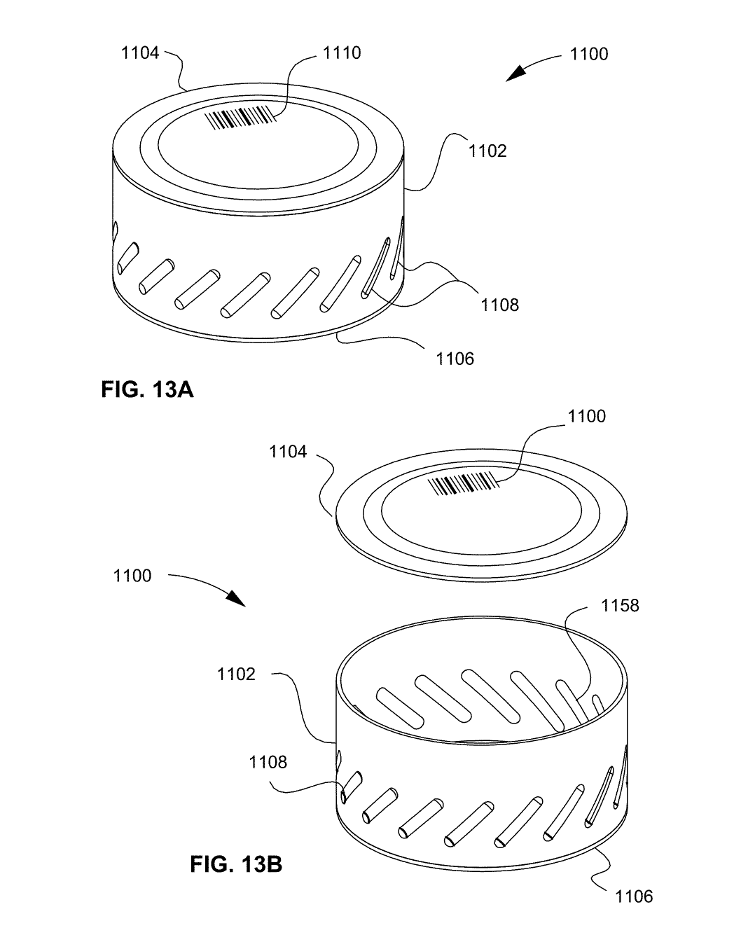

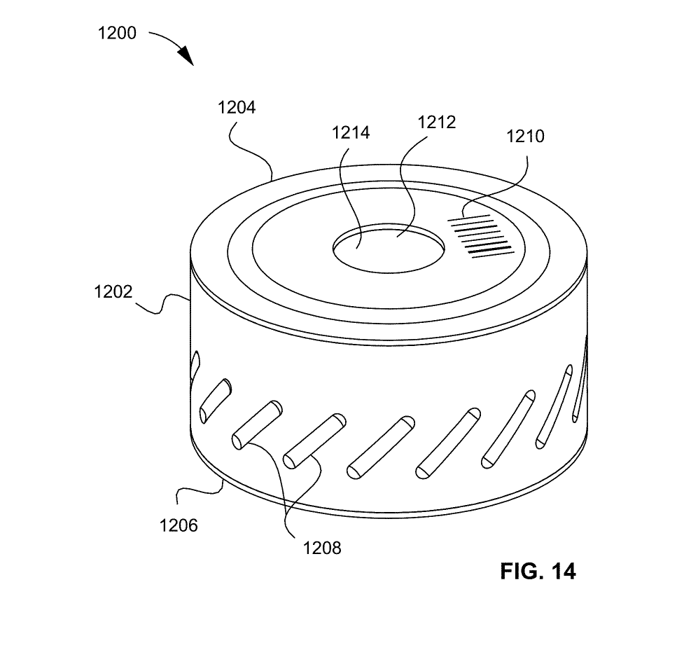

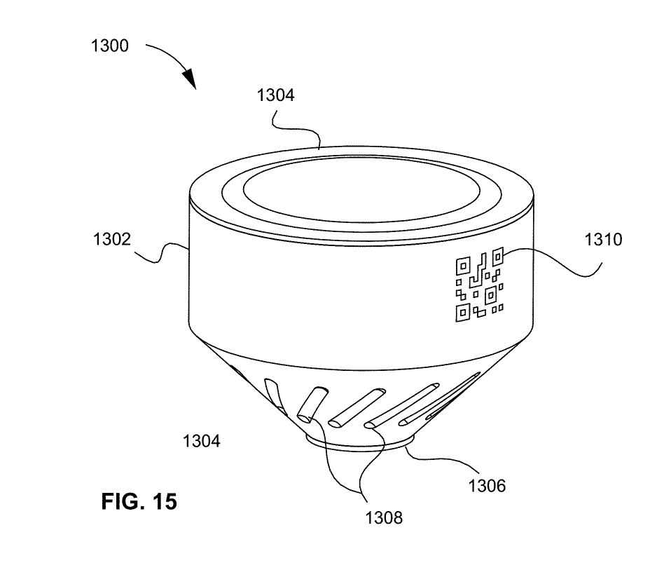

Referring to FIGS. 13A-15B, alternate containers are disclosed that can be configured such that some or all of the steps of Roasting 212, 214, Grinding 206, 207, and Brewing 214, 215 can be performed within the pod or package containing, for example, a single-serving size of coffee. FIGS. 13A and 13B illustrate one version of a container 1100 that can be configured for roasting, grinding, and brewing within the container 1100. The container 1100 can include a cylindrical body 1102 that can be made from metal, aluminum, or any other suitable material and can define a cavity (not shown) that can be configured to retain a plurality of green coffee beans. The container 1100 can include a seal 1104, filter 1106, and a plurality of indents 1108 that can be substantially sealed prior to use of the container 1100. Referring to FIG. 13B, the plurality of indents 1108 can be sealed, for example, by a plurality of flaps 1158. The container 1100 can include a validation marking 1110 that can be read by an integrated beverage system 12 or 800, for example. FIG. 14 illustrates an alternate embodiment of a container 1200, where the container 1200 can have a substantially toroid or donut-shaped body 1202. The container 1200 can include a seal 1204, filter 1206, validation marking 1210, and a plurality of indents 1208. A cylindrical wall 1214 of the body 1202 can define an inner cylinder 1212, where the cylindrical wall of the body 1202 can be substantially transparent. In an example embodiment, the body 1202 can be placed over an optical heating element (not shown) such that light can penetrate the body 1202 through the cylindrical wall 1214 and can roast coffee beans. In an example embodiment, room temperature air can be flowed through the inner cylinder 1212 in the center of the container 1200 to keep the temperature of the transparent cylindrical wall 1214 within acceptable ranges and allow the use of low cost transparent plastics or other materials. It will be appreciated that any suitable container configuration is contemplated that can be used with any suitable roasting system or method. FIGS. 15A and 15B illustrate an alternate embodiment of a container 1300 that can include a body 1302, seal 1304, filter 1306, validation marking 1310, and a plurality of indents 1308 that can be positioned on the filter 1306 or bottom surface of the body 1302. Referring to FIG. 15B, providing forced heated air through the plurality of indents 1308 can cause beans within the container 1300 to travel vertically and radially outward towards the perimeter of the body 1302, where the beans can then drop back down towards the filter 1306 such that the beans are substantially mixed within the container 1300 to provide substantially even roasting.

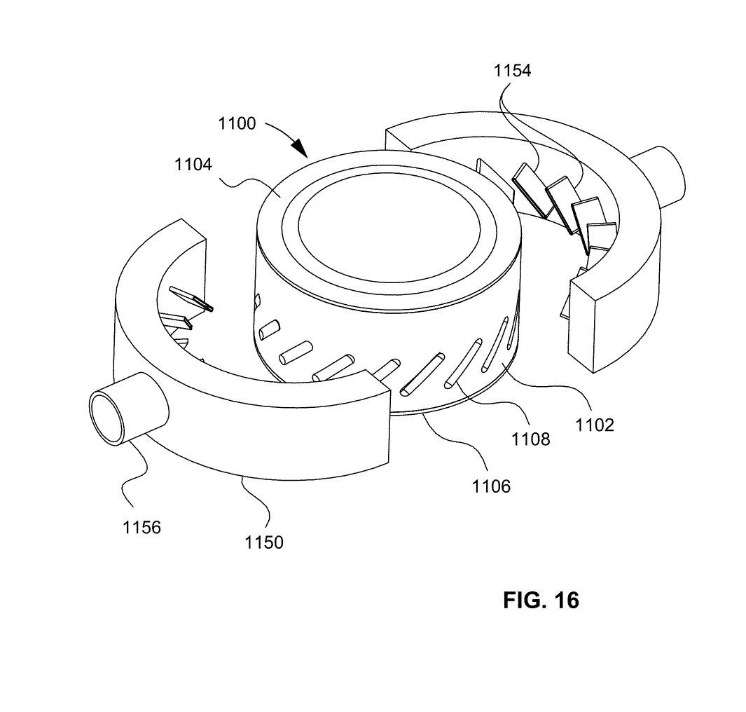

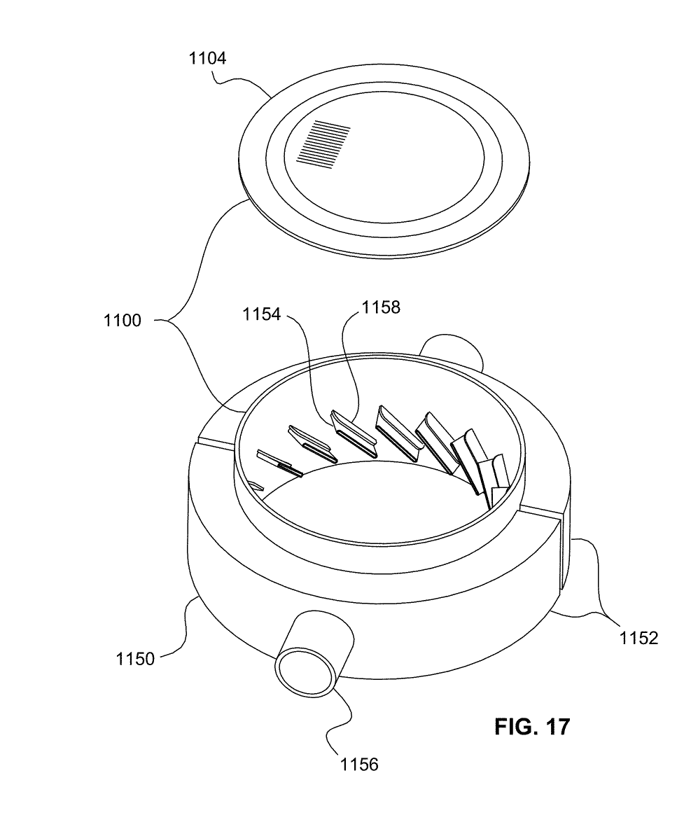

FIGS. 16-19 illustrate an example embodiment of a method for using the container 1100 illustrated in FIGS. 13A and 13B. Referring to FIG. 16, the container 1100 is shown prior to engagement with a roasting assembly 1150 according to one embodiment. The roasting assembly 1150 can include a pair of hemispherical members 1152 that can be actuated to engage the circumference of the body 1102 of the container 1100. The hemispherical members 1152 can include a plurality of hollow teeth 1154 that can be configured to penetrate the plurality of indents 1108 on the body 1102 as shown in FIG. 17. The plurality of hollow teeth 1154 can be coupled with a heat source 1156 that can communicate hot air through the hemispherical members 1152, through the plurality of hollow teeth 1154, and into the cavity defined by the body 1102 such that the beans are roasted. Upon completion of the roasting process, which can be determined by a control system or by the user, the roasting assembly 1150 can be disengaged from the container 1100. When the roasting assembly 1150 is disengaged, a plurality of flaps 1158, which can be pushed inwardly by the plurality of hollow teeth 1154, can return to a resting position and substantially seal the cavity defined by the body 1102.

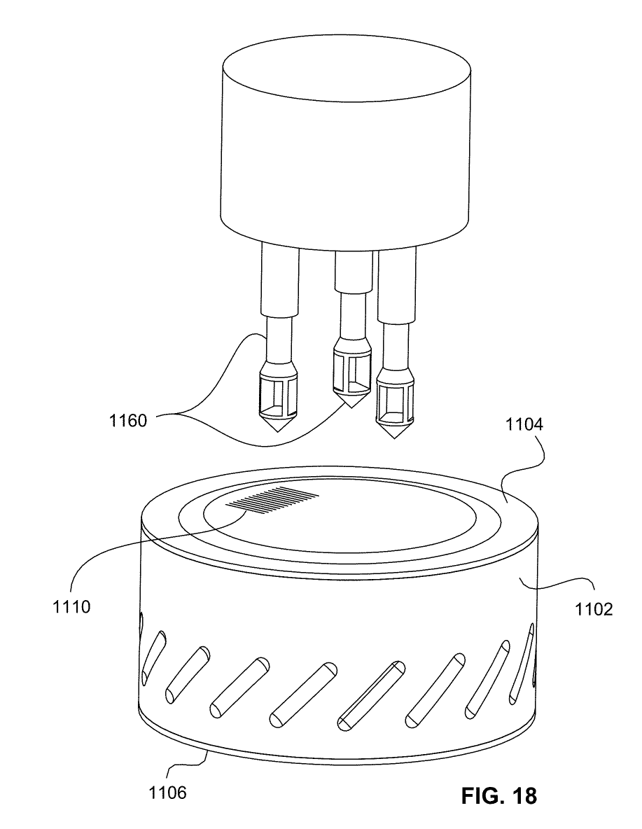

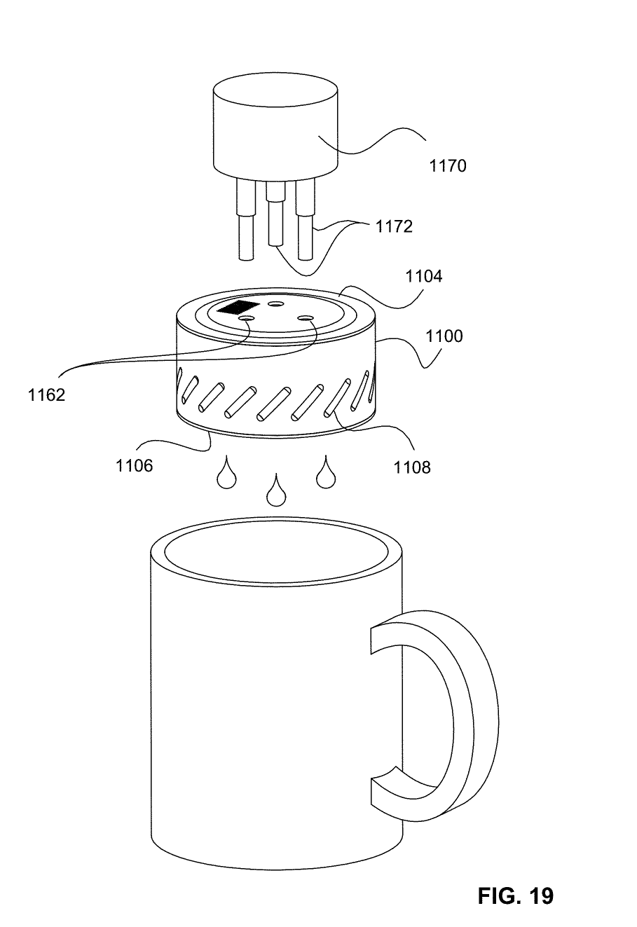

Referring to FIG. 18, a grinding assembly 1160 can be engaged with the container 1100 to grind the beans within the container 1100. The grinding assembly can include a plurality of grinders, such as ultrasonic grinders, that can penetrate the seal 1104 and form one or a plurality of apertures 1162 (FIG. 19). The grinding process can include any suitable tools and any suitable type or direction of penetration. The grinding process can include packaging inert grinding media in the container 1100. The grinding process can use the plurality of indents of the container 1100 to form a portion of a mechanical grinding mechanism. The grinding process can be controlled manually or by any suitable control system. An alternative to physical grinding can be to impinge high pressure water on the beans that can cause the beans to fracture into small pieces. In alternate embodiments, the coffee beans can have small mechanical or laser drilled holes formed in them to ease the fracture process. Hot water or steam can be injected into such holes, which can be used to extract coffee from the beans, which can be referred to as “in-bean brewing”. In an alternate embodiment, the coffee bean can be laser ablated such that the ablation products can be captured and mixed with water to form the drink. In this case, the bean may be a green bean or a roasted bean. The local atmosphere surrounding the beans can be controlled by introducing certain gases or gas mixtures to aid in the laser ablation process. Laser ablation can be performed by pulsed, high peak power lasers such as CO2 lasers, excimer lasers, pulsed diode lasers, and other such lasers. It will be appreciated that coffee beans or coffee grounds can be broken apart, reduced in diameter, ground, mashed, pulverized, cut, chopped, reduced, burst, drilled, cored, fired, or otherwise modified by the integrated beverage system. In an alternate embodiment, the one or a plurality of apertures 1162 can be formed by the integrated beverage system during the roasting stage (for example, as shown in FIG. 13B) such that heated air is able to escape the container 1100.

Referring to FIG. 19, a brewing assembly 1170 can be engaged with the container 1100 to brew coffee within the container 1100. The brewing assembly can contain a plurality of hot water delivery tubes 1172, for example that can deliver hot water through the one or a plurality of apertures 1162 created by the grinding assembly 1160 or roasting assembly. The hot water can engage the coffee grounds, where brewed coffee can then be forced through or can drip through the filter 1106 positioned on the bottom surface of the container 1100.

Referring to FIGS. 69-70B, shown are alternate embodiments for a pod that can contain green unroasted coffee beans, where the coffee beans can be roasted inside the pod. Hot air can be injected into the pod to roast the beans in the pod. The pod can be made of any high temperature material including, for example, metals, ceramics, mica, or the like. Such embodiments can use relatively cost aluminum foil, stainless steel foil, mica paper, baking parchment paper or board, or the like. Features in the pod, such as an angled or ramped floor, may be provided to allow the beans to swirl or agitate in the injected hot air such that the beans can convectively heat evenly but not burn. The bottom of the pod may also have spiral features to create an upward spiral air motion that can cause the beans to spin. The bottom of the pod can include a filter or mesh through which hot air can pass, but the beans cannot pass.

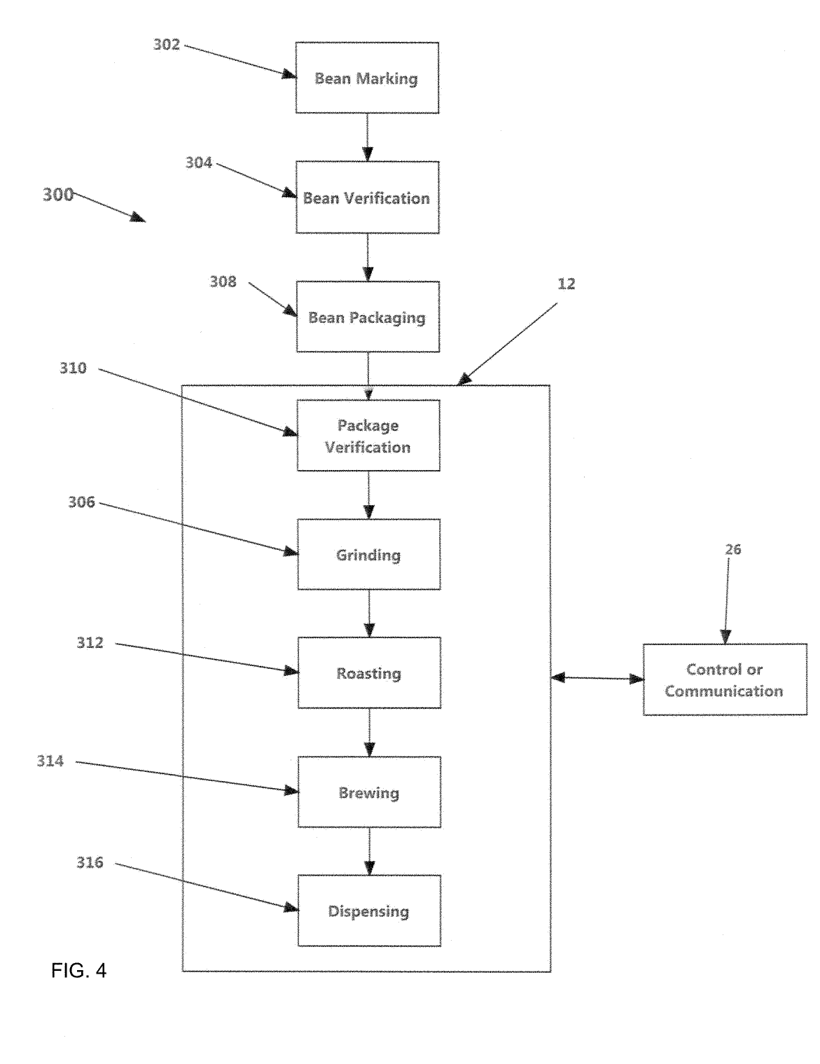

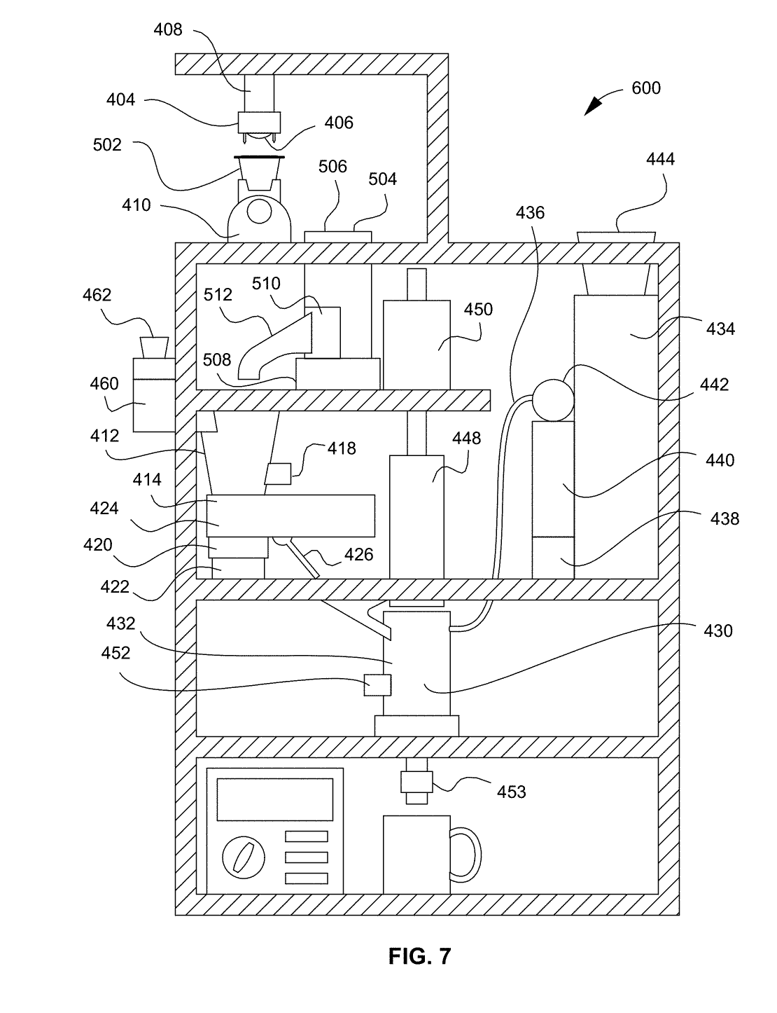

Referring to FIG. 4, an alternate Method 300 is depicted for providing coffee to a consumer. Method 300 can be performed at least partially by the interactive beverage system 10, the integrated beverage system 12, or the integrated beverage system 600 (FIG. 7). It will be appreciated that any suitable steps of the method 300 can be performed by the integrated beverage system 600 or can be performed independently from the integrated beverage system 600.

Method 300 can include the steps of Bean Marking 302 and Bean Verification 304, which can be analogous to the steps of Bean Marking 102 and Bean Verification 104, respectively, as described with reference to FIG. 2. Method 300 can include the step of Bean Packaging 308, which can incorporate the disclosure described with reference to Bean Packaging 208, Single Bean Arrangement 218, or Multi-Bean Arrangement 219 shown in FIG. 3.

Method 300 can include the step of Package Verification, which can incorporate the disclosure of Package Verification 110 shown in FIG. 2. Method 300 can include the step of Grinding 306, which can incorporate the disclosure described with reference to Grinding 206, 207 shown in FIG. 3. As illustrated, unroasted coffee beans can be packaged, such as in single-serving containers 502, where the single-serving package can be inserted into the integrated beverage system 600. The integrated beverage system 600 can then validate the container 502 and remove the coffee beans from the package or pod. After removal, the unroasted coffee beans can go through the Grinding 306 step prior to being roasted. Method 300 can include the step of Roasting 312, which can incorporate the disclosure associated with Roasting 212 shown in FIG. 3. Method 300 can then transition to the steps of Brewing 314 and Dispensing 316, which can correspond to the steps of Brewing 114 and Dispensing 116 shown in FIG. 2. In the illustrated version, the integrated beverage system 12 can verify bean packaging, roast coffee beans, grind coffee beans, and then brew coffee all within the same machine.

In some cases it may be beneficial for a consumer to keep track of their coffee intake. This can be accomplished with the help of a smartphone app or website with personalized information based on the coffee consumption history of that individual. The app can keep track of coffee intake by interfacing with the integrated beverage system 12 of FIG. 1, for example. It is known that the caffeine level in the body is boosted immediately after consuming coffee and decreases in an approximately exponential decay fashion over the course of 10-20 hours. It is also known that caffeine increases mental alertness and acuity. The app can keep track of coffee intake and suggest types of coffee, roast level, etc., to the user to maintain a desired level of mental alertness or acuity (i.e., maintain a certain caffeine level in the body). The app can make these suggestions based on the time, type, quantity of previous coffee drinks, a reference caffeine metabolism curve, and learning about the user's personal caffeine metabolism rate. This personal metabolism rate can be determined by user response to questions or user response to tests of mental acuity. The app can also place an order or control the integrated beverage system 12 of FIG. 1 at the appropriate time. The app can also take into account the long term acclimatization to caffeine that can occur with drinking coffee over days, weeks, or months that can require the user to drink more coffee to reach the same level of mental acuity.

Grinding 206, 207 steps can be performed by the integrated beverage system 500 and can include the disclosure of the Grinding 106 step described with reference to FIG. 2. The integrated beverage system 500 can include any suitable grinder system 504 that can grind the roasted beans into any suitably sized particles. The grinder system 504 can accept the roasted beans from the trap door 426. The grinder system 504 can include a body 506, a motor 508, a grain-size filter 510, and a chute 512 that can convey roasted grounds to the brewing system 430. The average particle size can vary, for example, from between about 10 microns to about 2000 microns. An electrically powered grinder can be adjustable to a desired particle size. The grinder system 504 can include a blade grinder, a burr grinder, a disc burr grinder, a conical burr grinder, ultrasonic grinder, wet grinder, mortar and pestle grinder, or any other grinder. The grinder system 504 can be configured to produce a uniform particle size or particles having varying sizes. Grinding time can be from about 1 second to about 10 seconds, from about 10 second to about 30 seconds, from about 30 second to about 60 seconds, from about 60 second to about 120 seconds, or for greater than 120 seconds. The grinder system 504 can also be adaptively controlled such that the mechanical adjustment of grind size can be determined by the degree of roasting of the coffee beans performed in the integrated beverage system 500. The fracture mechanics of coffee beans in the grinder system 504 can depend on the degree of roasting such that darker roasts may fracture to finer particles than lighter roasts even when the mechanics of the grinder remain unchanged. It may be valuable to adjust grinder system 504 mechanics based on information about the degree of coffee bean roasting.

In an example embodiment, after Roasting 212, 214, the integrated beverage system 500 can automatically move the roasted beans from the roasting stage to the grinder system 504 using gravity or active transportation. After Grinding 206,207, the integrated beverage system can automatically move the grounds to the brewing system 430.

In an alternate embodiment, as will be described in more detail with reference to FIG. 8, after Roasting 212, 214, an integrated beverage system 700 can move a grinding tool 718 that can be associated with Grinding 206, 207 into proximity with roasted beans. After the beans are ground, the integrated beverage system 700 can move the equipment or components associated with Brewing 214, 215 into proximity with the roasted grounds. It will be appreciated that the beans and/or grounds can remain in substantially the same location, where the integrated beverage system 700 can move, rotate, or otherwise bring the tools associated with the Method 200 into proximity with the beans or grounds. In an alternate embodiment, the tools associated with the steps of the Method 200 can remain substantially stationary and the beans or grounds can be moved or otherwise transitioned between various stations. Grinding 206, 207 steps can include sensors such as optical sensors to visually monitor grind size, a vibration sensor (e.g., accelerometer) that can monitor progress of grinding, or a microphone that can measure noise from the grinder to determine grind size. The grind process makes audible noise, where it may be possible to use active noise canceling techniques along with an embedded audio speaker to mute or minimize the noise generated by the grinder. Similarly, other process steps such as roasting or brewing may make audible noise that can be minimized by active noise canceling methods.

The Method 200 can include Brewing 214, 215, which can include the disclosure of Brewing 114 described with reference to FIG. 2, and Dispensing 216, 217, which can include the disclosure of Dispensing 116 described with reference to FIG. 2. Brewing 214, 215 can include sensors 452 (FIG. 5) such as a sensor for water temperature, water pressure, water pH, optical absorption, optical color sensor, optical light scattering, optical polarization to measure coffee extraction from the grind, a refractometer that can measure coffee extraction, a surface plasmon resonance (spr) sensor that can measure other chemical parameters of brewing, or other chemical sensors.

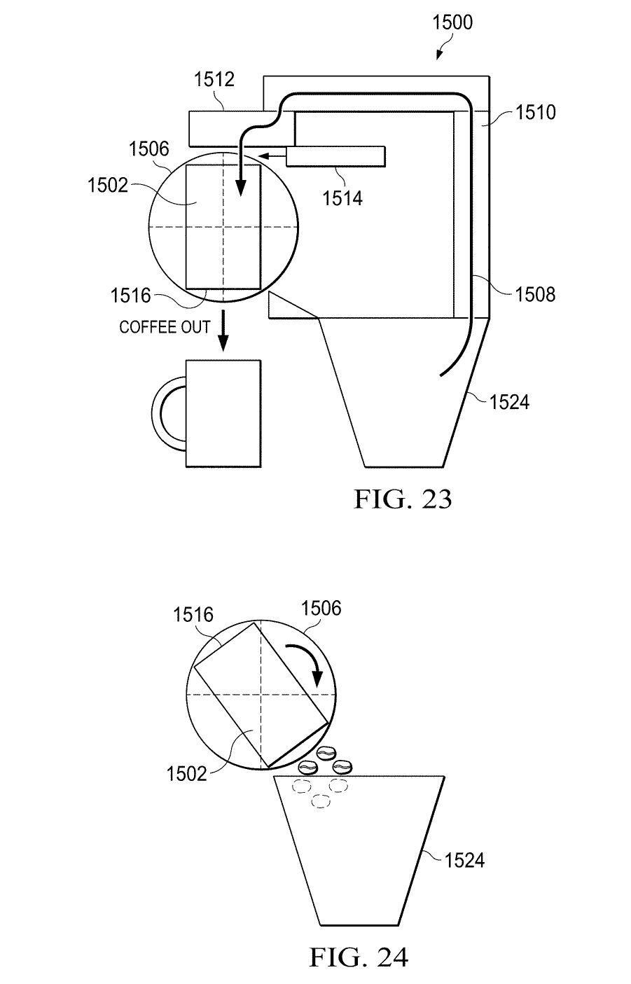

Referring to FIG. 23, an integrated beverage system 1500 can be used in accordance with a roasting, grinding, and brewing system, such as described for example in with respect to Method 200. The integrated beverage system 1500 can have any suitable elements, or features, such as those described in association with the integrated beverage system 500. Roasting can include roasting of coffee beans in single serve portions with the green coffee beans provided in small pods. The roasting, grinding, and brewing processes can include features and steps as described herein. Green coffee beans can be provided in a container or pod 1502, where the pod 1502 can be inserted into the integrated beverage system 1500. In one embodiment, the pod 1502 can be inserted into a rotatable pod holder 1506. The lid 1504 (FIG. 22) of the pod 1502 can be removed manually by the user or by the integrated beverage system. The lid 1504 can be punctured, torn, peeled, or otherwise opened or accessed.

The pod 1502 may be able to hold up to 25 grams of green coffee beans and the grinds from 25 grams of roasted coffee. The pod 1502 can be about 1.375×1.375×2.375 inches in size. The pod can include compostable/biodegradable material. Brewing may occur in the pod 1502 so the material may be such that it can tolerate 100C water for approx 1 minute or more. The pod material may be transparent or opaque and, if opaque, any suitable color or combination of colors is contemplated. The pod can be sealed and airtight. The bottom of the pod 1502 may have a coffee filter integrated into it, where the filter may be a part of the pod (e.g., perforations, etc) or a separate filter paper material attached to the pod. The bottom of pod may be perforated during insertion into the machine or other action of the machine to create or expose the filter paper material. The top of the pod 1502 may be sealed initially, but may need to be opened by the system to allow green beans to exit the pod and allow the ground coffee to be inserted back into pod for brewing. The user may remove the lid of the pod before insertion into the machine, or this may be done automatically. The outside of the pod 1502 may be printed with ink. Markings may include corporate branding, name of bean, etc. An information code (bar code, QR code, etc) may be printed such that the machine can read when the pod is inserted into machine. Visible or invisible security markings may be on the pod to identify authentic pods and prevent third party pods from being used in the machine (RFID or similar may be used if cost is low enough and the materials are compostable). Also the same system may prevent previously used pods from being re-used in the machine. The machine may mark the pod as previously used or record unique serial numbers in a database system and check such a database to prevent re-use.

As shown in FIG. 24, to transfer the green beans from the pod 1502 to a roaster 1524 the pod can be rotated after being opened or punctured. The pod 1502 can be rotated by the pod holder 1506 using a servo or any other suitable mechanism. This may be performed by a Hitec HS311 servo (180 degree rotation) controlled by a Raspberry Pi, for example. The central axis of the pod holder 1506 can be offset from the central axis of the roaster 1524 such that the pod holder 1506 need not rotate a full 180 degrees to dispense beans into the roaster 1524. The pod holder 1506 can have any suitable range of rotation such as, for example, from about 90 degrees to about 180 degrees, from about 120 degrees to about 165 degrees, or from about 150 degrees to about 170 degrees.

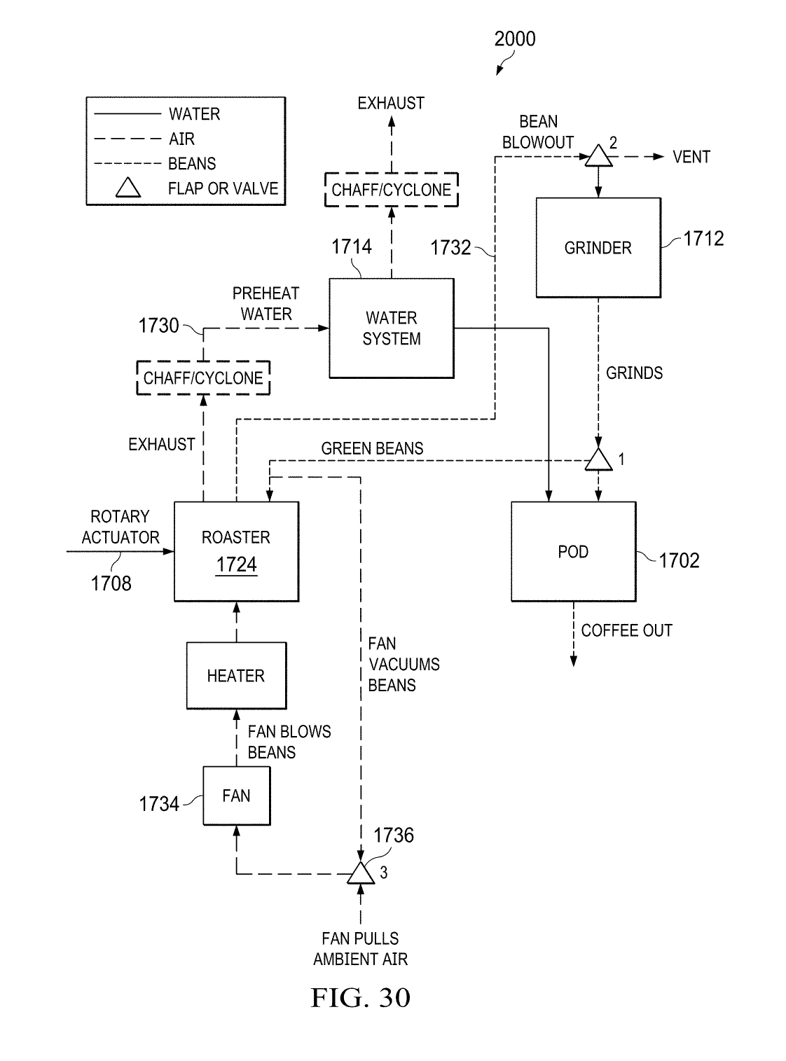

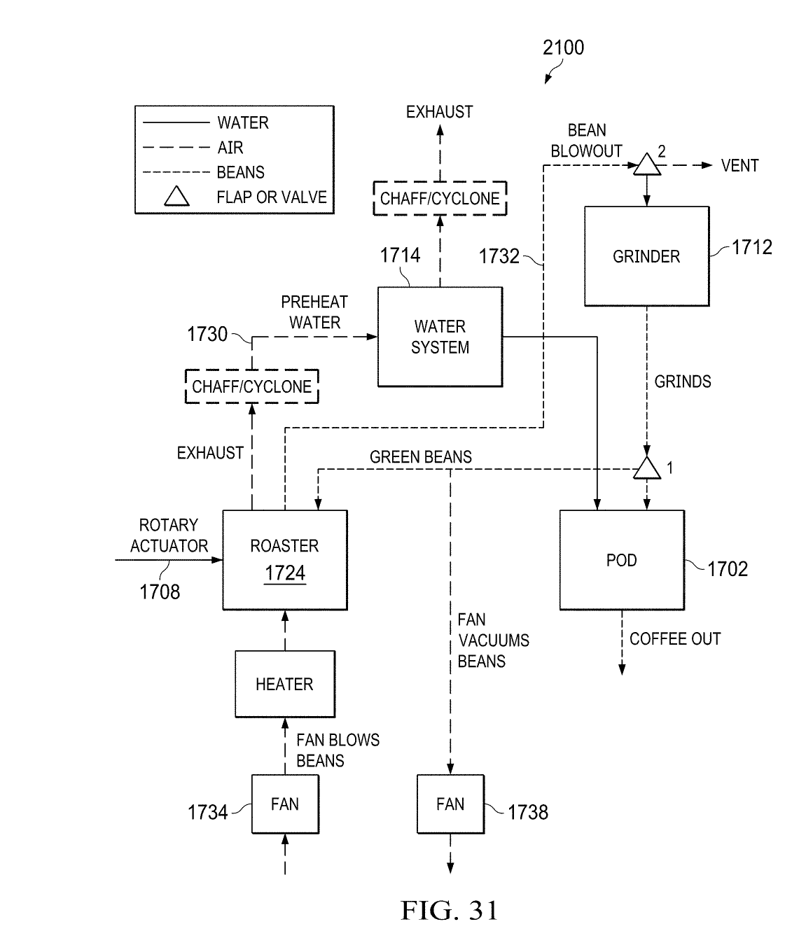

As illustrated the roaster 1524 can positioned at about the bottom of the integrated beverage system 1500. The roaster may be the heaviest of the integrated components and it may be beneficial for the system 1500 to have a low center of gravity. Once the green beans have been introduced into the roaster 1524 they can be roasted in accordance with methods described herein. In particular, a fan (FIGS. 30 and 31) can be associated with the roaster and can be used to facilitate substantially uniform roasting of the beans.

The roaster 1524 may include hot air blown by a fan into a small roast. An AC heater element may be a custom part or an off-the-shelf component. The heater may have over-temp protection and other thermal protection (e.g., thermal diode, bimetallic strip protection, etc.). The heater may consume a maximum of 1250 Watts, a maximum of up to 1500 Watts, or the limit can be the highest power available from a single phase AC power socket, for example. The fan may be a counter rotating fan for high air pressure from Sanyo Denki. The fan may have PWM speed control and RPM tachometer measurement. The roast chamber may have an approximately 2.8 inch tall cone, about 1.5 inch diameter at bottom, and about 3.5 diameter at the top, where other dimensions and designs are contemplated. The roaster 1524 may be thermally insulated to minimize heat loss. The top of the roaster 1524 may have three ports, for example, including green bean loading, exhaust air during roasting, and a roasted bean blowout tube. The exhaust and blowout tubes can be stainless steel having an OD of about 0.875 inches. There may be a moving door on top of the roaster 1524 that opens the appropriate ports during the cycle in the current prototype, which can be actuated by a linear actuator. The roaster 1524 may have a deflector plate that deflects beans out of roaster 1524 and to the grinder 1512 when the roast is completed and the fan may be operated at higher speed (up to 100% fan speed, for example). The roaster 1524 may operate up to about a 250C temperature or higher, where parts can be designed to operate at least at about 300C to provide a safety margin. In one embodiment it may be beneficial to be able to easily disassemble and replace roaster 1524 pieces as needed (simple fittings, screws, etc). A type K thermocouple may be used to measure the temperature in the roast chamber. The roaster 1524 may have a microphone nearby or attached to it to monitor the sounds of roasting (sounds of spinning beans, first crack, second crack, and other sounds) and provide feedback control to the roast algorithm; in addition other sensors such as cameras, laser reflection measurement, humidity, accelerometers may be used to monitor the state of the beans in the roaster and provide feedback to algorithms for roasting.

The roast air exhaust port may be about 250C hot air exiting (typical roaster operating time may be up to 3 minutes or less, for example). One design to cool this hot air may be by routing it thru the water reservoir or boiler to reduce the exhaust temperature and simultaneously pre-heat the water (use of heat exchanger may help with this) as described herein. The exhaust port may have chaff exiting that comes off the green beans. This chaff may need to be collected and disposed of—typical collection may be a mesh screen or cyclonic separator of some sort. This chaff is harmless and tasteless and actually may be directed into the grinder after the roast is finished to be expelled into the pod. There may be smoke in the air exhaust and a smoke filter may be desirable such as, for example, simple carbon/charcoal filter, HEPA filter, etc. The filter may also be used to adjust or control the aroma exiting the machine. Reducing the air temperature of the exhaust by water heat recovery may allow simple standard filters to be used. In some cases for a commercial machine, for example, the exhaust air may be vented to an external fan or system to blow out of the room/building. The roast exhaust port may have a smoke detector in the path to detect smoke and control/stop roasting as a safety measure. Other emission/air sensors may also be included to monitor the state of the roast or for safety measures.

Referring back to FIG. 23, once the roasting process has been completed the roasted beans can be blown out of the roaster by increasing the fan speed. The roasted beans can follow a bean path 1508, where after leaving the roaster 1524 the beans can be ejected through a blowout tube 1510 and into a grinder 1512 that can be positioned substantially above the pod 1502. It will be appreciated that the grinder can include any suitable grinder mechanism such as those described herein. The pod 1502 can be rotated via the pod holder 1506 back to its original upright position underneath the grinder 1512 with the top or lid 1504 open, punctured, or the like. The grinder 1512 can be operated and the grinds can fall back into the pod 1502 through the opened lid 1504. The grinder 1512 can include a conical burr grinder that runs from a 120V AC motor, but other grinders are contemplated. The grinder fineness setting may be manually set and left in one position or can be varied. Embodiments can provide the ability to manually adjust the fineness setting. The grinder can consumes about 100 Watts AC and can be turned on/off via solid state relay controlled by a Raspberry Pi, for example. The grinder can be computer controlled so that the grind size can be controlled by computer software.

Once the roasted grounds are positioned within the pod 1502, a water injection system 1514 can mate to the pod 1502 and can inject hot water into the pod 1502 to brew the coffee. The bottom of the pod 1502 can contain a filtering mechanism 1516 such that the brewed coffee can exit the bottom of the pod 1502 into a user's cup. Such a system can use the pod 1502 for multiple steps in the brewing method where the pod can 1502 can serve to retain the unroasted beans as well as the brewing container for the roasted grounds. Providing the pod 1502 with multiple functions may also reduce the size of the integrated beverage system 1500 as fewer system components may be needed to achieve the desired result.

It will be appreciated that the brewing process using the pod 1502 may introduce more water into the pod 1502 than the volume of the pod 1502 can initially accept. The pod 1502 can be expandable in dimension to allow more water to be injected into the pod during brewing. Such mechanisms of expansion can include accordion folding, origami folding, a flexible balloon-like material for pod, or the like. Air or water may be injected into the pod 1502 to cause such an expansion to occur, or mechanical mechanisms may be used to stretch or expand the pod. A potential benefit of expanding the pod only during the brewing stage is that the pod can be kept relatively small in size for packaging, but expand to allow more volume of water to be contained within the pod during brewing. In an alternative embodiment, the pod 1502 can mate to a fixed container (not shown) that is part of the system 1500. This fixed container can create extra volume for the brewing operation and the hot water for brewing can be injected from the top of the fixed container. The filter 1516 can still be at the bottom of the pod 1502 in such a version and the finished coffee product (or other suitable beverage) can come out of the bottom of the pod. The fixed container may be made of nonstick material or other hydrophobic or superhydrophobic materials to prevent the residue of brewing from sticking to the container to make cleaning easier. Water can also be injected into the fixed container to aid in cleaning in a swirling pattern.

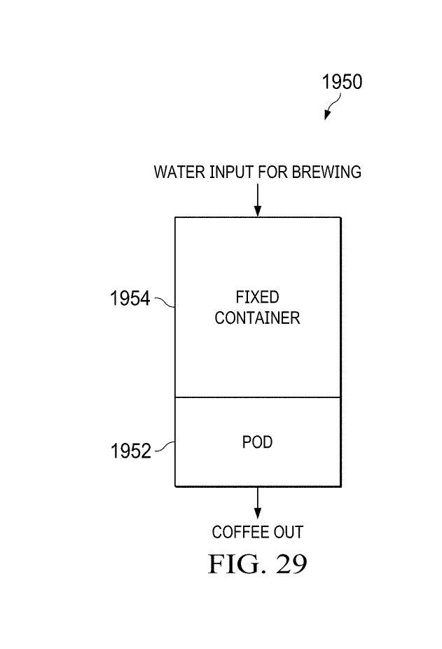

In an alternate embodiment, as shown in FIG. 29, a two-piece or modular system 1950 can be provided. A first portion 1952 can contain green beans and a second portion 1894, which can be removed from the first portion 1952, can be a brewing/filtering portion for brewing that captures the spent grinds and houses the filter. The two pieces may be inserted into the same portion of the machine or into separate parts of the machine, for example. It will be appreciated that any suitable modular features for the pod or container are contemplated. A two-cavity pod concept can provide green coffee beans in the lower portion, where the top portion is empty and fills with coffee grinds after the grinding process. A middle separation layer of filter paper can be provided. The top and bottom of the pod can be sealed to prevent contents from falling out, where these seals can be removed by the system or by the end user. Variations of this concept are contemplated where the two cavities may separate, slide, or disconnect in different ways to allow the green beans to be extracted. In some cases the green beans may be in the top cavity and the bottom cavity may be empty. Any suitable number of cavities is contemplated.

The pod 1502 can incorporate any suitable features to aid in the brewing process. These may be mechanical features incorporated into the body or lid of the pod 1502 and/or inserts (not shown) into the pod 1502 that can aid the mixture of the hot water with the grinds to facilitate even mixing or faster extraction of the drink from the solid grounds. Such features or elements can include spirals, nozzles, helix, ridges, dimples, protrusions, or other features that may enhance the mixture of water and grinds. Such features in the pod may direct water in specific patterns to enhance brewing extraction. The brewing process may also include multiple steps in which a subset quantity of the total quantity of water can be injected into the pod and brewing extraction allowed to occur, where this water can then be forced out of the pod via air injection or any other suitable method. Additional water that may be a subset of the total drink amount can then be injected into the pod, where this water can interact with the grinds (or other drink mixture in the pod) and ejected. This process can continue until the total amount of water is consumed or a desired amount of finished drink is expelled. This process can occur with each subset quantity of water being different. For example, each subset quantity amount may be different such as 1 ounce, 2.2 ounces, 3 ounces, or any other fractional numbers less than the total amount desired. The temperature or pressure of water injection can be different in each subset water injection step as well. The brew interaction time of each subset water injection step may be different. For example, the first subset injection step may be for 10 seconds or any other time and the second subset injection step may be for 14 seconds or any other time.

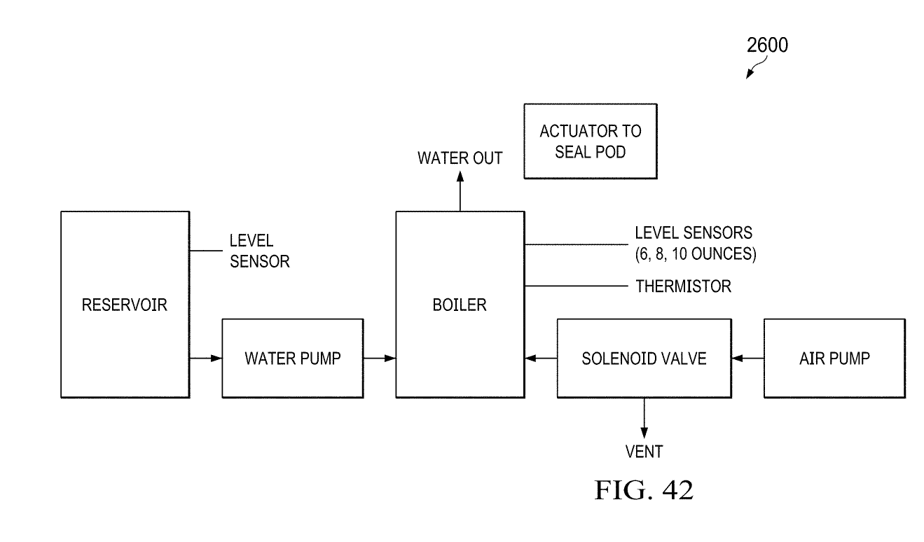

Referring to FIG. 42, integrated beverage system 1500 can have a water system 2600. The water system can include a refillable reservoir water tank. The water tank may be removable from the machine to refill, or can be refilled by pouring water into an external port on the machine. The reservoir may be about 45 ounces or larger, for example. A magnetic float/hall sensor in the water reservoir may be used to determine low water level.

The water system 2600 may include a water pump, boiler, air pump, and solenoid valve. The boiler may have level sensors to sense 6, 8, and 10 ounces of water, or any other suitable water levels. The boiler may consume a maximum of 1500 Watts when on (single phase standard household circuit for the US; in other settings higher power consumption is acceptable), for example. The water pump, air pump, and solenoid may operate from 12V DC, for example. The boiler can have a thermistor to measure temperature. The maximum temperature of the boiler may be 100C, for example, but any temperature is contemplated. The boiler may have over-temperature thermal cutoff built in. The pod may be sealed up to 5 psi for brewing, for example, or higher pressure. For home use the water reservoir can be manually refilled. For commercial system, the water may be plumbed in.

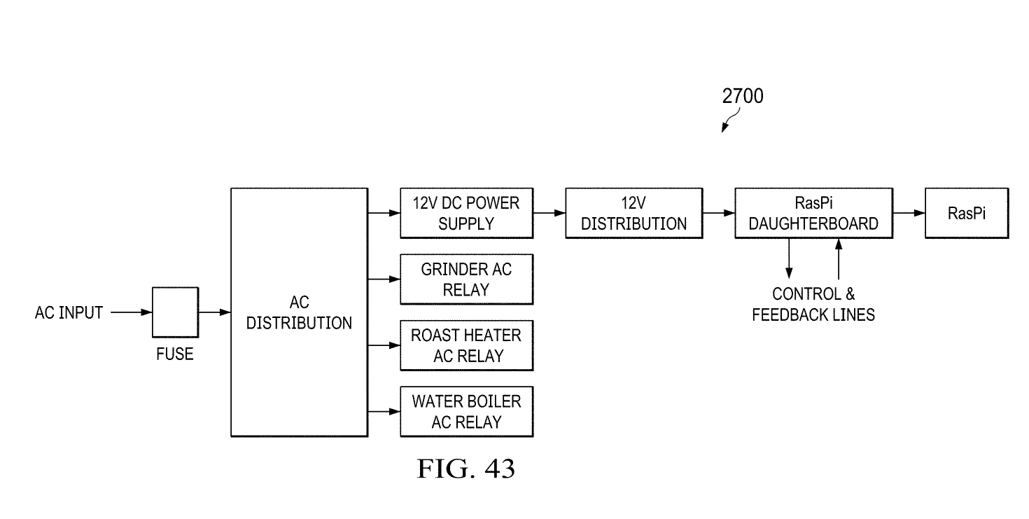

Referring to FIG. 43, integrated beverage system 1500 can have any suitable electrical configuration 2700. The system 1500 can plug into a standard single phase 120V US household outlet. Maximum power consumption may be 1500 Watts, for example. The system can operate over a voltage range of 110V to 130V, or wider voltage range if desirable. The AC power into the system may be voltage stabilized to a fixed voltage level. The ambient temperature in the case in the vicinity of the electronics may be a maximum of 40C or less during operation, for example. The system 1500 may be controlled by a Raspberry Pi or equivalent running Linux. The primary components of the electrical system can include AC power distribution within the box, a 12V DC power brick, a Raspberry Pi with Wi-Fi dongle (and possibly a Bluetooth dongle), a daughterboard for the Raspberry Pi for I/O machine control, and AC solid state relays: 2 high power (1500 Watts each) for roast heater and water heater control; 1 low power AC relay for grinder control, for example.

In alternative embodiments, the pod 1502 can contain extra flavorings, such as chocolate, hazelnut, or the like, and these flavoring can be extracted into the water during the brew process and exit the pod via the filter into the cup. The flavorings can remain at ambient temperature conditions in such embodiments and flavorings may be liquid, powder, or any suitable form. The flavorings can be contained in a water soluble pouch (not shown) within the pod and/or be attached to the inside of pod in some way, or embedded in the pod material, for example.

It will be appreciated that any suitable mechanism can be incorporated into the system 1500 to transfer or extract the green beans from the pod or container. For example, referring to FIG. 25, a vacuum or suction 1518 can be used to direct the beans into the roaster 2024. Alternatively, the original pod may be punctured or a lid may be removed in some way, such as by sliding, such that the green beans may be blown out of the pod by air via a fan or the like.

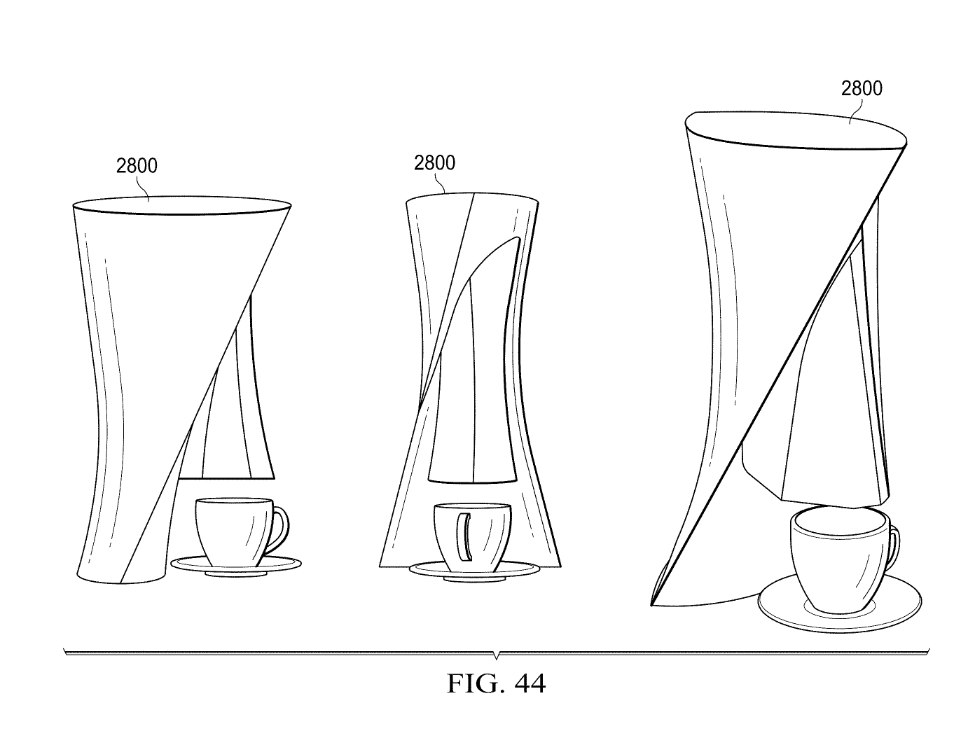

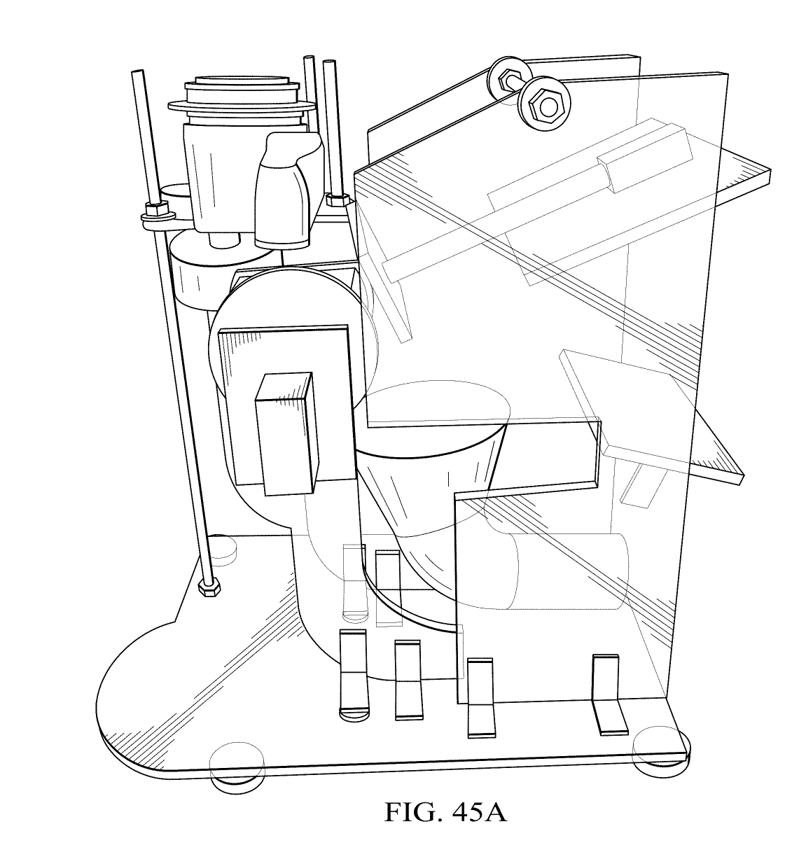

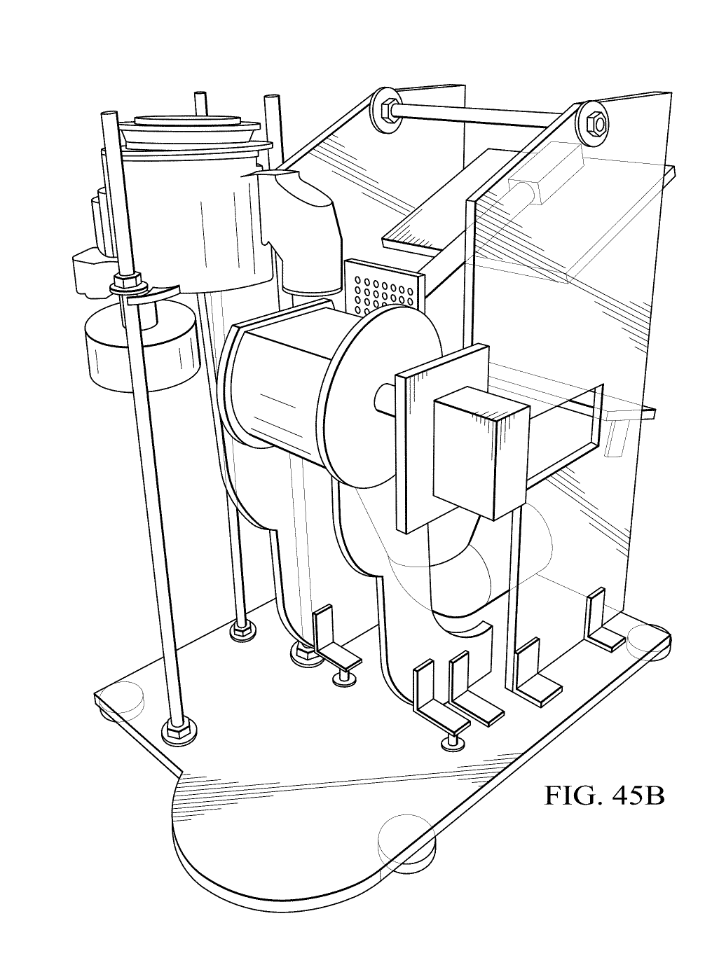

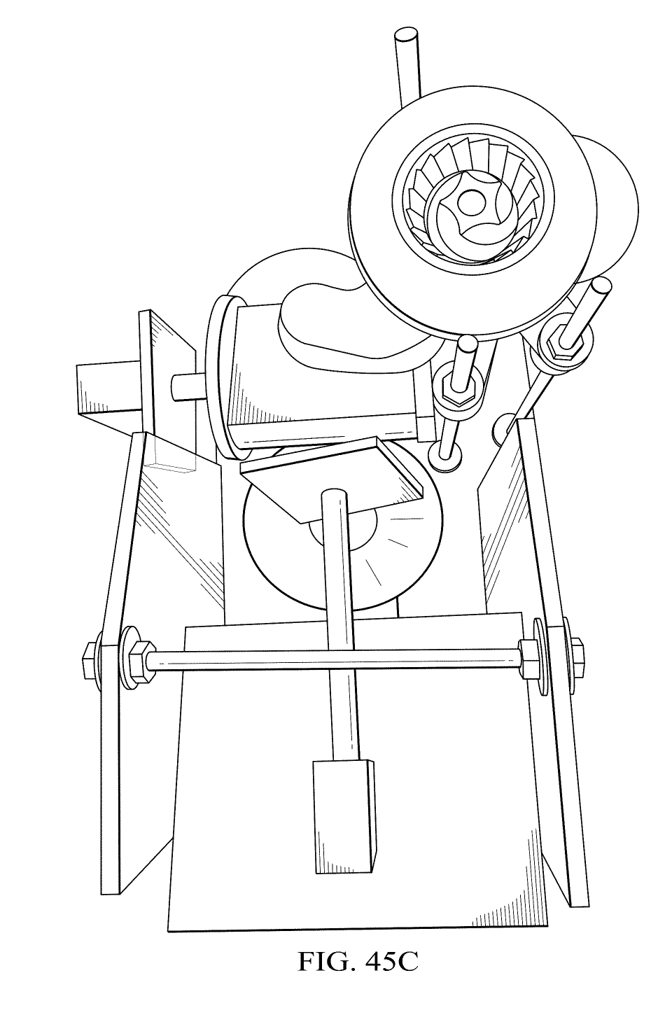

It will be appreciated that the integrated beverage system 1500 may have any suitable casing or housing 2800 as shown in FIG. 44. The system 1500 may be kitchen countertop size. The target dimension of the system 1500 may be maximum 12×12 inch footprint and 12 inches in height, but larger or smaller sizes are contemplated. The housing 2800 may be ventilated to prevent excess heat buildup in the machine, where this may be through a combination of vents, louvers, fans, or the like. The external sound created by the system 1500 can be dampened. Embodiment of the system 1500 may have microphones for listening to user commands and/or listening to sounds within the machine for diagnostics and maintenance notification. The grinder sound may be actively noise cancelled. The external housing 2800 of the system 1500 may be brushed stainless steel or any other suitable material, such as materials that can tolerate heat. It may be preferable to have the case be partially removable to access parts inside the machine without the need to completely remove the entire housing 2800. The system can have any suitable user interface, where the system 1500 may have a power on/off switch, a CPU hard reset switch, a USB cable port connected to a Raspberry Pi, or any other suitable connection points. The machine may have indicator lights such as “power on”, “Wi-Fi connected”, and an operating indicator light when making coffee. In embodiments where a user inserts a pod into the machine a door is contemplated that opens/closes to allow this. The rotating pod holder 1506 may have a cam that pushes open a spring loaded door to allow pod insertion. All the controls of the machine may be via wireless connection. The machine may also have a port for water to be filled into the reservoir. In one embodiment, a minimal user interface is incorporated into the system 1500 for some simple functions, where more complex functions may be via an app over wireless connection. An example version of the system 1500 is shown in FIGS. 45A-C.

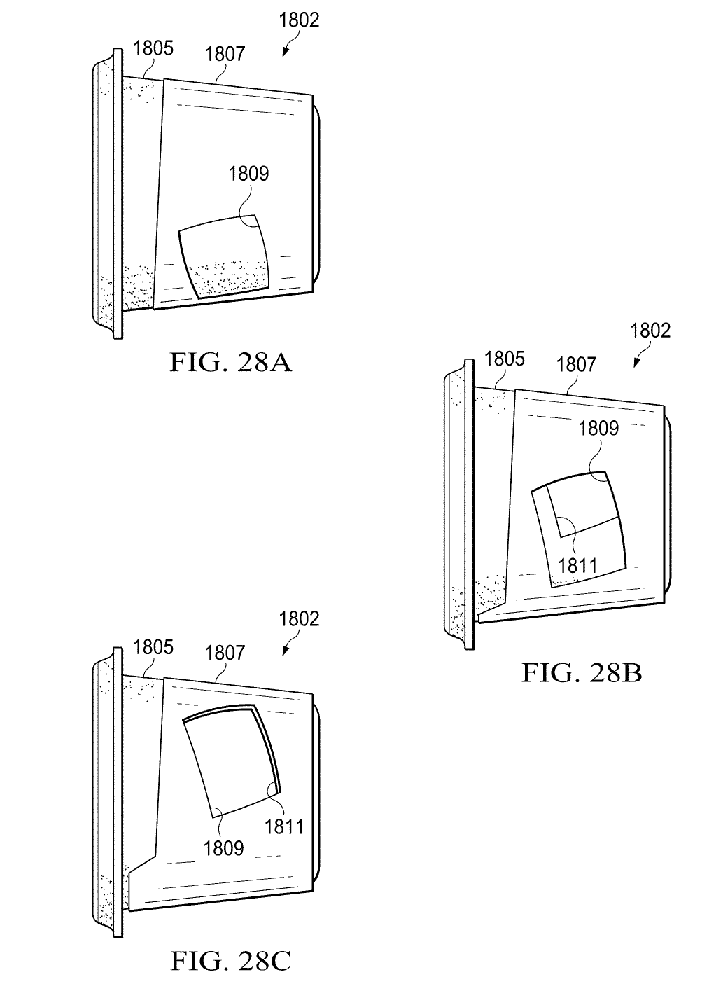

Referring to FIGS. 28A-28C, one version of a pod 1802 is shown having a body 1805 and a rotatable sleeve 1807. FIG. 28A illustrates the pod 1802 in a “closed” position, where a first aperture 1809 defined by the sleeve 1807 is closed by the body 1805 of the pod 1802. FIG. 28B illustrates the pod 1802 in a partially open position, where the first aperture 1809 is partially aligned with a second aperture 1811 defined by the body 1805. FIG. 28C illustrates the pod 1802 in an “open” position, where the first aperture and the second aperture are substantially aligned. In the “closed” position beans may be prevented from exiting the pod 1802, but in the “open” position beans may be able to pass through the first aperture 1809 and the second aperture 1811. The sleeve 1807 can be rotatable relative to the body 1805 in any suitable fashion and the rotation to remove the beans can occur manually, mechanically, and/or automatically with an integrated beverage system.

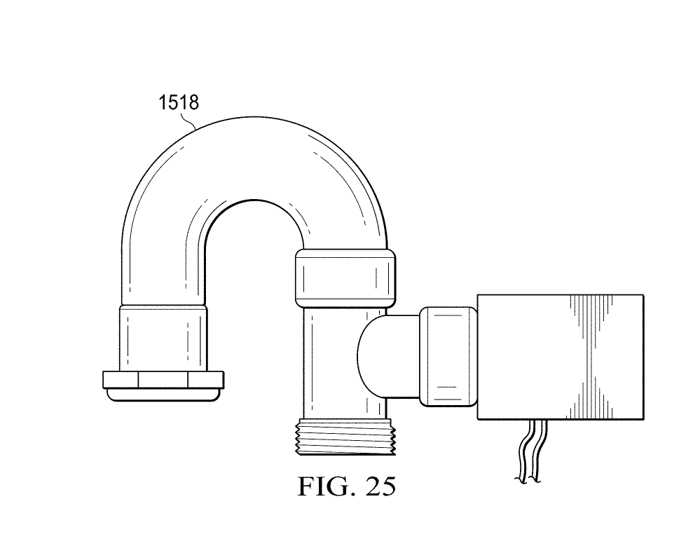

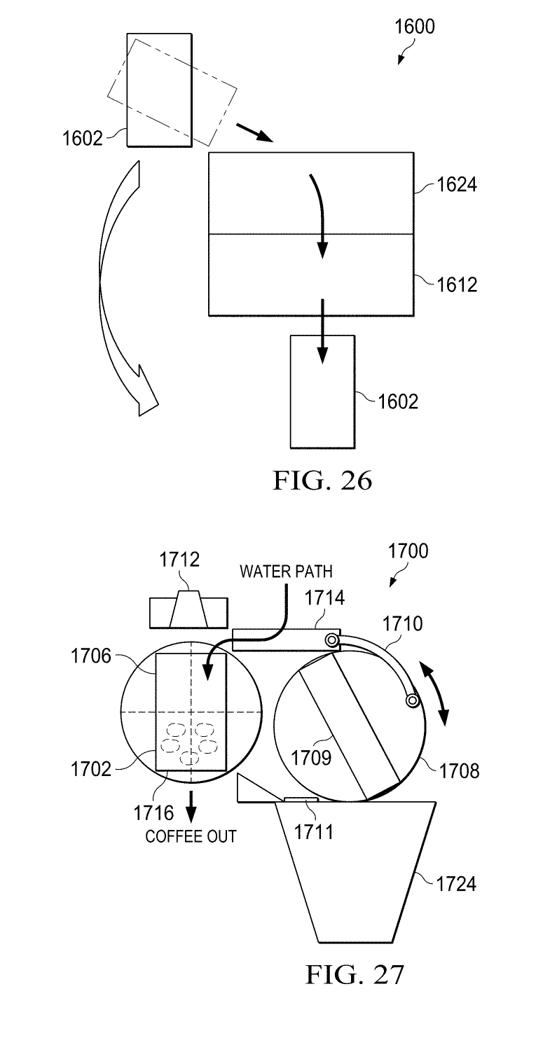

Referring to FIG. 26, an alternate embodiment of an integrated beverage system 1600 is shown. It will be appreciated that any suitable method, mechanism, or orientation of stacking functionality is contemplated. As illustrated, a container 1602 containing unroasted beans can be opened or access such that beans can be introduce into a roaster 1624. The roasted beans can then be introduced into a grinder 1612. In the illustrated example, after the beans in the container 1602 have been emptied, the container 1602 can be transitioned from above the roaster 1624 into a brewing position below the grinder 1612. The container 1602 can manually be moved from the first position to the second brewing position, or the container 1602 can be automatically transitioned to the second positioned with a robotic arm or the like. In this manner, the container 1602 can be used to retain the green coffee beans during storage and also to function as a brewing receptacle for the roasted coffee grounds.

Referring to FIG. 27, an integrated beverage system 1700 can be used in accordance with a roasting, grinding, and brewing system, such as described for example in with respect to Method 200. The integrated beverage system 1700 can have any suitable elements, or features, such as those described in association with the integrated beverage system 500. Roasting can include roasting of coffee beans in single serve portions with the green coffee beans provided in small pods. The roasting, grinding, and brewing processes can include features and steps as described herein. Green coffee beans can be provided in a container or pod 1702, where the pod 1702 can be inserted into the integrated beverage system 1700. In one embodiment, the pod 1702 can be inserted into a rotatable pod holder 1706. The lid 1704 of the pod 1702 can be removed manually by the user or by the integrated beverage system. The lid can be punctured, torn, peeled, or otherwise opened or accessed.

To transfer the green beans from the pod 1702 to a roaster 1724, the pod 1702 can be rotated after being opened or punctured. The pod 1702 can be rotated by the pod holder 1706 using a servo or any other suitable mechanism. The central axis of the pod holder 1506 can be offset from the central axis of the roaster 1724 such that the pod holder 1706 need not rotate a full 180 degrees to dispense beans into the roaster 1724. The pod holder 1706 can have any suitable range of rotation such as, for example, from about 90 degrees to about 180 degrees, from about 120 degrees to about 165 degrees, or from about 150 degrees to about 170 degrees.

The integrated beverage system 1700 can include a multi-function rotating actuator 1708. In a first position, the actuator 1708 can be positioned substantially above the roaster 1724, which can be positioned at about the bottom of the integrated beverage system 1700. An access door 1711 can be slidably coupled with the actuator 1708 such that, in a first position as shown in FIG. 17, the access door 1711 is in an “open” position to accept the coffee beans from the pod 1702 into the roaster 1724. Once the beans have been introduced into the roaster 1724 the actuator 1708 can rotate clockwise to a second position to simultaneous close the access door 1711 and align an exhaust tube and/or blowout tube 1709 with the roaster 1724. During the roasting process exhaust can pass through the tube 1709 and, at the completion of the roasting process, the roasted beans can be blown vertically through the tube 1709 with a fan (not shown), for example. The roasted beans can be blown via any suitable tubing (not shown) or bean path into a grinder 1712 that can be positioned above the pod 1702 and pod holder 1706. The grinder 1712 can then grind the beans in accordance with versions described herein.

Following the grinding of the beans, the coffee grounds can enter the pod 1702, which has been returned to a substantially vertical position. The actuator 1708 can rotate clockwise to a third position such that a linkage 1710 associated with the actuator 1708 horizontally urges a brew plate 1714 having a water path (not shown) into position below the grinder 1712. The coffee grounds in the pod 1702 can then be brewed such that finished coffee is able to pass through a filter 1716 positioned in the bottom of the container 1702. Such a system can use the pod 1702 for multiple steps in the brewing method where the pod can 1702 can serve to retain the unroasted beans as well as the brewing container for the roasted grounds. Providing the pod 1702 with multiple functions may reduce the size of the integrated beverage system 1700 as fewer system components may be needed to achieve the desired result. It will be appreciated that the actuator 1708 can transition between any suitable number of positions or stages. For example, an exhaust position may be different from a bean blowout position, where it may desirable to have the exhaust exit through a different path from the roasted beans.

Referring to FIG. 30, a schematic of a single fan system 2000 is shown that can be used with the integrated beverage system 1700 and/or any other system described herein. In the illustrated embodiment, a single fan 1734 can be provided that is operatively coupled to both the pod 1702 to suction out the green coffee beans and the roaster 1724 to eject the exhaust via an exhaust port 1730 and a bean blowout tube 1732. The fan 1734 can be associated with a flap or valve 1736 to facilitate the single fan functioning both to vacuum and to eject coffee beans during different stages of operation. A chaff/cyclone stage may be in one of two positions, or may have two such devices as may be desirable.

Referring to FIG. 31, a schematic of a dual fan system 2100 is shown that can be used with the integrated beverage system 1700 and/or any other system described herein. In the illustrated embodiment, a first fan 1738 can be provided that is operatively coupled to both the pod 1702 to suction out the green coffee beans. A second fan 1740 can be provided that is coupled with the roaster 1724 to eject the exhaust via an exhaust port 1730 and a bean blowout tube 1732. It will be appreciated that any suitable fan and/or valve arrangement is contemplated.

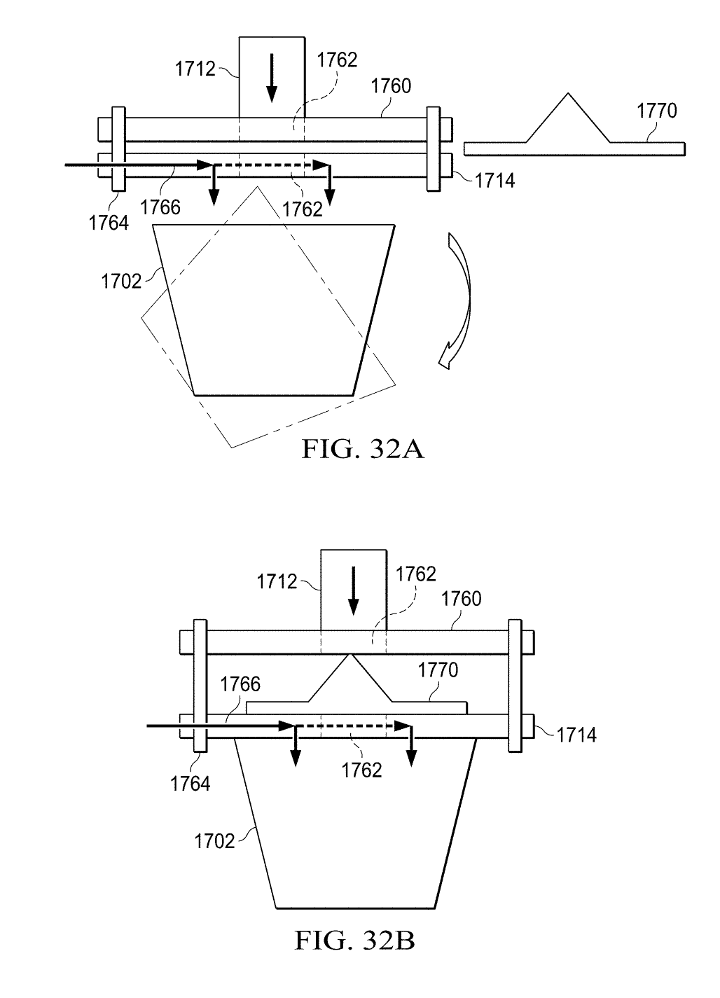

FIGS. 32A and 32B illustrate one version of a spring-loaded brewing plate 1714 that can be used to seal a pod 1702 such that water within the pod 1702 can be pressurized to control brewing time and/or interaction time with coffee grounds. The grinder 1712 can include a fixed horizontal plate 1760 defining an aperture 1762 through which roasted coffee grounds can pass. The brewing plate 1714 can include a plurality of springs 1764 can that couple the fixed horizontal plate 1760 to the brewing plate. The brewing plate 1714 can include a water line 1766 to deliver heated water for the brewing process. Referring to FIG. 32A, the brewing plate 1714 can be in a first position adjacent or proximate the horizontal plate 1760, where a laterally slidable wedge 1770 is provide that is not yet engaged with the brewing plate 1714. In this first position the can be sufficient overhead space between the pod 1702 and the brewing plate 1714 that the pod 1702 can be easily rotated to dispose of the green beans contained therein.

With reference to FIG. 32B, as described herein, the pod 1702 can be used both to retain the green coffee beans and to brew the roasted coffee grounds. Prior to the brewing process the pod 1702 can be rotated back to a substantially vertical position. The wedge 1770 can be laterally translated between the brewing plate 1714 and the fixed horizontal plate 1760. Because the brew plate 1714 may be attached to the horizontal fixed plate only by the plurality of springs 1764, the brew plate 1714 can be urged downward as the wedge 1770 is engaged. As shown in FIG. 32B, when the wedge 1770 is in the brewing position the brew plate 1714 can be fully expanded such that the brew plate can seal the pod 1702. When the pod is sealed in this fashion water entering via the water line 1766 can pressurize the pod 1702 to improve control over the brewing process.

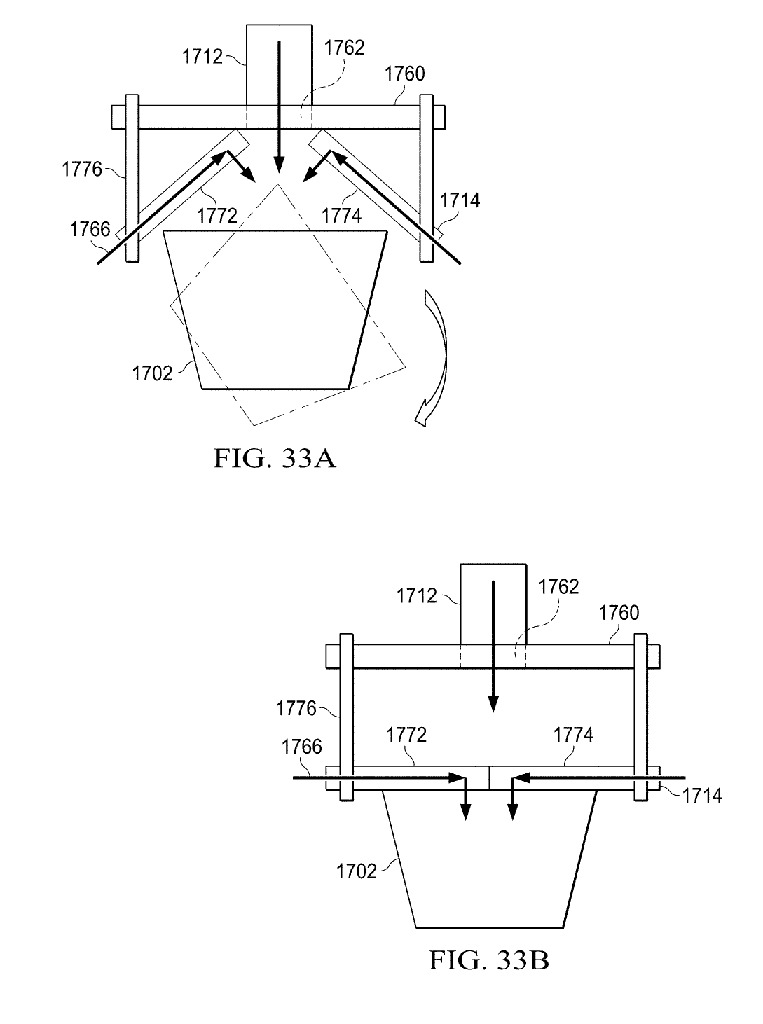

FIGS. 33A and 33B illustrate one version of a “drawbridge” brewing plate 1714 that can be used to seal a pod 1702 such that water within the pod 1702 can be pressurized to control brewing time and/or interaction time with coffee grounds. The grinder 1712 can include a fixed horizontal plate 1760 defining an aperture 1762 through which roasted coffee grounds can pass. The brewing plate 1714 can include a first hinged portion 1772 and a second hinged portion 1774, where the hinge portions can transition between a first position (FIG. 33A) and a second position (FIG. 33B). The hinged portions 1772, 1774 can be coupled to the fixed horizontal plate 1760 with rigid rods 1776. The hinged portions 1772, 1774 of the brewing plate 1714 can include a water line 1766 to deliver heated water for the brewing process. Referring to FIG. 28A, the brewing plate 1714 is shown in a first position where the hinged portions 1772, 1774 are raised such that there is sufficient overhead space between the pod 1702 and the brewing plate 1714 that the pod 1702 can be easily rotated to dispose of the green beans contained therein.

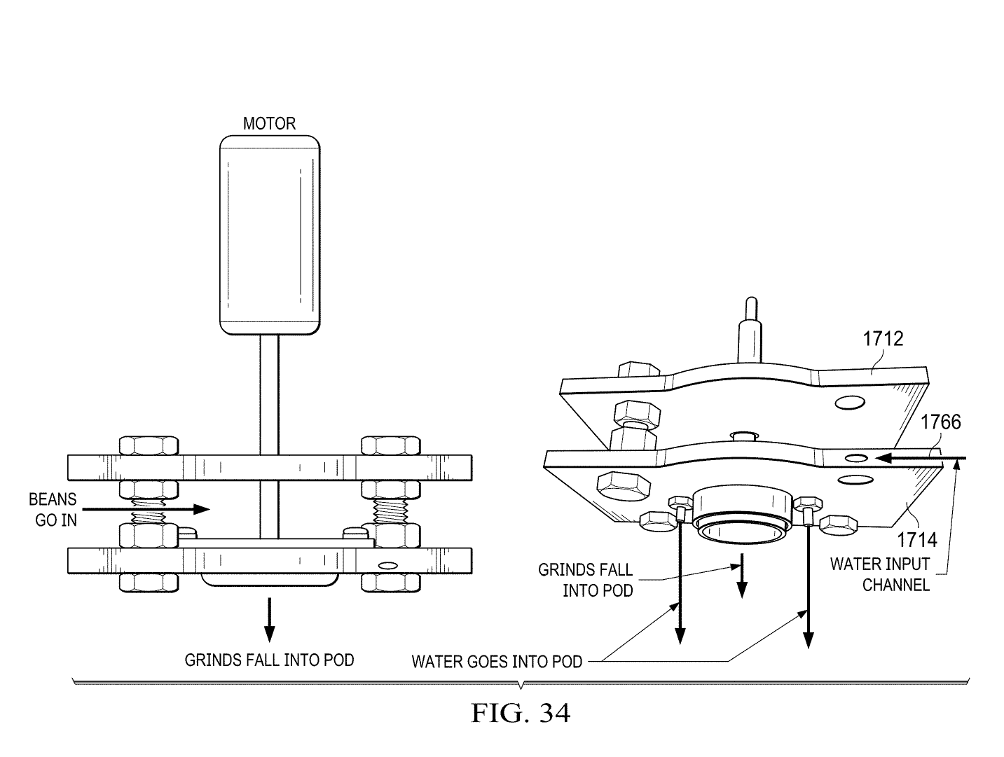

With reference to FIG. 33B, prior to the brewing process the pod 1702 can be rotated back to a substantially vertical position. The hinged portions 1772, 1774 can be urged downward such that they are substantially parallel with the fixed horizontal plate 1760. As shown in FIG. 33B, when the brew plate 1714 is in the brewing position it can seal the pod 1702. When the pod is sealed in this manner water entering via the water line 1766 can pressurize the pod 1702 to improve control over the brewing process. FIG. 34 illustrates one example of the relationship between the grinder 1712 and the brew plate 1714.

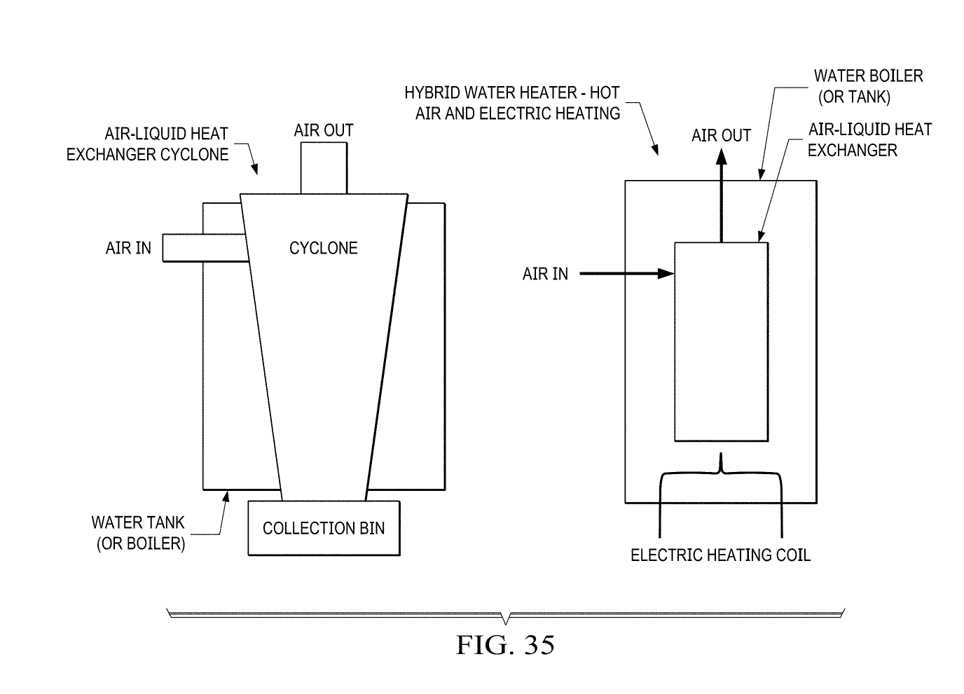

Referring to FIG. 35, it may be beneficial to utilize the heat from the roasting process in other applications of coffee preparation. For example, heat from the roaster exhaust (e.g., exhaust 1720) can be directed through a heat exchanger in the water reservoir or boiler to extract heat from the hot air stream such that this can be used to heat water that may be used to make coffee. The heat exchanger may in some cases have the features of a cyclonic separator in order to separate chaff from the exhaust air path. The heat exchanger may also serve to reduce the air temperature of the exhaust so that it can be vented into the room with less ambient heating if desired. In a boiler configuration, the boiler can be a hybrid configuration where liquid may be heated with exhaust air and also a heating element (such as an electric heating element). Such embodiments may allow more rapid heating of water and reduce energy consumption of machine operation. In an alternate embodiment the hot air may be directed to a thermoelectric generator to turn the waste heat into electric power. Conventional boilers for home appliances are not designed for multiple energy input sources which this new design allows. This may allow for faster water heating or more energy efficient liquid heating.

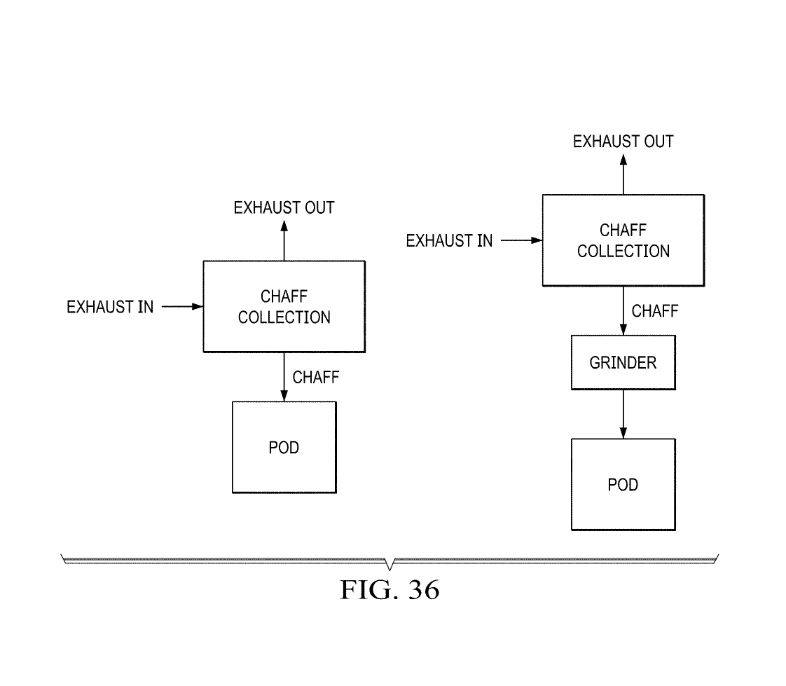

FIG. 36 illustrates an example system for the removal of chaff. Chaff that exits the roast chamber (e.g., roaster 1712) may be directed to a chaff collection/separation mechanism. This system may direct the chaff back into the pod. In another approach, the system may direct chaff into the grinder and then into the pod again. In this way, a separate chaff collection box may not need to be provided and serviced by the user since the chaff can be returned to the pod with spent grinds to be removed after a cup of coffee is made. This may simplify machine operation and maintenance for the user.

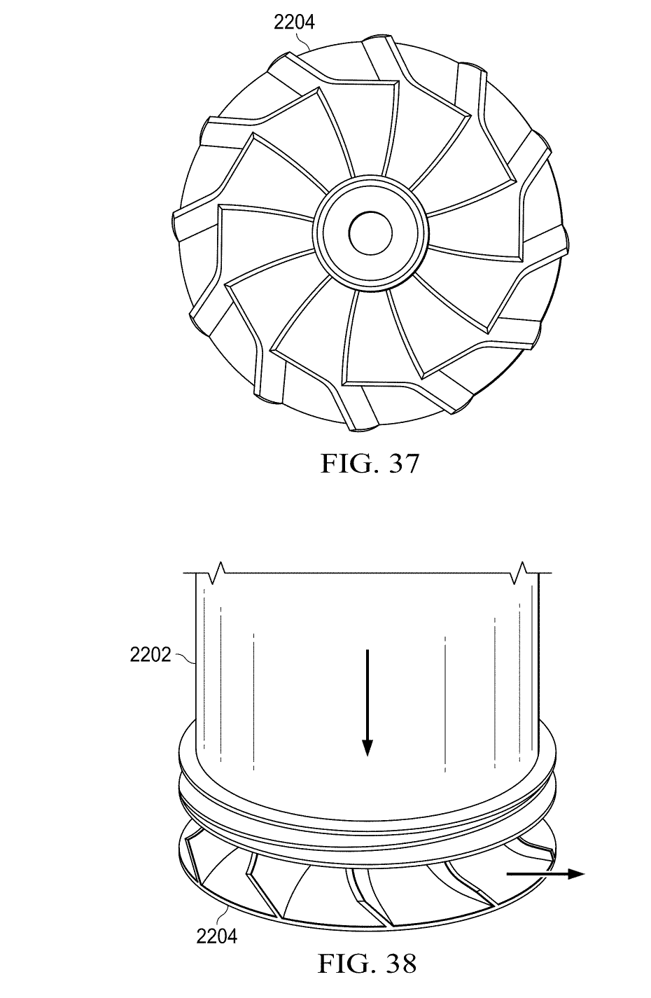

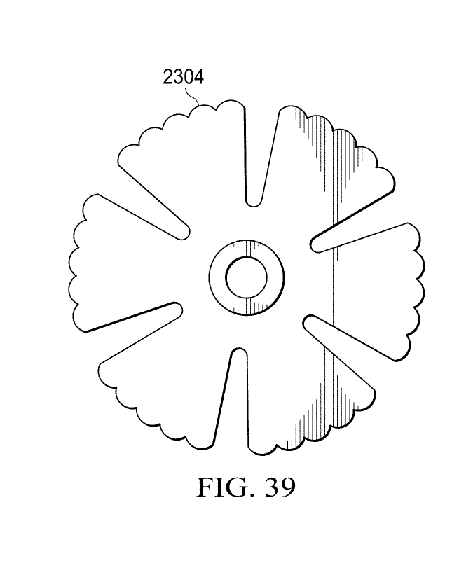

Referring to FIGS. 37 and 38, roasting coffee beans quickly and uniformly, such as in a roaster 1724 as shown herein, can benefit from even convective hot air flow. Embodiments herein can incorporate an air distribution device associated with a fan or turbo compressor wheel 2204 as shown. This wheel 2204 may be attached to a pipe 2202 with hot air coming down, where the wheel can create a spinning vortex flow of air that serves to agitate, spin, and/or heat the beans in the surrounding roast chamber. The heat can be produced by a heating coil in the pipe 2202 or in any other suitable manner. The beans may undergo a complex spinning/rolling/tumbling motion that enables fast, uniform roasting. Another advantage of this approach may be that the heat may be applied from the center of the roast chamber, such as roaster 1724, which allows the perimeter of the chamber to be made with low cost materials (metals or high temperature glass that allows the roast process to be visibly viewed, where the low cost materials may need very little processing to form to shape). Other similar air ducting/flow structures can be used in similar way to create desired air motion to agitate the beans. An advantage of this approach may be that hot air may be brought in from the top and roasted beans can drop via gravity through a door in the bottom of the roaster to the next process step (the heat may also be brought in from the bottom of the roaster if desired). The heat in this case may be brought in from the center of the roaster which may allow the perimeter container to be solid and without any features needed, and allows the use of low cost simple glass for the perimeter if there is a desire to see inside the roaster. The perimeter container can also have features to improve agitation or bean mixing if desired and may be of other materials than glass. With reference to FIG. 39, a fan blade 2302 may also be used.

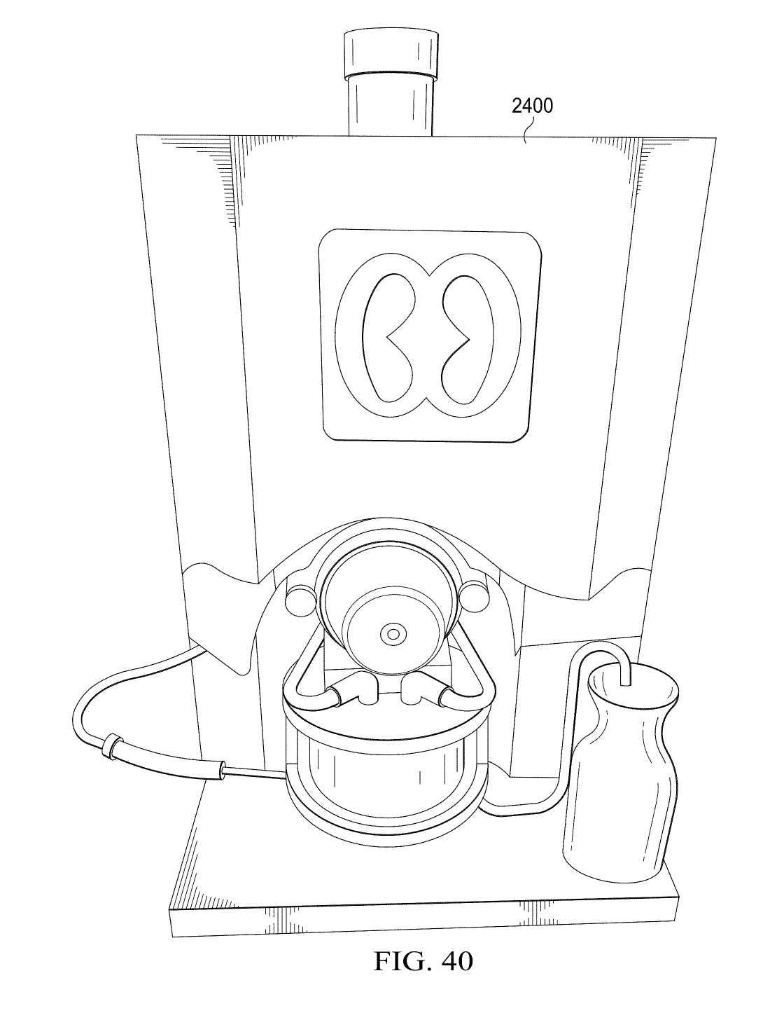

Referring to FIG. 40, one example of an integrated beverage system 2400 is shown having roasting, grinding, and brewing functions. The beans can be inserted into the clear container at top of the system 2400. The beans can fall into a roaster via a computer controlled door. The beans can be roasted. The beans can fall into a grinder via a computer controlled door. The grinds can fall into the brew chamber at the bottom of the system 2400 (white bottomed container). The chamber can be sealed and hot water can be injected to brew the coffee. This is an example of a full immersion brewer and the coffee grounds/water mixture can be agitated/mixed to the desired level by bubbling air through the chamber. The chamber can be pressurized which can push the coffee out of the chamber through a pressure relief check valve. The brewed coffee can be seen in the small carafe on lower right side of FIG. 40.

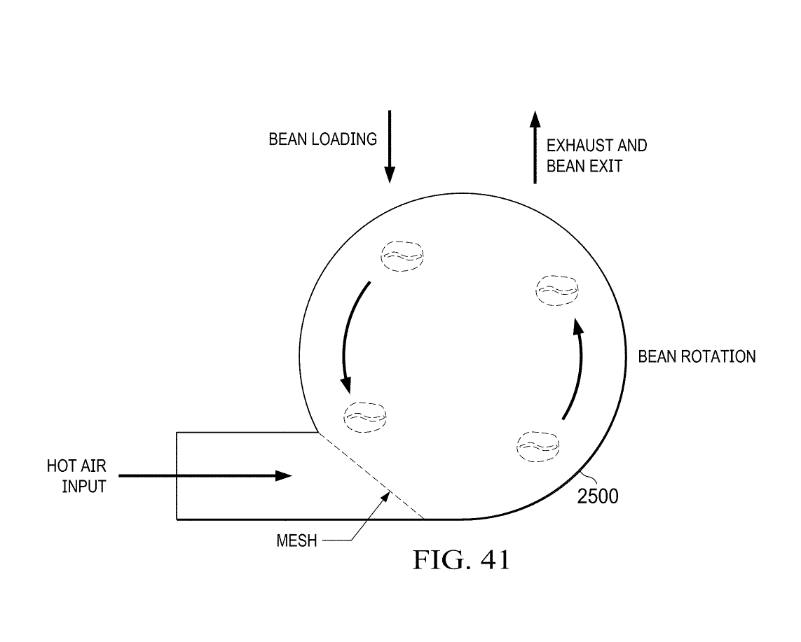

Referring to FIG. 41, an alternate approach to roasting may be a horizontal cylinder configuration with the air entering the roaster 2500 lateral to the cylinder and beans spinning up and around the cylinder. Gravity may cause the beans to fall back down and catch the input air repeatedly. Variations are contemplated in which the air input and output can be varied around the circular cylinder of the roaster 2500.

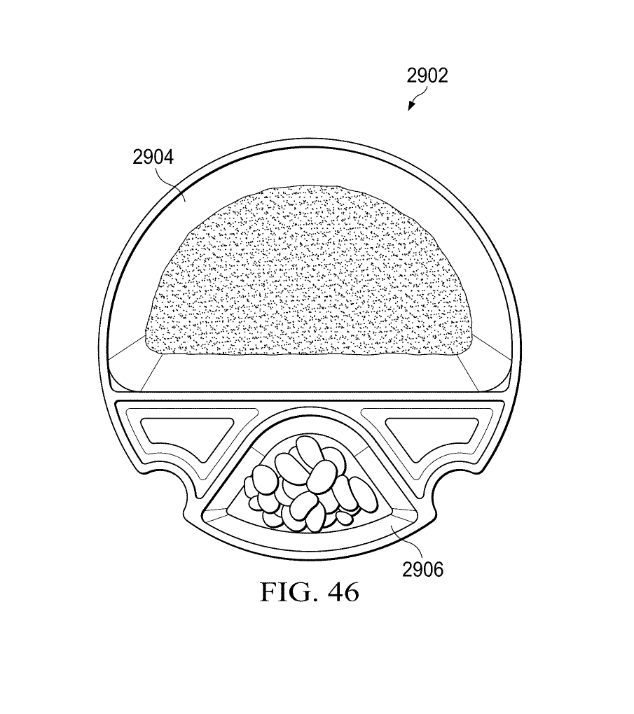

Referring to FIG. 46, in an alternate embodiment a container or pod 2902 can include a plurality of cavities. The cavities may contain green unroasted beans, roasted beans, partially roasted beans, or may be empty, for example. The material of the pod 2902 may be compostable/biodegradable, where the material may be designed to be “activated” to start the biodegradation process, where such activation can be via exposure to wavelengths of light, contact with materials or liquids, contact with gases, or the like. The exposure may occur in the integrated beverage system as part of the process and, thus, induce the beginning of bio-degradation. The exposure or activation may be delay such that the pod 2901 material may remain in shelf stable state during prior steps (packaging, storing, shipping, etc.) but then may degrade once the pod 2902 has been used. The pod 2902 and/or the lid of the pod may contain antibacterial/antimicrobial or other agents to kill and or prevent the growth of bacteria, viruses, mold, fungus, or the like. Such antimicrobial ingredients may be natural and may be embedded into the packaging such that they are not extracted into the water in brewing. Such a configuration may be used to keep the food contained inside safe for human consumption. Alternatively the pod 2902 or lid may have chemical or other markings that react with bacteria (molds, viruses, etc.) to change color or some other visual (or sensory) indicator to enable a user (or machine) to detect the presence of a pathogen to indicate that the pod 2902 should be discarded.

In one example, the pod 2902 may contain a first cavity 2904 and a second cavity 2906 that are independent and have no pathway between them. Both cavities 2904, 2906 may have a lid or seal that can be removed. One cavity may contain the food product, such as green coffee beans, and the second cavity may be empty. Both cavities may be sealed from the outside environment. The pod 2902 may be inserted into the machine (such as an integrated beverage system) and the lid for the food containing first cavity 2904 may be punctured or removed to allow the food product to be processed by the machine (the food product may be extracted from the pod 2902). The machine may perform the process and the lid or cover of the second cavity 2906 may be removed or punctured to allow the processed food product to enter this second cavity and further processing may be done. The use of multiple cavities can allow one cavity to be isolated and remain free of any contaminants from the original food product (if any contaminants do exist). The lid or seal of each cavity can be opened simultaneously or sequentially one after the other to isolate one cavity from the other if desired. The multi-cavity pod 2902 can have any physical orientation, where one cavity may be beside another cavity, one cavity may be on top of another cavity, and these concepts may be expanded to more than two cavities to any suitable number. The pod 2902 can have green beans in the first cavity 2904 and grounds in the second cavity 2906. The second cavity 2906 with grounds could be empty when purchased and the machine may insert the grounds into this cavity for disposal.

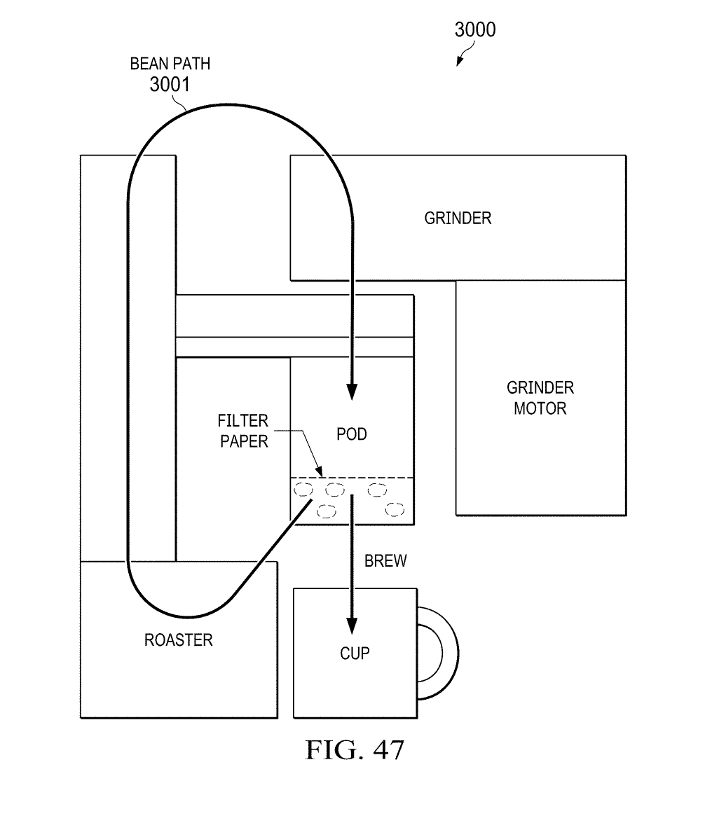

Referring to FIG. 47, an alternate approach to a roast, grind, and brew integrated beverage system 3000 is provided. In this case the pod may have multiple cavities one located above the other (E.g., FIG. 29). Both cavities may constitute one pod and can be delivered as a single unit with sealing on the top and bottom of the pod. The lower cavity of the pod may contain green unroasted beans and the upper cavity may be empty. The layer separating the two cavities may have some filtering material (paper, steel mesh, etc.). The lead line 3001 shows the example path of the coffee beans through the system 3000. The green unroasted beans may fall into the roaster (the machine may automatically remove/puncture/etc the bottom seal to allow the beans to fall out into the roaster) and the beans may be roasted. The roasted beans may expand in size and lose weight during roasting so they can be easier to blow out. The roasting may be via convection and a fan and a heater coil may create the heat for convective heating. During roasting, the fan may be operated at a sufficient level to spin/agitate the beans but after roasting the fan may be operated at much higher speed to create enough air pressure to blow the beans out of the roast chamber. The roast chamber may have a mechanical feature to deflect the beans out of the roaster into a tube or pipe that directs the beans to the next step of processing. The beans may be directed to the inlet of a coffee grinder such as a burr grinder. The grinder may be situated so the grinds exit the grinder and fall back into the top portion of the pod (the top seal or lid of pod may have been removed by the user or by the system). A brewing mechanism may mate to the pod and hot water may be injected into the pod to brew the coffee. The resultant coffee may be filtered by the previously mentioned filter paper and coffee may exit the pod into the cup. The pod may contain the used grinds and there may be nothing to clean up for the end user. The pod may be removed from the machine and the pod may be made of compostable or biodegradable material. Note that the pod may originally contain roasted whole beans (in the location of the green unroasted beans mentioned previously) and the roast step may be skipped and the rest of the machine may be operated as described to make coffee. Alternatively, partially roasted beans can be in the pod and the remaining roasting can be done in the system. Other drink or food stuffs may be provided in the pod and the entire machine or parts of the process may be used to make any suitable food or drink. For example the pod may contain tea and the system may be used to make tea as one example. In this example, the tea may remain in the pod and may not be dumped into the roaster, where the tea may be in the lower or upper chamber of the pod when originally packaged. It is contemplated that a single system can have different configurations for use with different beverages such as, for example, both tea and coffee.

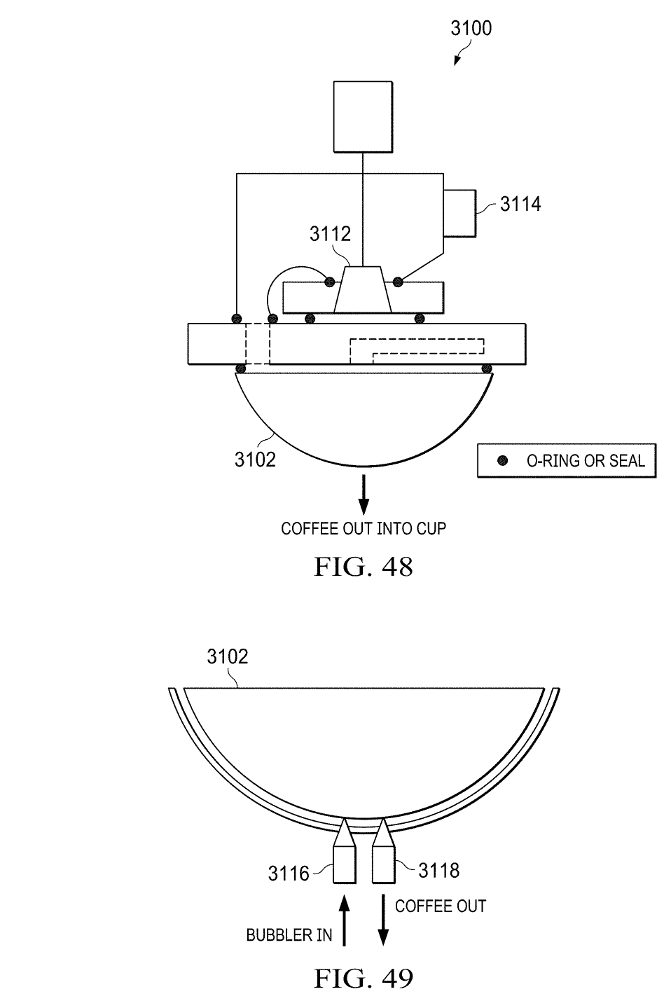

FIG. 48 illustrates one embodiment of an integrated beverage system 3100. It may be desirable to ship unroasted green coffee beans in a pod 3102, to roast the beans within the pod 3102, remove the beans for the roasting step, and then return the roasted grounds to the pod 3102 for brewing. The pod 3102 may contain the green unroasted coffee beans. The pod 3102 can be made of any suitable material that can tolerate the high temperature generally associated with roasting. For example the pod 3102 can be configured from metal foil or can have a foil lining. The pod 3102 can mate with the system 3100 and the lid of the pod 3102 can be punctured or removed. Hot air can be introduced to the pod 3102 so that the beans are roasted in the pod. The hot air can cook the beans and may also swirl or agitate the beans to cook via convection. When the roasting is finished, the roasted beans may be blown out of the pod 3102 such as with a fan 3114 (or removed in some other way such as inverting or mechanical removal) into the grinder 3112. The grinder 3112 may be outside the pod 3102 and may be a conical burr grinder, flat burr grinder, spinning blade grinder, or any other grinder. The beans may be ground and the grinds may end up in the original pod 3102.

Referring to FIG. 49, after the grounds are returned to the pod 3102 the pod 3102 may be sealed and brewing may occur. An injector 3116 can pierce the pod 3102 to deliver water and a second penetration can be made with a second access port 3118 such that coffee may come out the bottom of pod. Various doors, seals and/or actuators may be involved at different times in the process to allow the steps to occur.

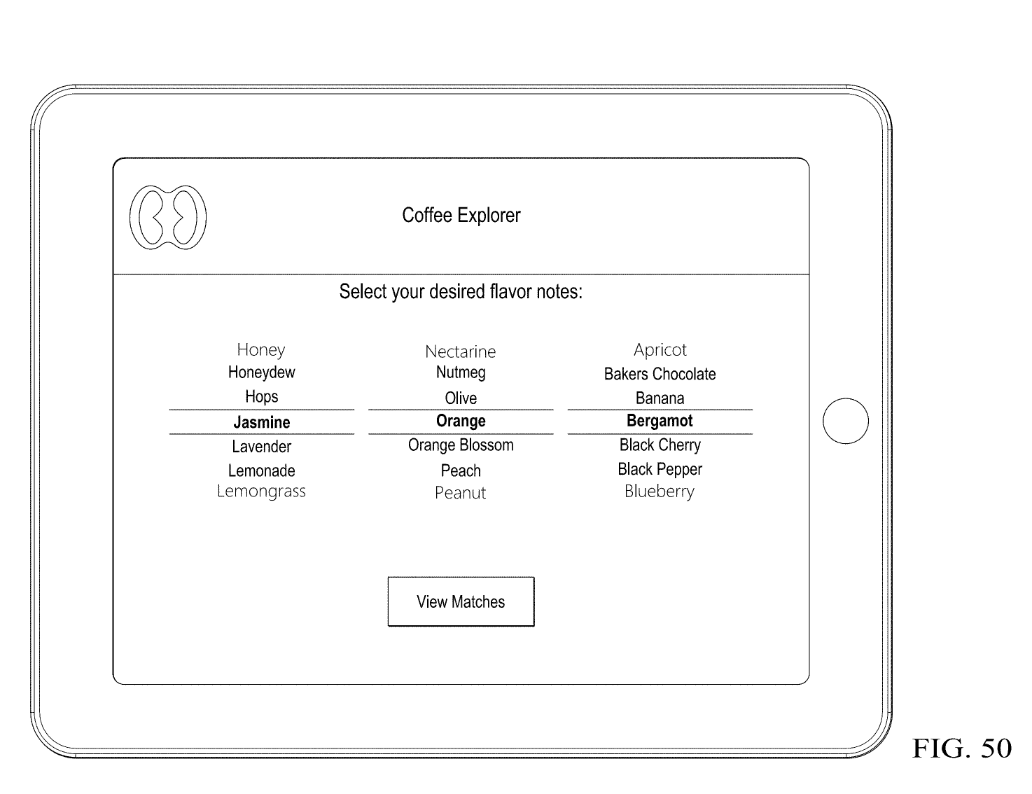

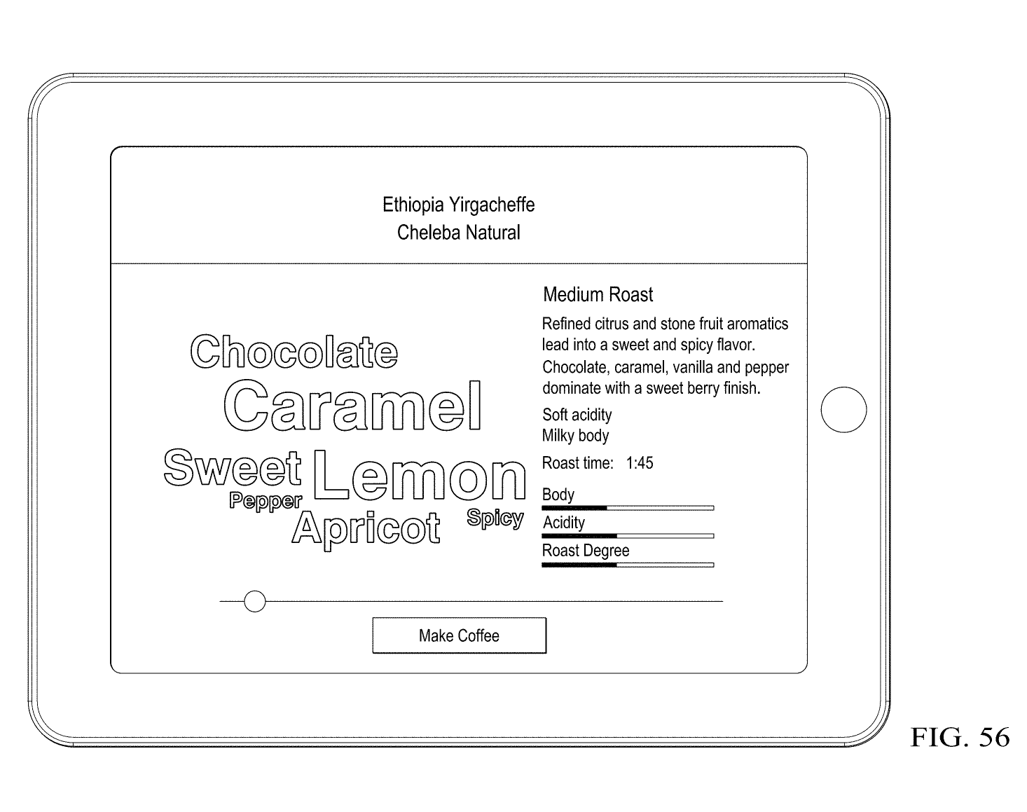

Referring to FIGS. 50-57, embodiments of software applications to control the integrated beverage systems are disclosed. Integrated beverage systems in accordance with versions described herein may be internet connected and controlled by an application that can run on computer, laptop, smartphone, tablet, etc. Embodiments of the system can make coffee, cook, or otherwise provide a food product with a combination of hardware and software that can allow the end user to pick the desired flavor notes that they want, where the software can suggest the ingredients and the preparation recipe to create the desired flavors/tastes. The roast, grind, brew hardware system along with the choice of coffee bean type and specific recipe to make the coffee can allow desired flavors to be made. Very precise and accurate cooking hardware with closed loop feedback controls can allow for very high reproducibility. The beans may be characterized for taste/flavors by expert tasters beforehand and a database of recipes and flavors may be compiled. Statistical machine learning and artificial intelligence techniques can be utilized to interpret human commands and pick the most likely desired suggestion along with dynamic interpolation of flavors from predetermined recipes. A complex multidimensional space of recipe cooking parameters that can have forty or more variables can be used.

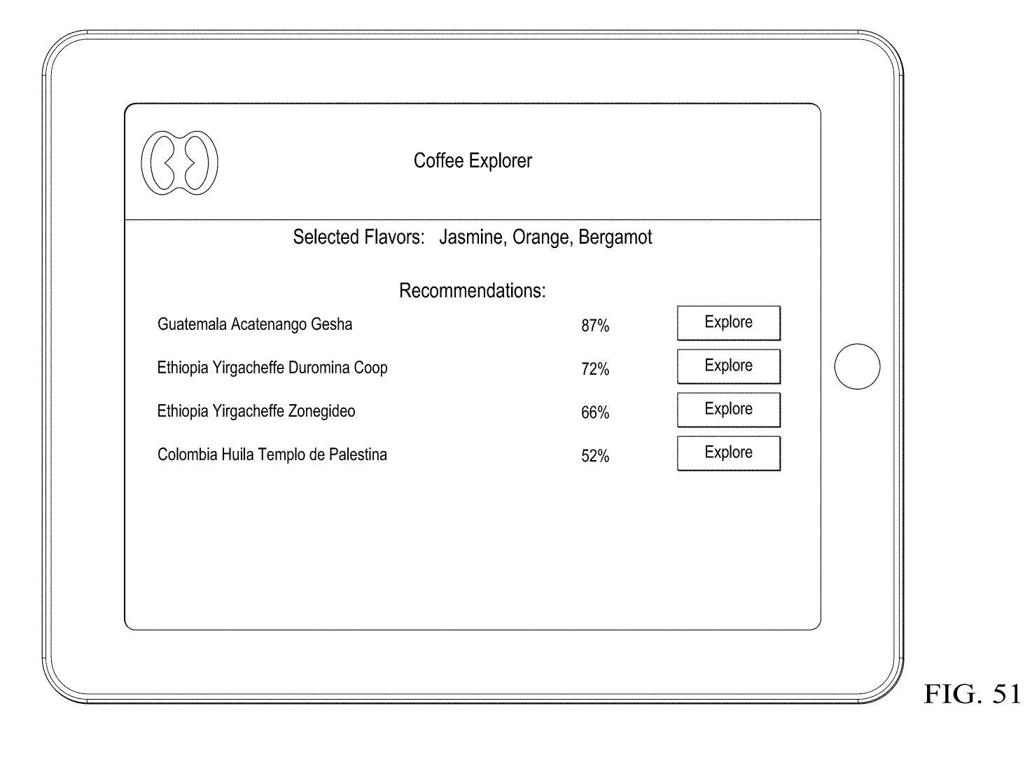

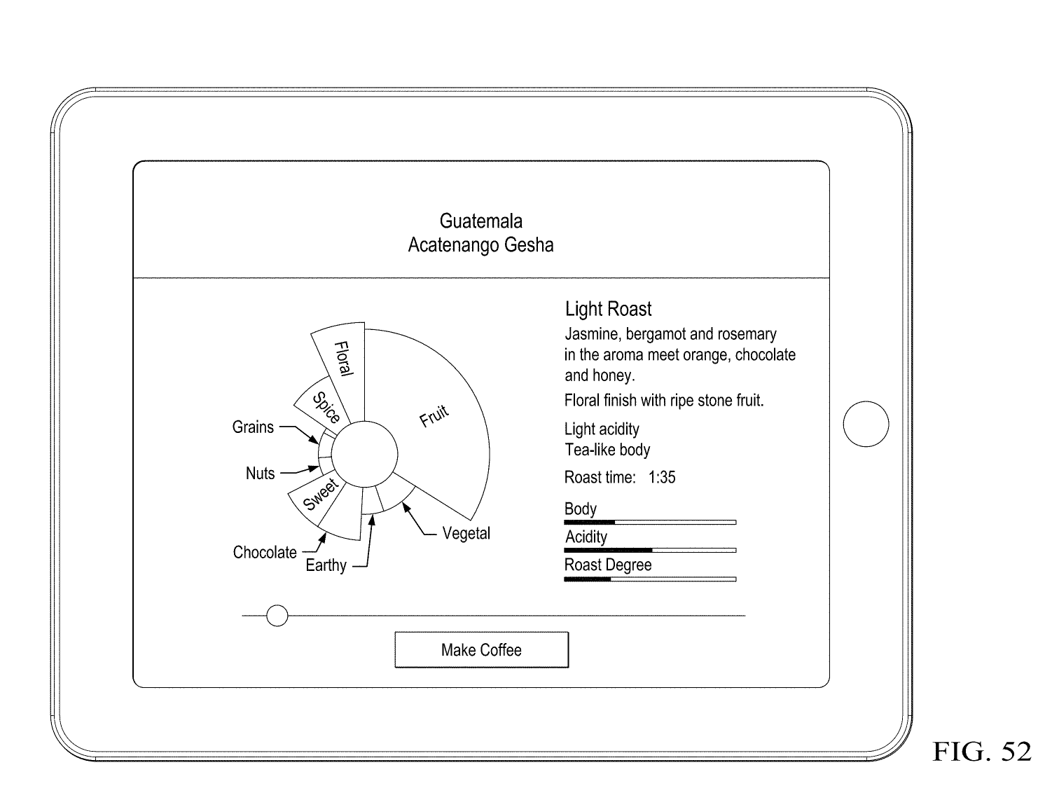

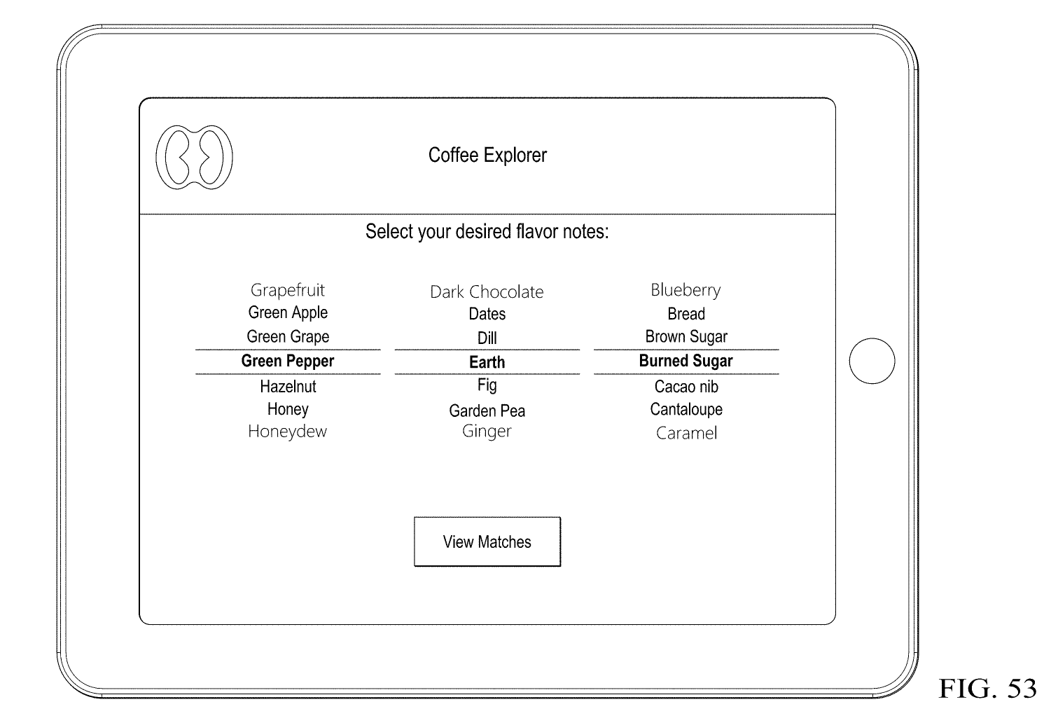

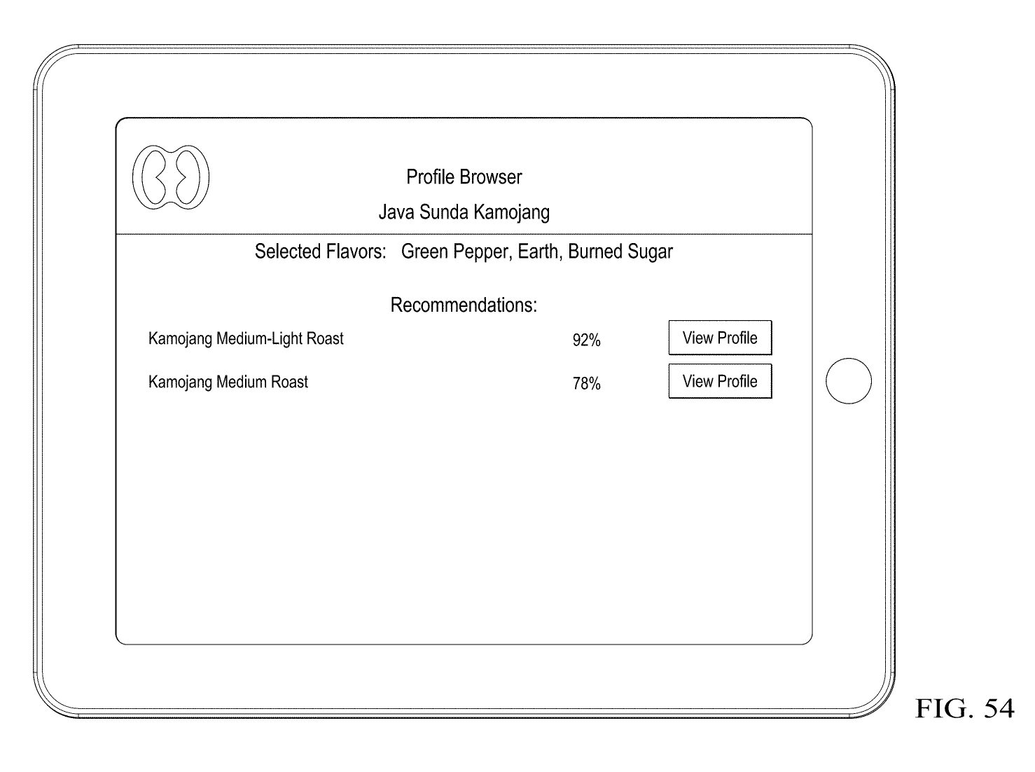

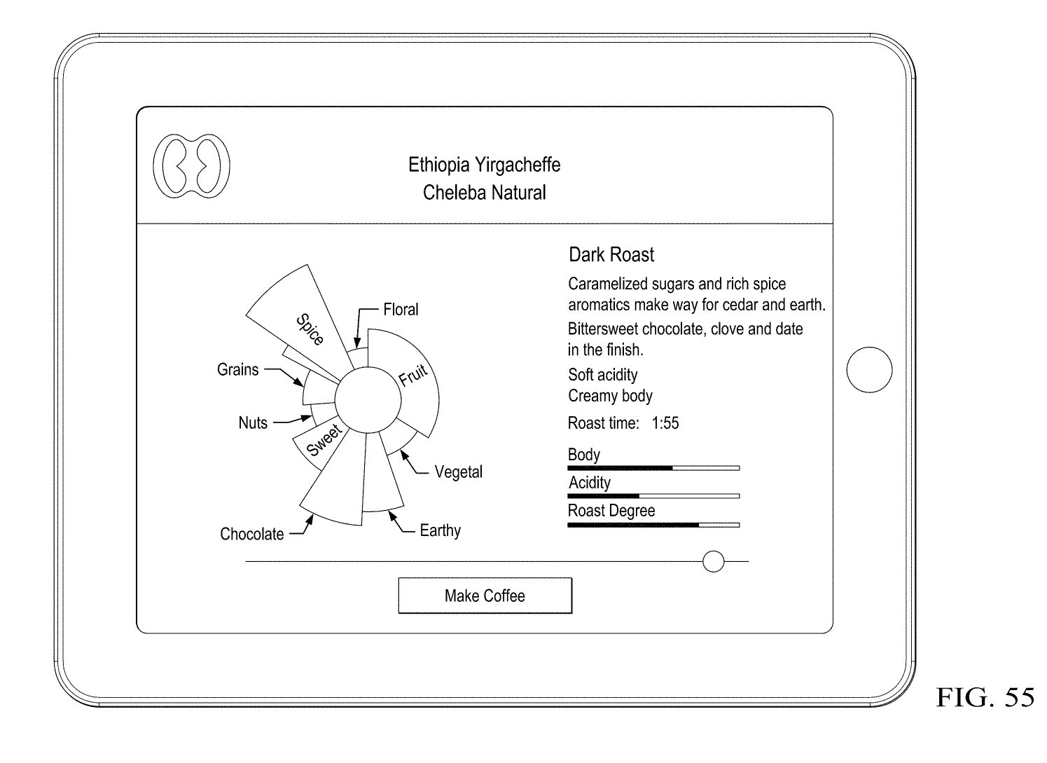

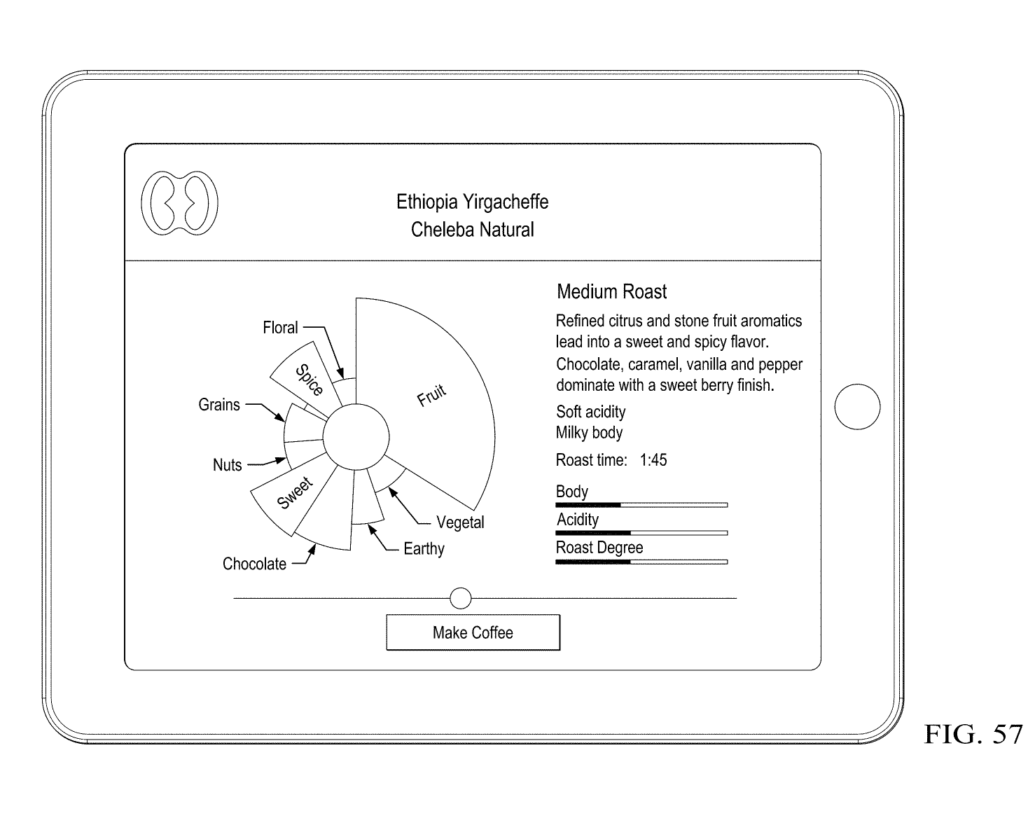

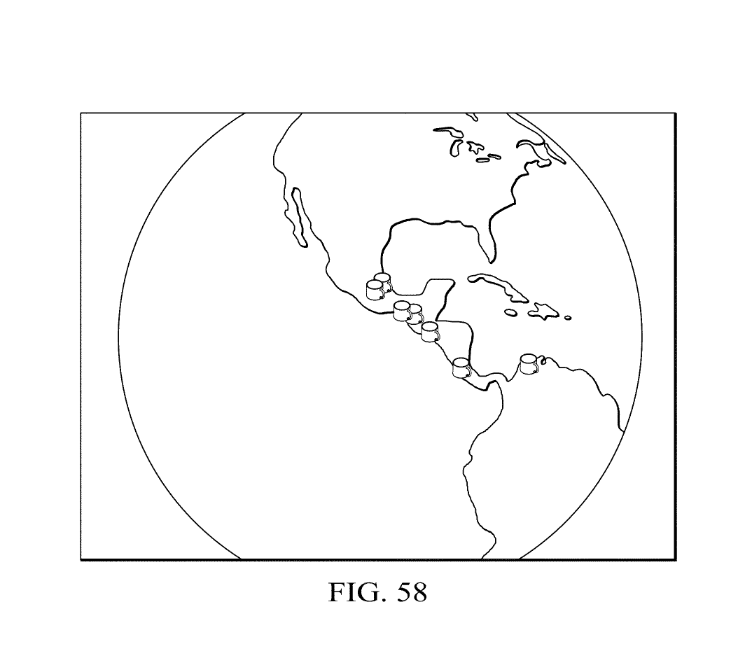

One example of the software is shown in FIGS. 50-58. The user may pick 3 desired flavor notes (E.g., jasmine, orange, and bergamot as shown in FIG. 50) and the system can responds with four choices in the next screen (FIG. 51) leading with Guatemala Acatenango Gesha. The flavor notes for a particular coffee can be shown in an Aster plot (FIG. 52) as a wheel with dominant flavors shown graphically larger. A second example is shown with green pepper, earth, burned sugar (FIGS. 53 and 54). The flavors can change even for the same bean type but with different processing, where roast, grind, and brew can individually affect flavor notes (FIGS. 55-57). The app can also show the location origins of each bean on a world map and allow the user to virtually ‘fly over’ the location or learn more about the story of each particular bean type including the farmers growing the bean, growing conditions, weather, etc (FIG. 58).

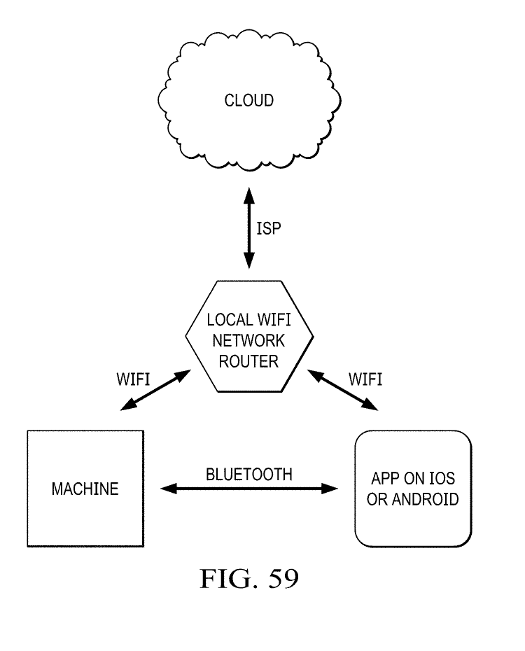

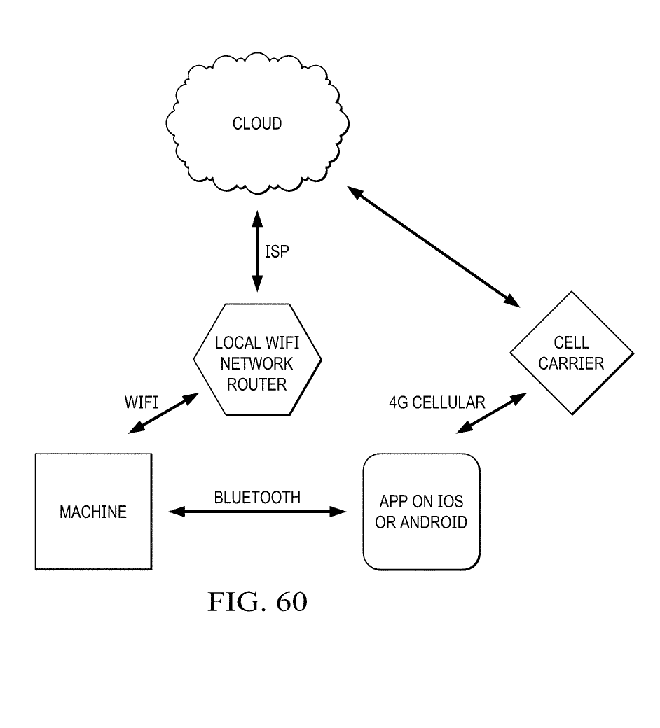

FIG. 59 illustrates one version of the architecture of machine hardware and software that can be associated with integrated beverage systems described herein. FIG. 60 illustrates an alternate version of architecture of machine hardware and software that can be associated with integrated beverage systems described herein.

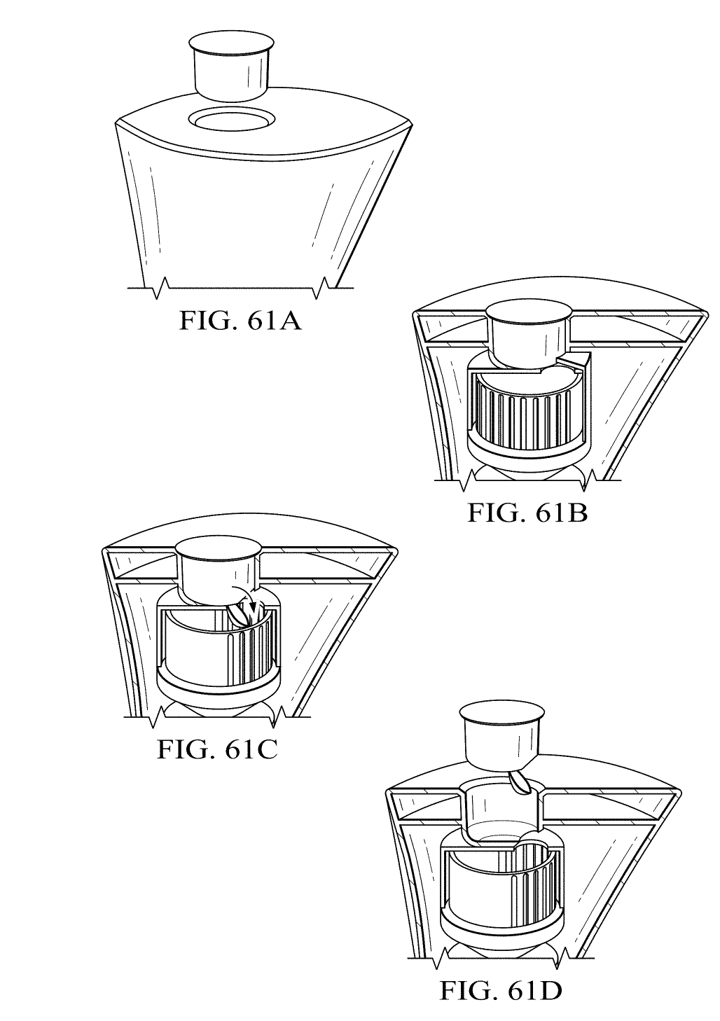

FIGS. 61A-D illustrate one embodiment of a pod system that can be used with versions of the integrated beverage systems described herein.

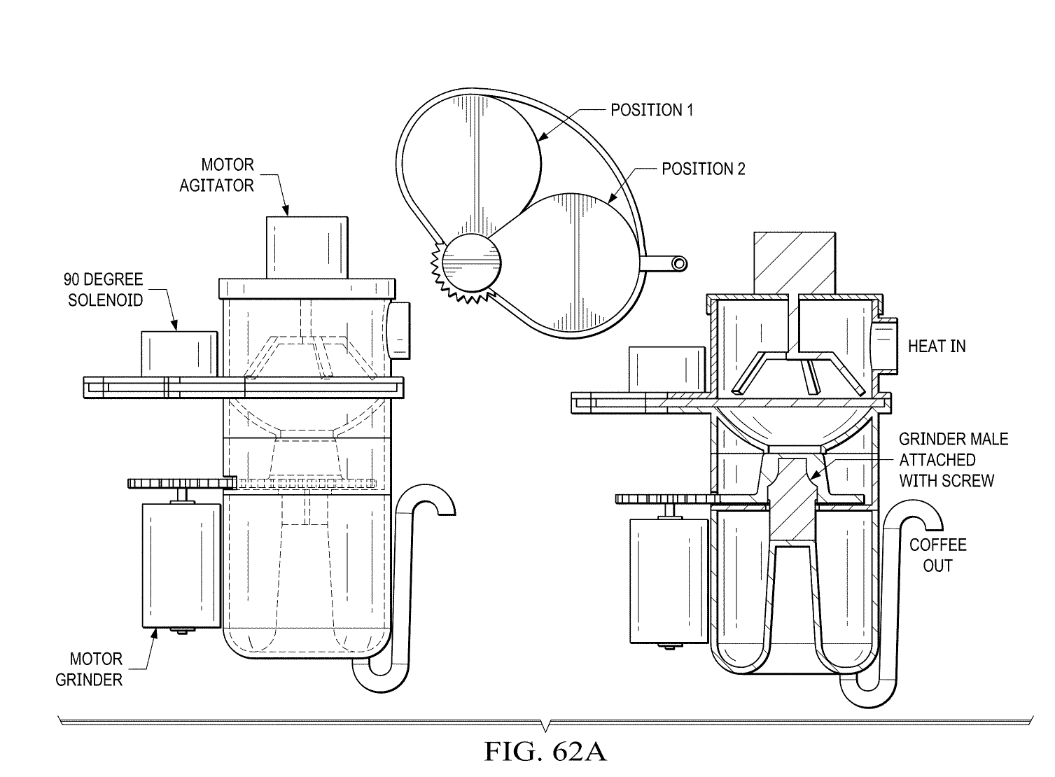

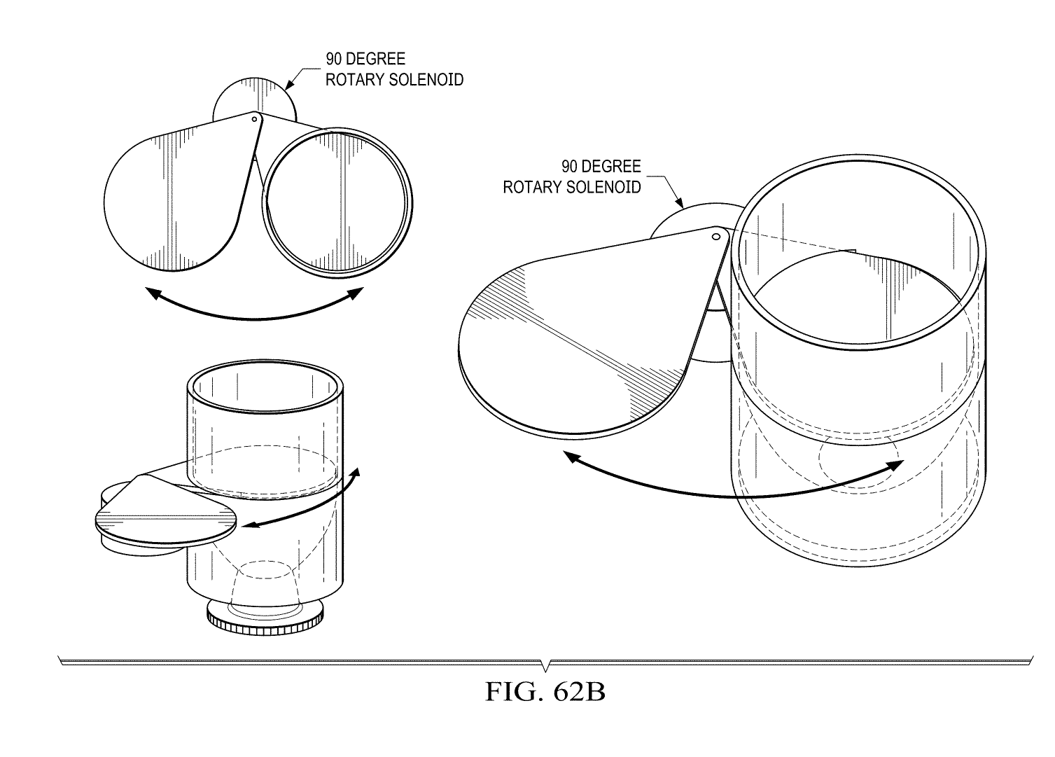

FIGS. 62A and 62B illustrate an example design of an integrated beverage system with roast, grind, and brew functionality. In the illustrated embodiment, the roaster can be positioned on the top of the system, the grinder below that, and the brewing system below that. Such a configuration can allow gravity to feed the coffee beans between stages. Computer controlled doors between the stages can allow the beans to fall between stages at the desired time when the machine activates the door. It will be appreciated that the doors may also be manually controlled.

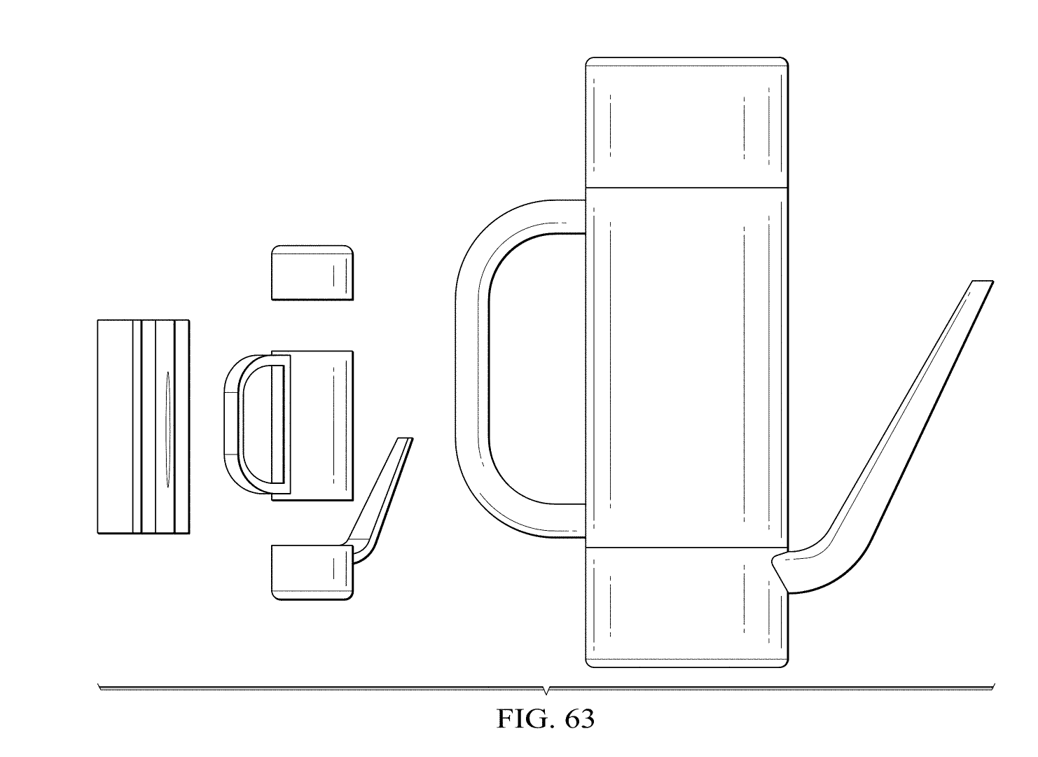

FIG. 63 illustrates one embodiment of a roast, grind, and/or brew system that can include a canister with a built in spout for pouring/serving. The canister can include separate sections for easy cleaning.

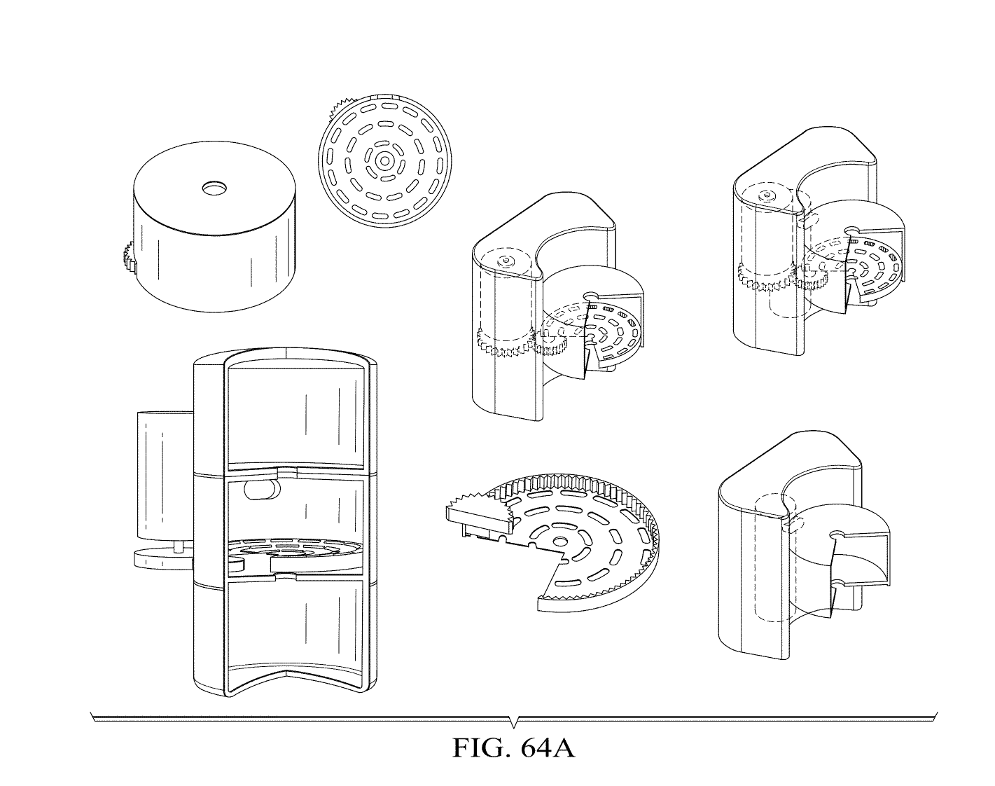

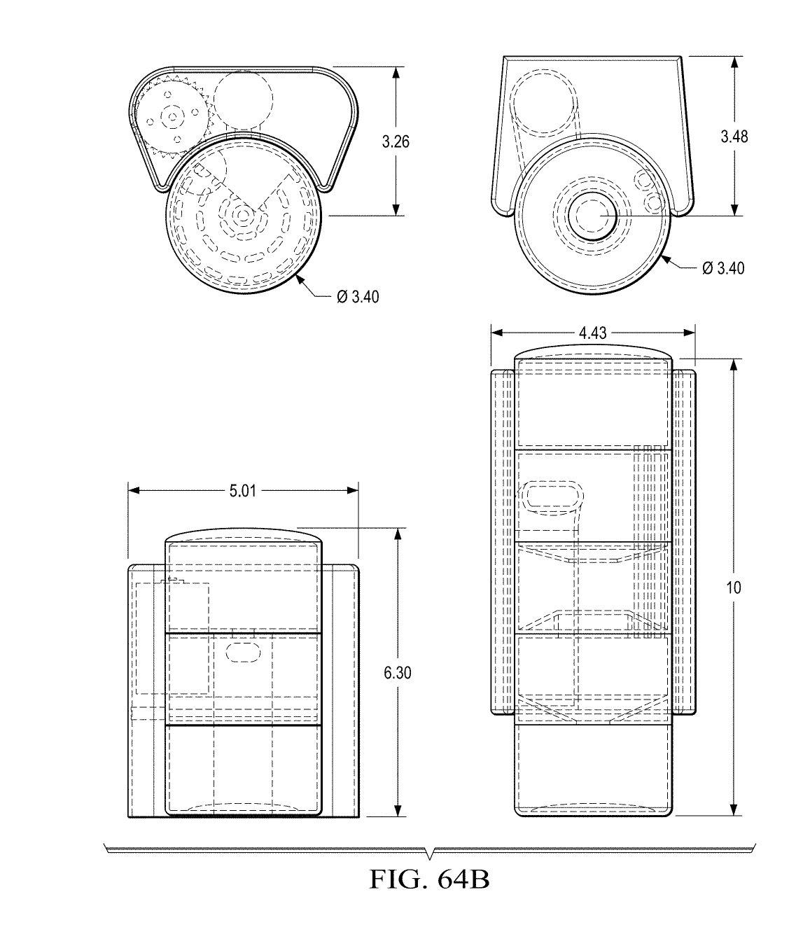

FIGS. 64A and 64B illustrate an alternate embodiment of an integrated beverage system that can roast, grind, and brew a beverage such as coffee.

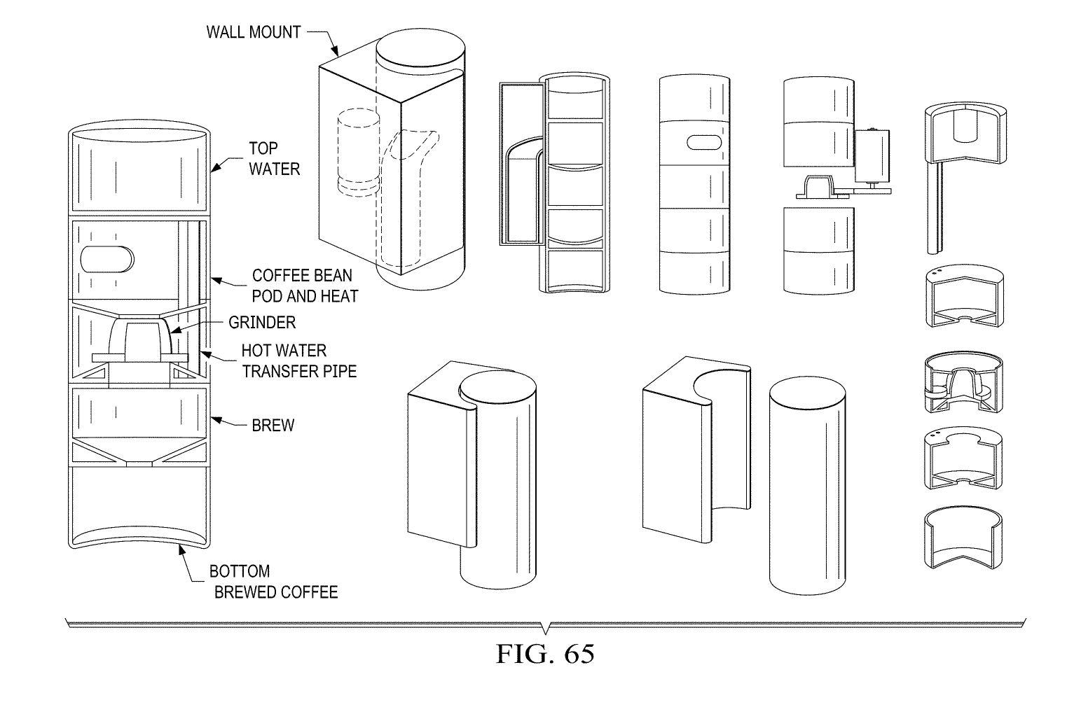

FIG. 65 illustrates an alternate embodiment of an integrated beverage system that can roast, grind, and brew a beverage such as coffee.

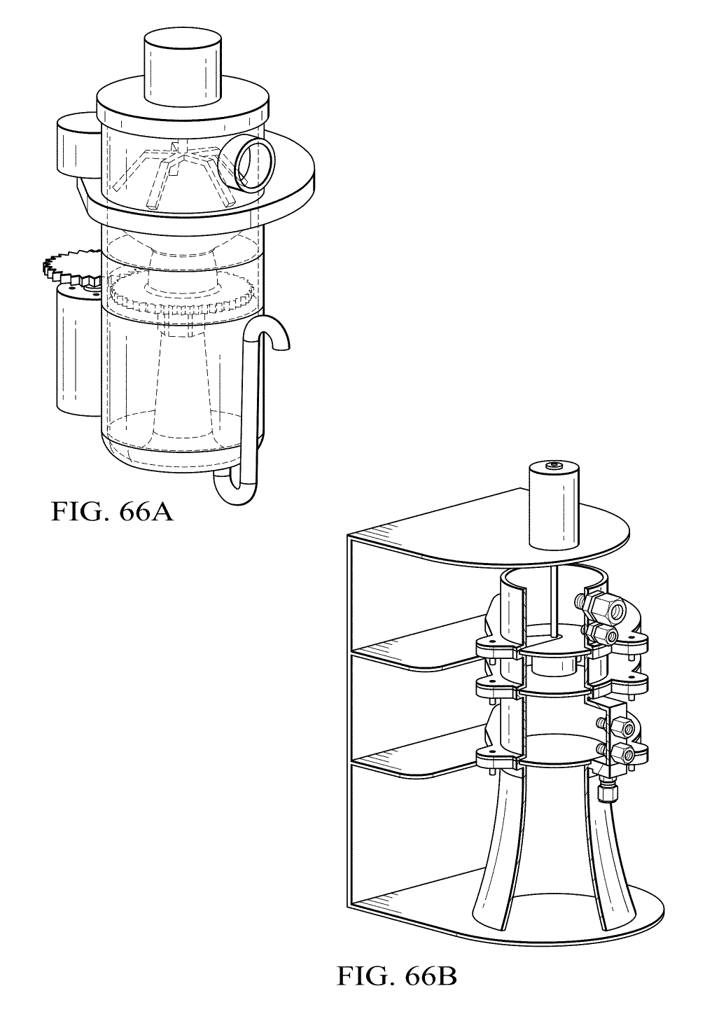

FIGS. 66A and 66B disclose an alternate design for a roast, grind, and brew integrated beverage system. Embodiments can include the separation of active and passive components. The illustrated figures below show the ‘passive’ components, where there are no electrical connections to the parts shown. In certain embodiments only these parts of the machine touch the coffee in the raw green bean state, ground, or brewed state. The motors, pumps, water heater, air heater, and other components that are active can be separate where the system can be designed such that the passive coffee portion of the machine can be easily separated and removed from the active portion. Such a design can allow the passive coffee portion of the system to be easily removed and cleaned, repaired, and/or replaced as necessary. In one example, the entire passive portion may be one tube or similar structure that can be removed and, in an alternate version, the passive portion can be multiple modular pieces. Removable pieces could easily be put into a dishwasher for cleaning, which may be difficult with other designs. The roaster may have a tube that connects the heater air source that is modular and can be disconnected. The grinder may be driven by a belt or gear connected to a motor with the actual grinder being removable. The brewer may have a water tube connected to allow hot water entry. There may be multiple doors or the like that can control flow between sections of the machine that move in/out and are part of the active part of the machine though they control flow in the passive part of the machine (e.g., computer controlled doors).

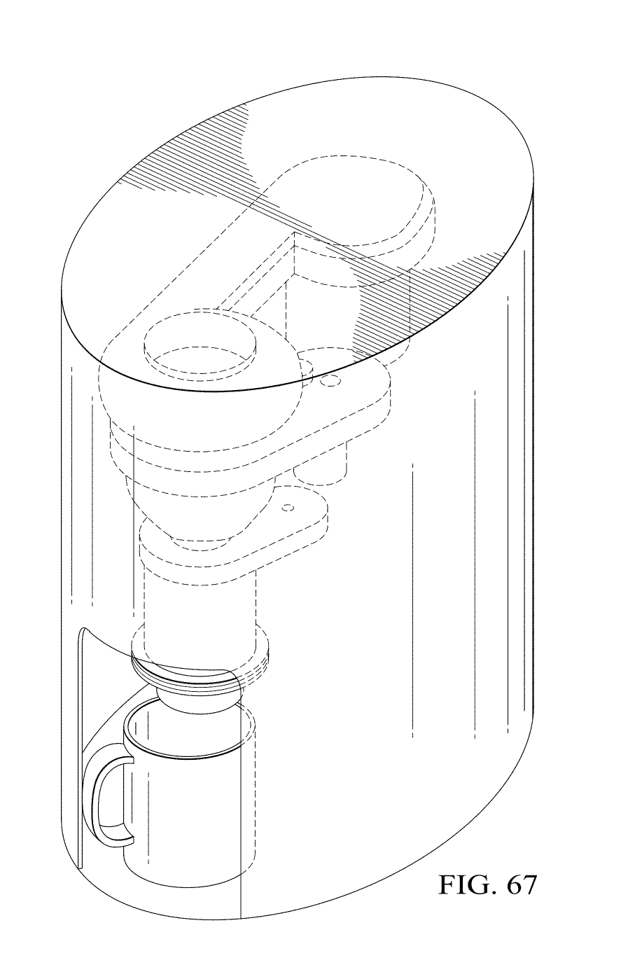

FIG. 67 discloses an alternate embodiment of an integrated beverage system that can provide a roast, grind, and/or brew functionality. Green beans may be loaded into the top of the machine, where the beans can be loaded via a pod that may be punctured and that drops the beans into a roaster, or the beans may be loose unpackaged beans that fall into the roaster in a controlled fashion such as a door opening. The system can include a roaster, a door under the roaster that opens and closes, and a grinder positioned under the roaster, where beans can fall into the grinder. The grinds can then fall into a brewer, which is under the grinder, in the illustrated embodiment. A door can open or close to allow grinds into the brewing system and/or to close and seal the brewer once the grinds are in position. Hot water can be injected into the brewer and coffee can come out of the bottom of the brewer into a cup. The system can include a replaceable/disposable filter that can catch the grinds and can be easily removed, cleaned, or disposed. This filter may be made of compostable material, for example.

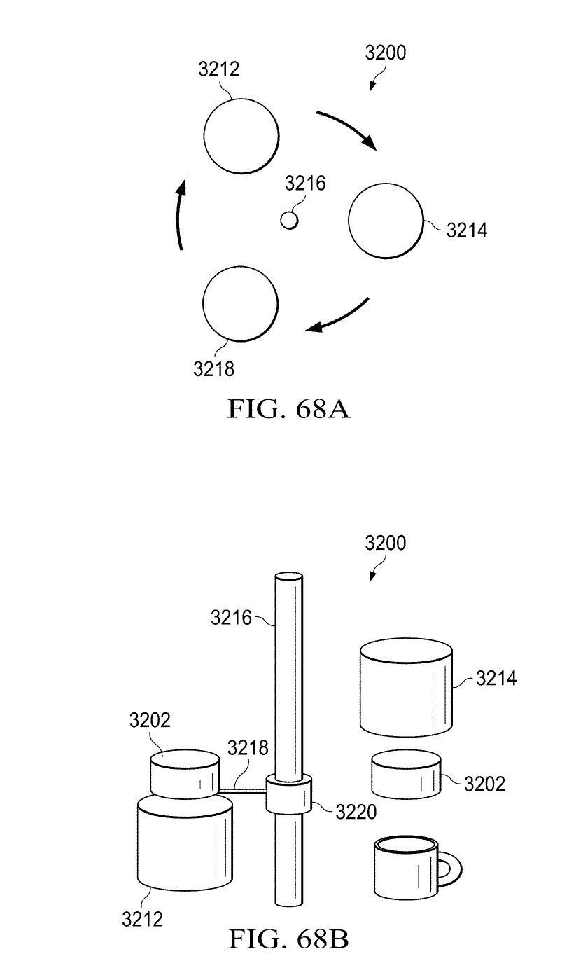

Referring to FIGS. 68A and 68B, one embodiment of an integrated beverage system 3200 is shown. It may be beneficial to provide a system that can automatically transition a container or pod 3202 between a plurality of different stations. For example, a pod 3202 can be placed into a loading station 3218. Next, a servo motor 3220 associated with an arm 3218 can transition the pod 3202 to a roaster 3212. Following the roasting step the servo motor 3220 can rotate the arm about an axis 3216 such that the pod 3202 is in position relative to a grinder and/or brewer system 3214. In this manner a grinder, roaster, and/or brewer can be placed radially about the axis 3216, which may decrease the space needed to accommodate the various functions of the integrated beverage system 3200. It will be appreciated that any orientation of functions is contemplated and any mechanism of transitioning the pod 3202 is contemplated.

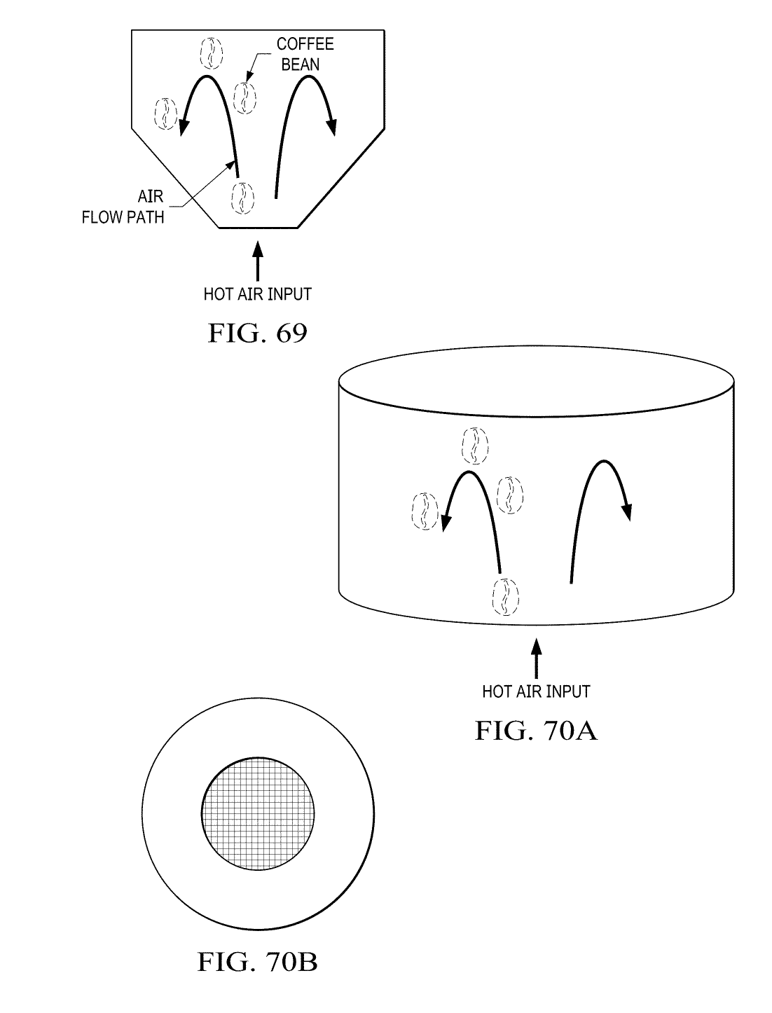

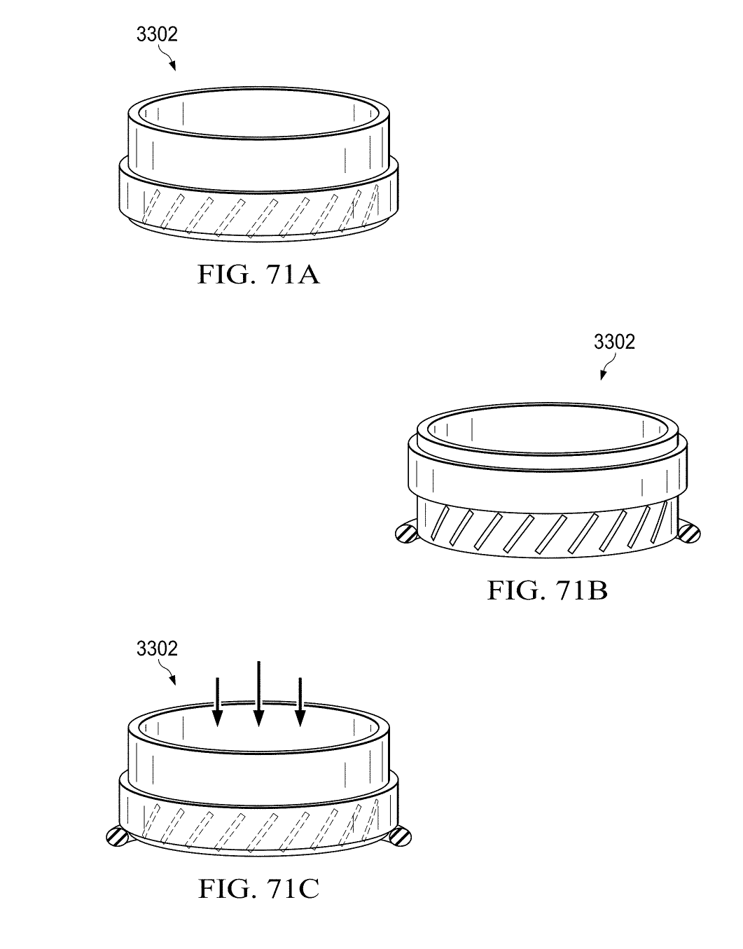

Referring to FIGS. 71A-71C, it will be appreciated that any suitable embodiment of a system that can roast, grind, and/or brew inside of a container or pod is contemplated. In one embodiment, a pod 3302 can include slits in a perimeter surface that can allow hot air to enter, but these slits may be covered by a sleeve before the pod used. During use, the pod 3302 can be inserted into an automated beverage system and the sleeve can be raised to allow hot air to enter and roast the beans. The sleeve can then be lowered and a grinding tool can be lowered into the pod 3302 and can spin to grind the roasted beans. Hot water can be injected into the pod 3302 to brew the coffee and coffee can come out of the bottom of the pod after passing through filtering material, for example.

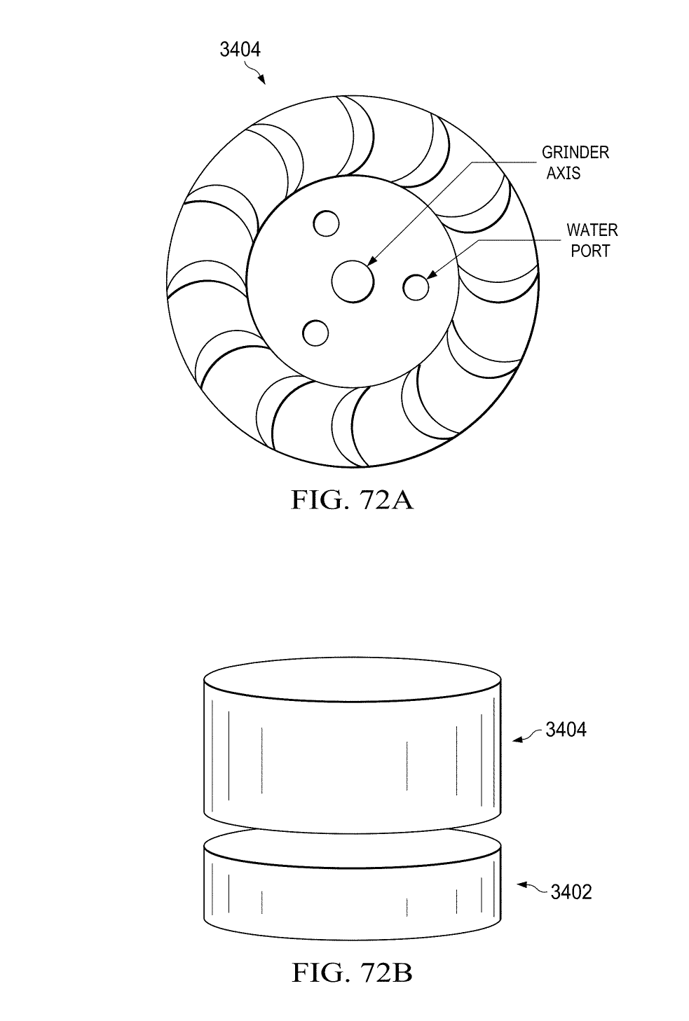

Referring to FIGS. 72A and 72B, one embodiment of a system to roast, grind, and/or brew in a pod is shown. The top of the pod 3302, or bottom of the tool 3304 in a system that can mate to the pod 3302, can have airfoil features to create swirling air pattern that can directed into the pod. Hot air can be injected into the pod to roast the beans. The tool 3304 can also have a grinder tool that can lower into the pod 3302 that can grind the beans. The grinder tool can have blades that can be retracted into a narrow feature and expand as the blades spin due to centrifugal force, which may allow the insertion hole to be relatively small. The tool 3304 can also have a water injection port to allow hot water to enter the pod 3302 and brew the coffee. Coffee may exit the pod 3302 from the bottom of the pod 3302 which can have a filtration material. The pod 3302 can also have a blade material located permanently inside the pod 3302, where this blade can be engaged by an external motor that spins the blade to grind the beans, for example.

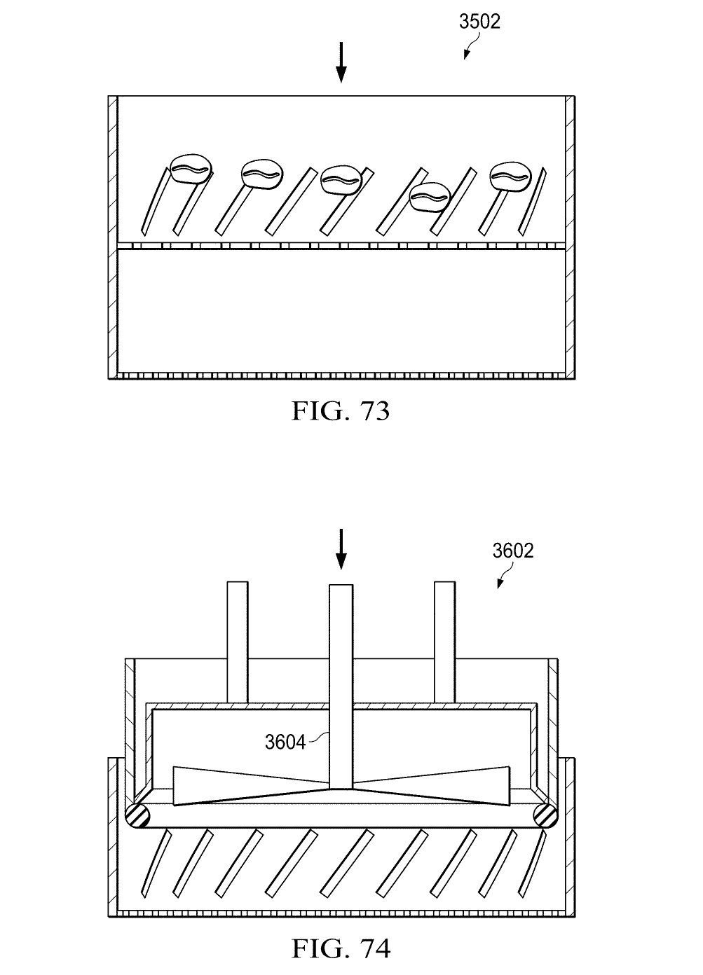

Referring to FIG. 73, one embodiment of system to roast, grind, and/or brew in a pod 3502 is shown. The pod 3502 can be a two section pod with one part on top of the other. The top part can contain green unroasted beans, where beans may be roasted in this top section via hot air injected via the perimeter or from the bottom. Alternatively, hot air can be injected from the top. After roasting, a grinding tool can be lowered into the pod 3502 and the grinds can fall into the lower section of the pod 3502. Water can be injected into the pod 3502 from the top or sides and coffee may be brewed/filtered in the lower section of the pod 3502. Coffee can come out of the bottom of pod.

Referring to FIG. 74, an alternate approach may be to roast in a pod 3602 from the perimeter via hot air and a tool 3604 can be lowered into the pod 3602 to block off the perimeter holes and allow grinding and brewing in the pod 3602. Brewing may occur in the pod 3602 and coffee can come out of the bottom of pod 3602. In another variation of this and all the other designs discussed, the pod may have a metal blade embedded into the pod along with a mating feature that allows an external motor to engage with the blade and spin the blade to grind the beans (other hard materials can be used instead of metal for the blade/grinding mechanism). The mating feature can be a central shaft or other feature that may be inside the pod, in which case the external tool can enter the pod to mate, or may protrude outside of the pod.

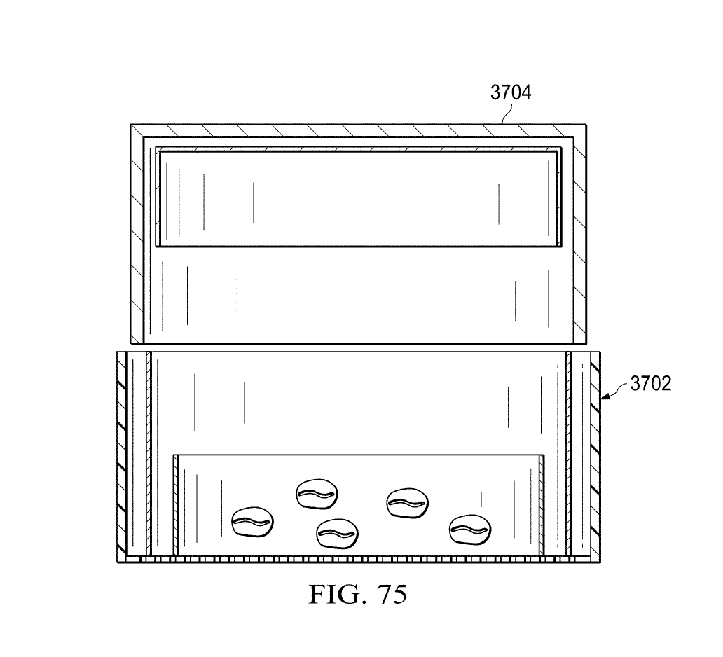

Referring to FIG. 75, an alternate approach to roasting, grinding, and brewing in a pod 3702 is shown. A tool 3704 can be lowered into the pod 3702, which can contain unroasted green beans. The tool 3794 can have vents to allow hot air to enter the pod 3702 to roast the beans. The tool 3704 also may have a grind and brew component that can allow the beans to be ground and brewed after roasting. The use of radially tilted fins may allow the injected hot air to spin the beans. It will be appreciated that any suitable mesh configuration, such as a vertical mesh configuration, is contemplated.

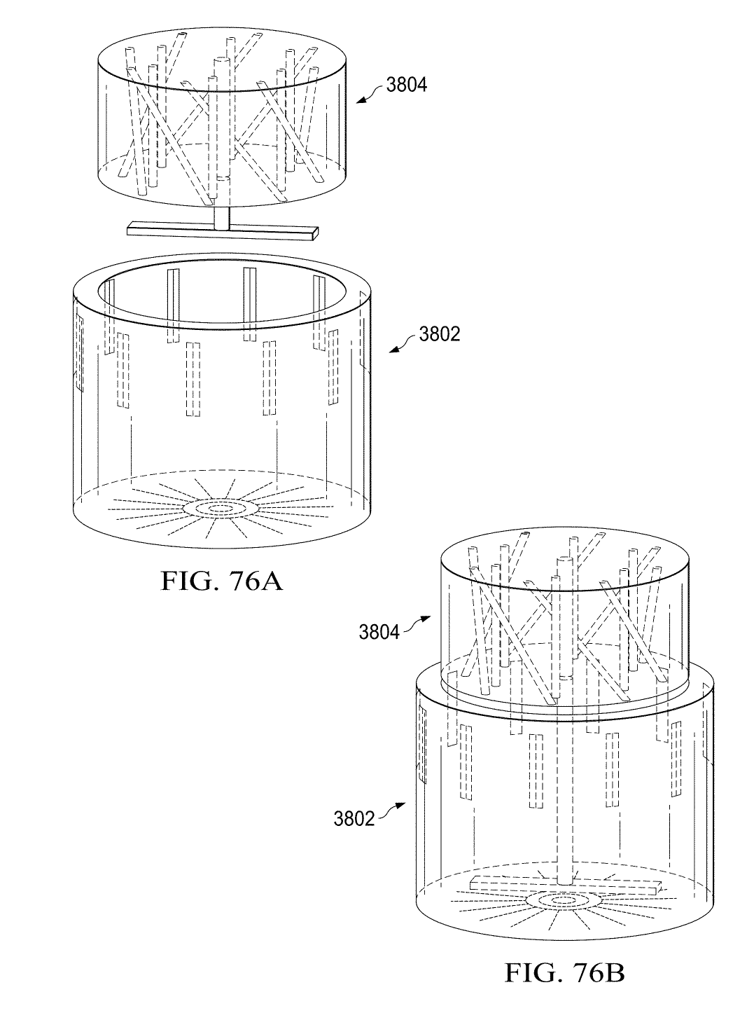

Referring to FIGS. 76A and 76B, an approach to providing a roast, grind, and brew functionality in a pod 3802 is shown. The tool 3804 can lower and mate to the pod 3802, which can contain green unroasted coffee beans. The tool 3804 can have nozzles to inject hot air into the pod 3802 to roast the beans and may have exhaust ports for the hot air. The tool 3804 can have a spinning blade to grind the roasted beans. The tool 3804 can have water injection ports to inject hot water into the pod 3802 to brew the coffee. The coffee can be filtered in the bottom of the pod 3802 and may come out of the bottom.

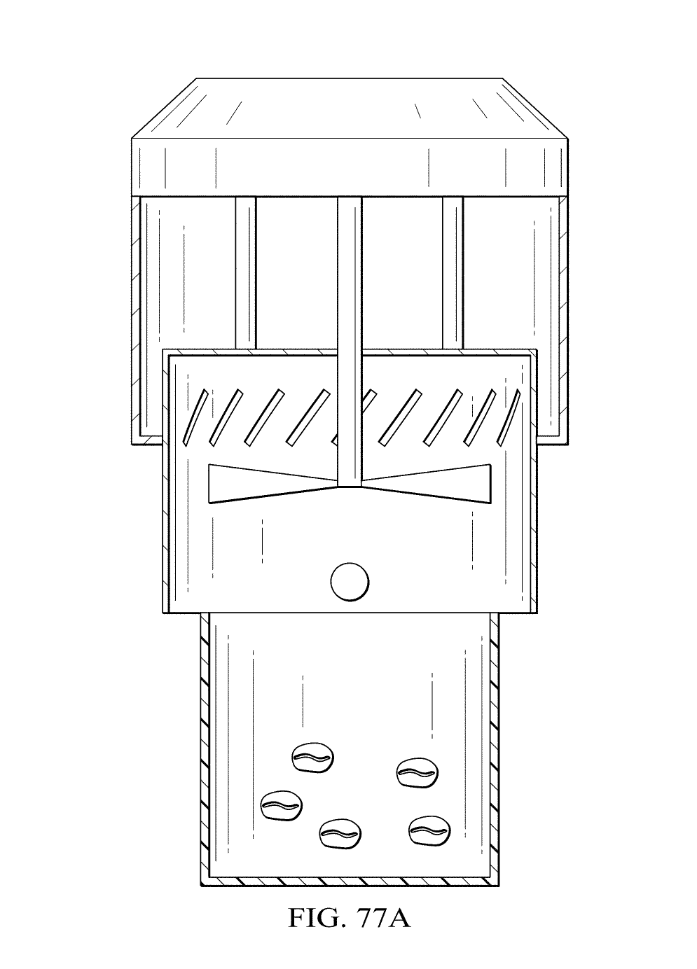

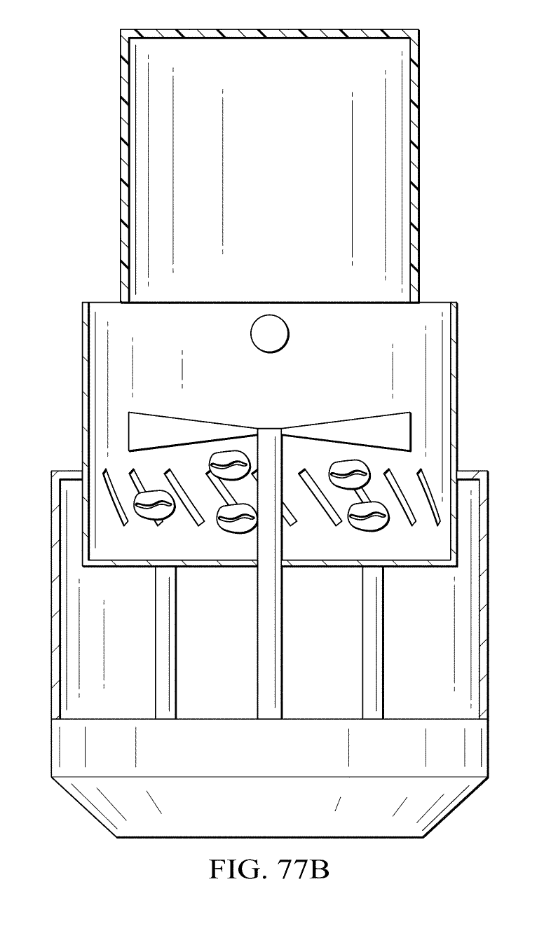

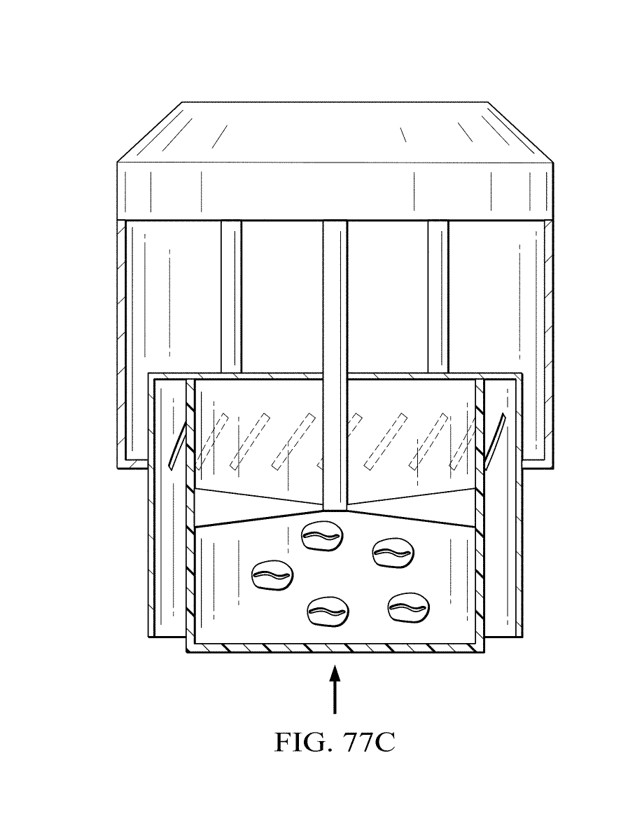

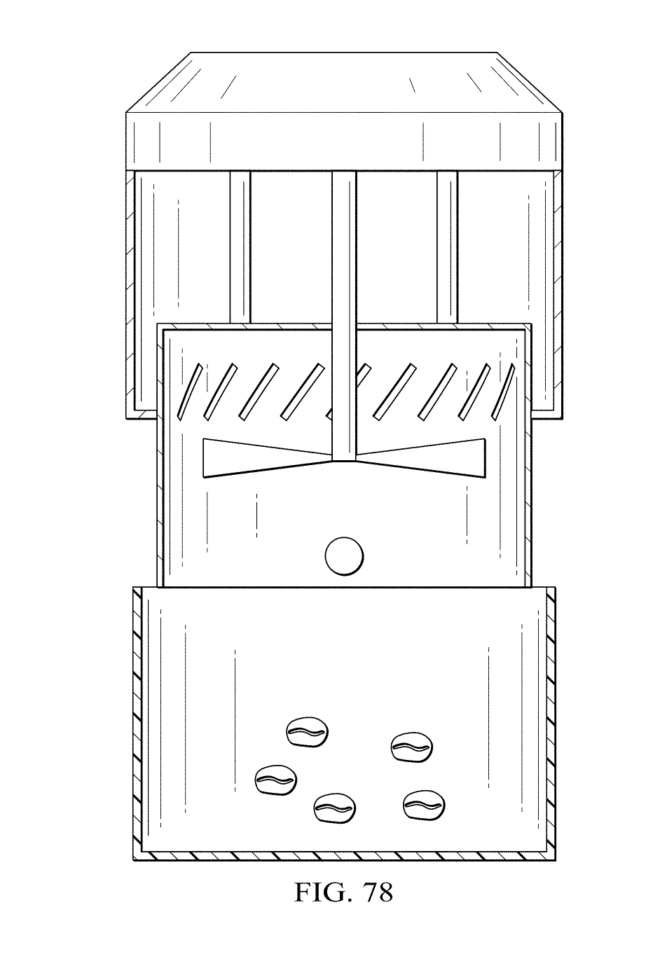

Referring to FIGS. 77A-77C, an approach to roasting, grinding, and brewing is shown. The pod may contain green coffee beans and can mate to the machine. The machine may rotate 180 degrees to dump the beans into the machine, which may roast the beans in a container. The machine can be rotated back 180 degrees and the roasted beans can fall back into the pod for grinding and brewing. Water can be injected into the pod and coffee may come out the bottom. Referring to FIG. 78, an alternate version with a wider pod is shown.

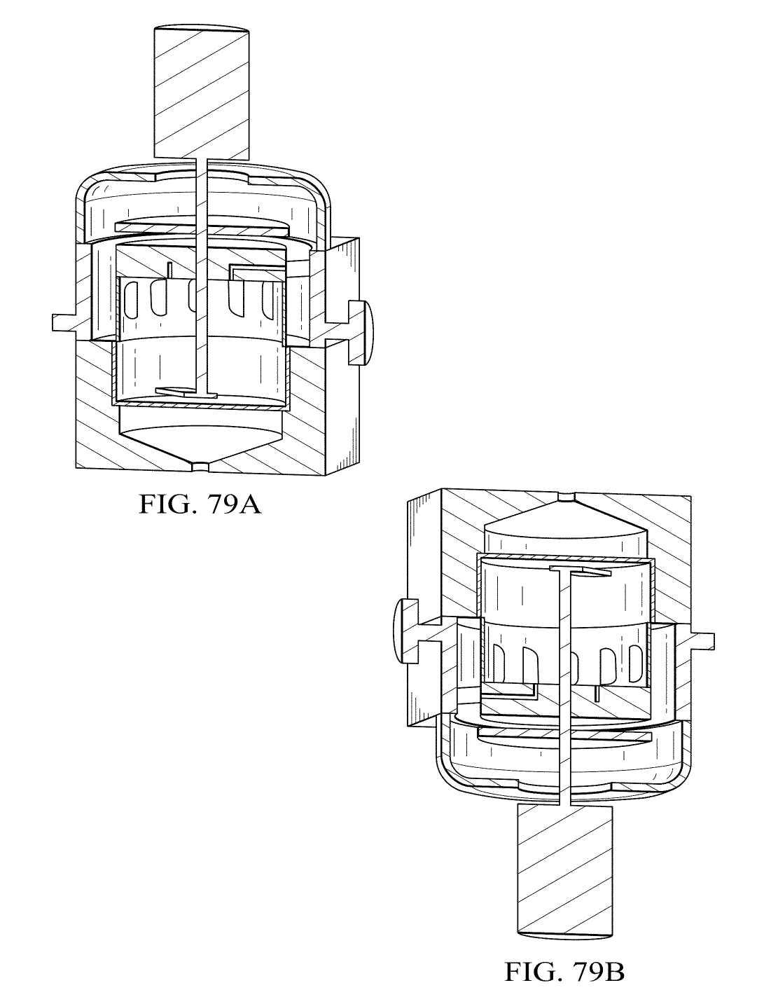

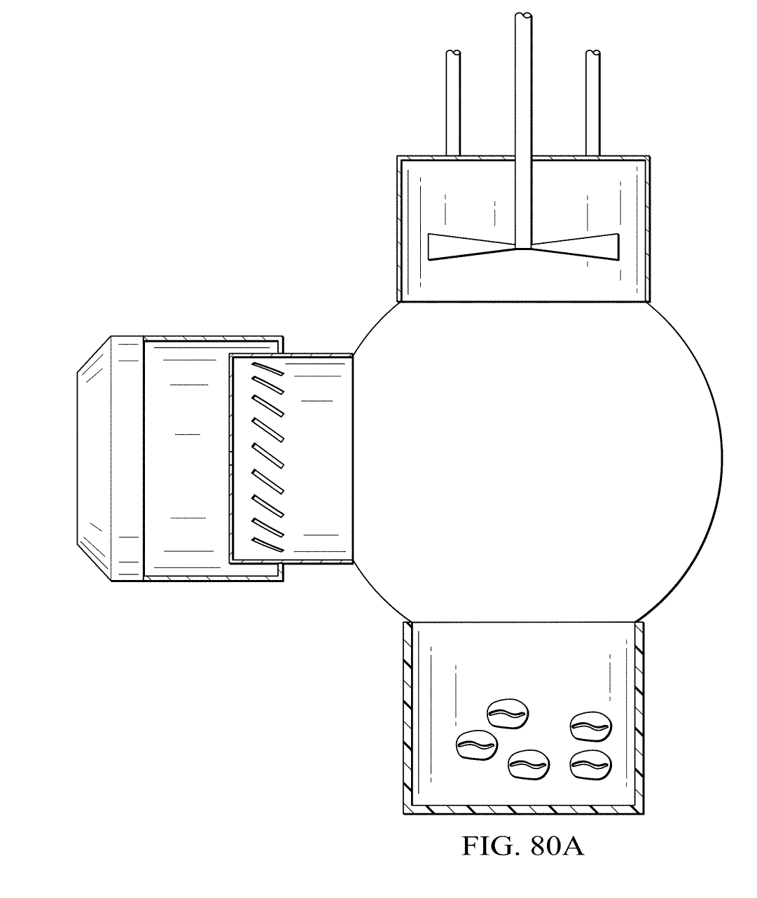

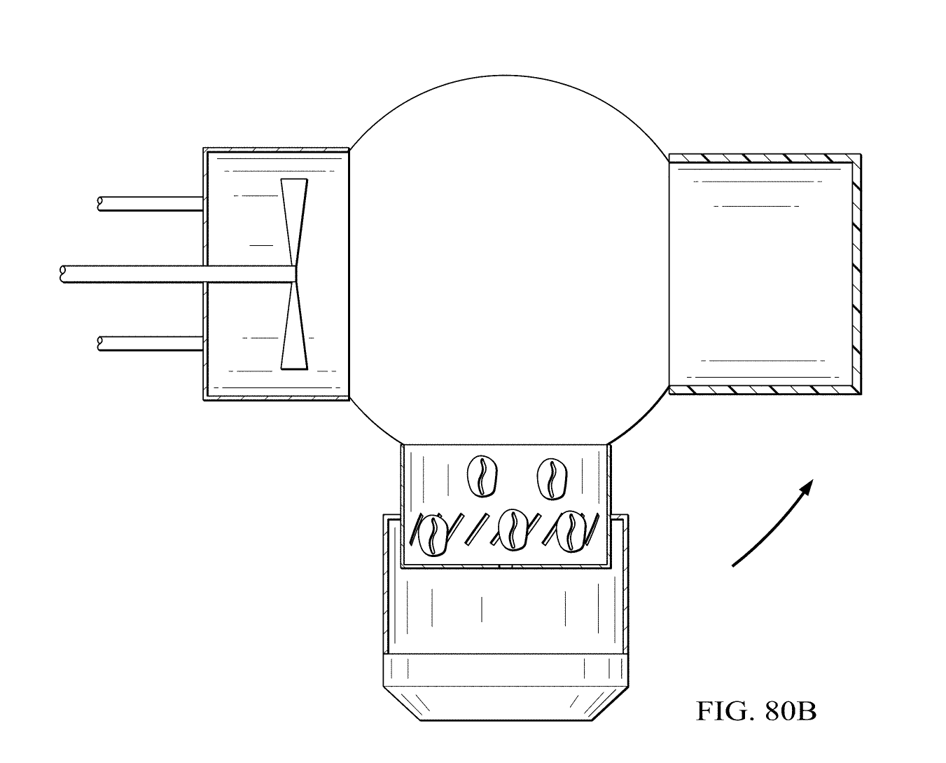

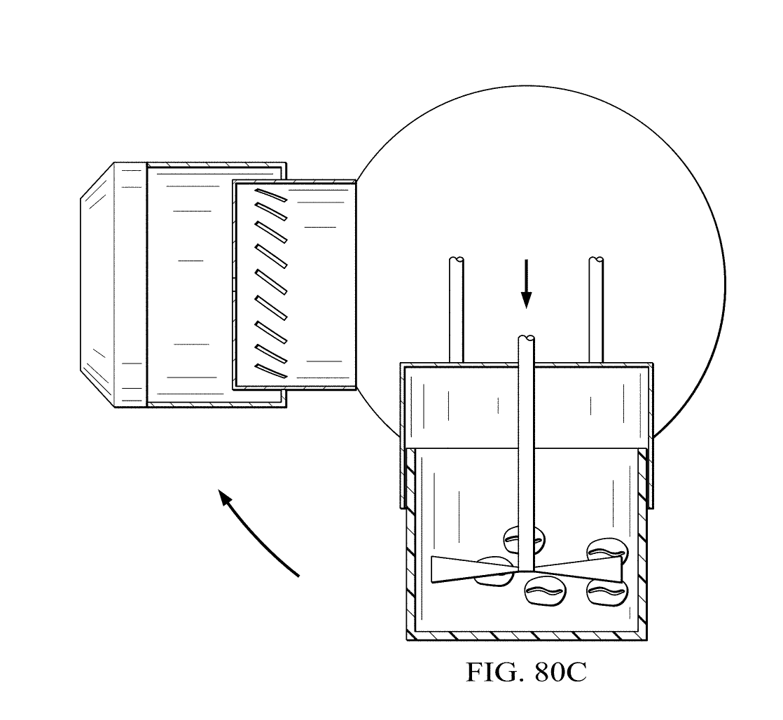

FIGS. 79A and 79B illustrate one embodiment of a system that can facilitate grinding in a pod. Referring to FIGS. 80A-80C, an alternate approach to a roast, grind, and/or brew system is shown. The pod can contain green beans and the pod can mate to the machine. The machine can rotate to drop the beans into a roaster. The beans can be roasted. The machine can rotate to drop roasted beans back into the pod. A grinder can be lowered into the pod to grind the beans. The grinder can be a spinning blade grinder, burr grinder, or other grinder. The same tool with the grinder can inject water into the pod to brew coffee, where coffee may come out of the bottom of the pod after passing through a filtering material.

In general, it will be apparent to one of ordinary skill in the art that at least some of the embodiments described herein can be implemented in many different embodiments of software, firmware, and/or hardware. The software and firmware code can be executed by a processor or any other similar computing device. The software code or specialized control hardware that can be used to implement embodiments is not limiting. For example, embodiments described herein can be implemented in computer software using any suitable computer software language type, using, for example, conventional or object-oriented techniques. Such software can be stored on any type of suitable computer-readable medium or media, such as, for example, a magnetic or optical storage medium or flash memory. The operation and behavior of the embodiments can be described without specific reference to specific software code or specialized hardware components. The absence of such specific references is feasible, because it is clearly understood that artisans of ordinary skill would be able to design software and control hardware to implement the embodiments based on the present description with no more than reasonable effort and without undue experimentation.

Moreover, the processes described herein can be executed by programmable equipment, such as computers or computer systems and/or processors. Software that can cause programmable equipment to execute processes can be stored in any storage device, such as, for example, a computer system (nonvolatile) memory, an optical disk, magnetic tape, or magnetic disk. Furthermore, at least some of the processes can be programmed when the computer system is manufactured or stored on various types of computer-readable media.

It can also be appreciated that certain portions of the processes described herein can be performed using instructions stored on a computer-readable medium or media that direct a computer system to perform the process steps. A computer-readable medium can include, for example, memory devices such as diskettes, compact discs (CDs), digital versatile discs (DVDs), optical disk drives, or hard disk drives. A computer-readable medium can also include memory storage that is physical, virtual, permanent, temporary, semi-permanent, and/or semi-temporary.

A “computer,” “computer system,” “host,” “server,” or “processor” can be, for example and without limitation, a processor, microcomputer, minicomputer, server, mainframe, laptop, personal data assistant (PDA), wireless e-mail device, cellular phone, pager, processor, fax machine, scanner, or any other programmable device configured to transmit and/or receive data over a network. Computer systems and computer-based devices disclosed herein can include memory for storing certain software modules used in obtaining, processing, and communicating information. It can be appreciated that such memory can be internal or external with respect to operation of the disclosed embodiments. The memory can also include any means for storing software, including a hard disk, an optical disk, floppy disk, ROM (read only memory), RAM (random access memory), PROM (programmable ROM), EEPROM (electrically erasable PROM) and/or other computer-readable media. Non-transitory computer-readable media, as used herein, comprises all computer-readable media except for a transitory, propagating signal.

In various embodiments disclosed herein, a single component can be replaced by multiple components and multiple components can be replaced by a single component to perform a given function or functions. Except where such substitution would not be operative, such substitution is within the intended scope of the embodiments.

Some of the figures can include a flow diagram. Although such figures can include a particular logic flow, it can be appreciated that the logic flow merely provides an exemplary implementation of the general functionality. Further, the logic flow does not necessarily have to be executed in the order presented unless otherwise indicated. In addition, the logic flow can be implemented by a hardware element, a software element executed by a computer, a firmware element embedded in hardware, or any combination thereof.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art. Rather it is hereby intended the scope of the invention to be defined by the claims appended hereto.

We claim:

1. A method for brewing coffee comprising:
inserting a sealed container containing unroasted coffee into an integrated beverage system having a roasting system and a brewing system;
engaging the unroasted coffee with the roasting system of the integrated beverage system;
roasting the unroasted coffee;
engaging roasted coffee with the brewing system of the integrated beverage system; and
brewing the coffee with the integrated beverage system.

2. The method of claim 1, further comprising:
opening the container with the integrated beverage system; and
verifying a property associated with the unroasted coffee.

3. The method of claim 1, wherein the steps of engaging the unroasted coffee with the roasting system and engaging the roasted coffee with the brewing system comprise transferring the unroasted coffee to the roasting system and transferring the roasted coffee to the brewing system.

4. The method of claim 1, wherein the steps of engaging the unroasted coffee with the roasting system and engaging the roasted coffee with the brewing system comprise engaging the container with the roasting system and engaging the container with the brewing system, wherein the container contains the unroasted coffee and the roasted coffee.

5. The method of claim 1, wherein the steps of engaging the unroasted coffee with the roasting system and engaging the roasted coffee with the brewing system comprise moving the roasting system into engagement with the unroasted coffee and moving the brewing system into engagement with the roasted coffee, wherein the container remains substantially stationary.

6. A method for brewing coffee comprising:
inserting a sealed container containing a plurality of unroasted coffee beans into an integrated beverage system having a roasting system, a grinding system, and a brewing system;
engaging the plurality of coffee beans with the roasting system of the integrated beverage system;
roasting the plurality of coffee beans;
engaging the plurality of coffee beans with the grinding system of the integrated beverage system;
grinding the plurality of coffee beans such that a plurality of coffee grounds are formed;
engaging the plurality of coffee grounds with the brewing system; and
brewing the plurality of coffee grounds with the integrated beverage system.

7. The method of claim 6, further comprising:
opening the container with the integrated beverage system; and
verifying a property associated with the container or contents thereof.

8. The method of claim 6, wherein the steps of engaging the plurality of coffee beans with the roasting system and engaging the plurality of coffee beans with the grinding system comprise transferring the plurality of coffee beans to the roasting system and transferring the plurality of coffee beans to the grinding system.

9. The method of claim 6, wherein the steps of engaging the plurality of coffee beans with the roasting system and engaging the plurality of coffee beans with the grinding system comprise engaging the container with the roasting system and engaging the container with the grinding system, wherein the container contains the plurality of coffee beans.

10. The method of claim 6, wherein the steps of engaging the plurality of coffee beans with the roasting system and engaging the plurality of coffee beans with the grinding system comprise moving the roasting system into engagement with the plurality of coffee beans and moving the grinding system into engagement with the plurality of coffee beans, wherein the container remains substantially stationary.

11. The method of claim 6, wherein the step of engaging the plurality of coffee grounds with the brewing system comprises transferring the plurality of coffee grounds to the brewing system.

12. The method of claim 6, wherein the step of engaging the plurality of coffee grounds with the brewing system comprises engaging the container with the brewing system, wherein the container contains the plurality of coffee grounds.

13. The method of claim 6, wherein the step of engaging the plurality of coffee grounds with the brewing system comprises moving the brewing system into engagement with the plurality of coffee grounds, wherein the container remains substantially stationary.

14. A method for brewing coffee comprising:
inserting a sealed container containing a plurality of coffee beans into an integrated beverage system having a grinding system, a roasting system, and a brewing system;
engaging the plurality of coffee beans disposed within the container with the grinding system of the integrated beverage system;
grinding the plurality of coffee beans such that a plurality of coffee grounds are formed;
engaging the plurality of coffee grounds disposed within the container with the roasting system of the integrated beverage system;
roasting the plurality of coffee grounds disposed within the container;
engaging the plurality of coffee grounds disposed within the container with the brewing system; and
brewing the plurality of coffee grounds with the integrated beverage system.

15. The method of claim 14, further comprising:
opening the sealed container with the integrated beverage system; and
verifying a property associated with the plurality of coffee beans.

16. The method of claim 14, wherein the step of engaging the plurality of coffee beans with the grinding system comprises transferring the plurality of coffee beans to the grinding system.

17. The method of claim 14, wherein the step of engaging the plurality of coffee beans with the grinding system comprises engaging the container with the grinding system, wherein the container contains the plurality of coffee beans.

18. The method of claim 14, wherein the step of engaging the plurality of coffee beans with the grinding system comprises moving the grinding system into engagement with the plurality of coffee beans, wherein the container remains substantially stationary.

19. The method of claim 14, wherein the steps of engaging the plurality of coffee grounds with the roasting system and engaging the plurality of coffee grounds with the brewing system comprise transferring the plurality of coffee grounds to the roasting system and transferring the plurality of coffee grounds to the brewing system.

20. The method of claim 14, wherein the steps of engaging the plurality of coffee grounds with the roasting system and engaging the plurality of coffee grounds with the brewing system comprise engaging the container with the roasting system and engaging the container with the brewing system, wherein the container contains the plurality of coffee grounds.
